(19) United States
(12) Patent Application Publication
(10) Pub. No.: US 2026/0330540 A1
(43) Pub. Date: Oct. 22, 2026

(54) SYSTEM

(71) Applicant: SoftBank Group Corp., Tokyo (JP)

(72) Inventor: Fumina YOKOI, Tokyo (JP)

(73) Assignee: SoftBank Group Corp., Tokyo (JP)

(21) Appl. No.: 19/646,624

(22) Filed: Apr. 14, 2026

(30) Foreign Application Priority Data
Apr. 22, 2025 (JP) 2025-070629

(51) Int. Cl. G06Q 30/0601; G06V 10/44

(52) U.S. Cl. CPC G06Q 30/06432; G06Q 30/06313; G06Q 30/06314; G06V 10/454

(57) ABSTRACT

A system includes circuitry configured to receive image data from a terminal device and store the image data in a storage device. The circuitry applies a convolutional neural network to extract feature vectors including color, shape, texture, and pattern features, and generates an image embedding vector. Cosine similarity scores are computed between the image embedding vector and stored item embeddings to retrieve and rank candidate item records exceeding a similarity threshold. A generative adversarial network synthesizes a composite image using body shape parameters and three-dimensional model data of a selected item to produce virtual try-on output data. The ranked candidate item records and the virtual try-on output data are transmitted to the terminal device.

### CROSS-REFERENCE TO RELATED APPLICATION

The present application claims priority to and incorporates by reference the entire contents of Japanese Patent Application No. 2025-070629 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

A problem to be solved by the present invention is to comprehensively and efficiently solve multifaceted and complicated problems in a purchasing experience peculiar to online shopping, in which users cannot objectively judge products that suit them in online shopping, cannot easily compare whether there are other better products, feel uneasy about a sense of size and a silhouette at the time of wearing because they cannot actually try them on, also have difficulty in selecting an optimal coordination adapted to a body shape, a lifestyle, and a change in a trend by themselves, and furthermore, complicated management work such as a budget, an inventory status, a purchase procedure, and a return response becomes a burden on the users, and to enable the users to complete optimal product selection and purchase with a sense of conviction and a sense of security while staying at home.

### SUMMARY OF THE INVENTION

Means for solving the problem according to the present invention is to configure an online shopping support system comprising a user information acquisition unit, a product information management unit, a virtual fitting provision unit, an image recognition unit, a styling proposal unit, a trend analysis unit, an interactive assistant unit, a purchase support unit, and an inventory management unit, acquire and manage body shape data, a face image, an age, a preference, a past purchase history, and budget information of a user by the user information acquisition unit, centrally manage information such as 3D model data, image data, a price, an inventory status, a brand, a category, a size, a color, and a material regarding a plurality of fashion products by the product information management unit, synthesize the body shape data of the user and the 3D model data for each product by the virtual fitting provision unit, and display a state in which a virtual avatar of the user wears the corresponding product on a user terminal by AR or VR technology using generative AI, analyze a product image uploaded by the user using the generative AI by the image recognition unit, extract feature amounts such as a color, a shape, a design, and a material, and search for a product with high similarity from a database of the product information management unit, generate a plurality of optimal coordination examples using the generative AI based on a body shape, facial features, a preference, a season, a usage scene, and trend information of the user by the styling proposal unit, analyze external data such as SNS, fashion magazines, and collections using the generative AI by the trend analysis unit to extract latest fashion trend information, return an answer or advice in real time to a question or request from the user using the generative AI by the interactive assistant unit while referring to the user information, the product information, styling information, the trend information, the purchase history, and the like, collate the budget information of the user with a product price and the inventory status by the purchase support unit to select a product purchasable within a budget, and perform input assistance for a delivery destination and a payment method, tracking of a delivery status, and automation of a return/exchange procedure, and store the preference and purchase tendency of the user by the inventory management unit, automatically notify a product with low inventory, a new product, a limited product, and the like, and execute price negotiation and purchase agency for the limited product using the generative AI as necessary, thereby realizing an online shopping experience in which the user can select and purchase an optimal product for himself/herself with a sense of conviction while staying at home.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

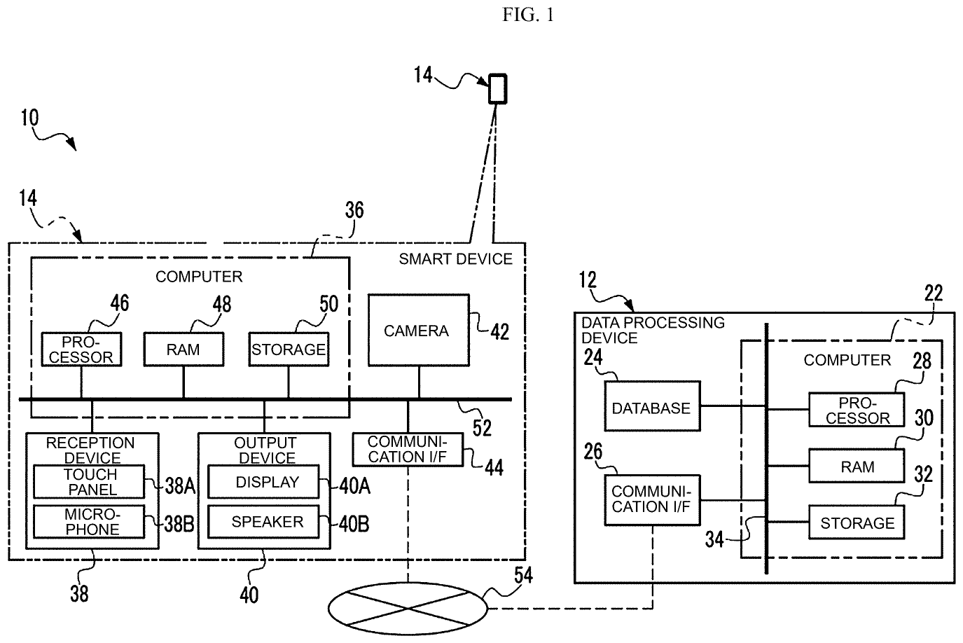

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

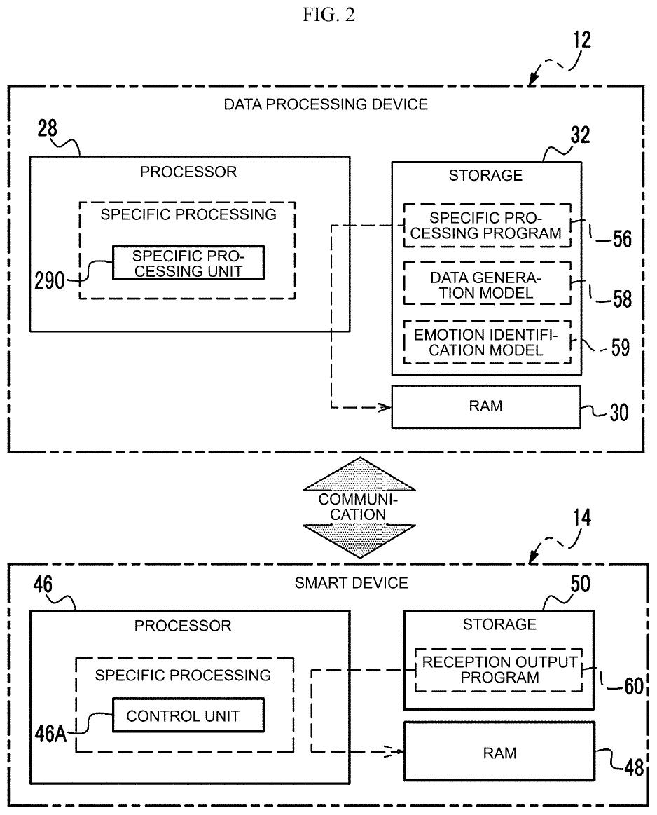

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

As an embodiment for carrying out the present invention, an online shopping support system is configured by cooperation between a server and a user terminal (a smartphone, a tablet, a personal computer, or the like), and includes a plurality of functional modules such as a user information acquisition unit, a product information management unit, a virtual fitting provision unit, an image recognition unit, a styling proposal unit, a trend analysis unit, an interactive assistant unit, a purchase support unit, and an inventory management unit. Hereinafter, a specific configuration of each unit, processing contents, a utilization method of generative AI, role sharing between the server and the terminal, and further, actual user usage scenarios and specific examples will be described in detail. Specifically, the present system adopts a distributed computing architecture. The server includes a parallel processing cluster composed of a plurality of computing nodes. The present system implements each functional module by containerizing it as a microservice. The present system executes asynchronous communication with the user terminal via an application programming interface gateway. The present system integrally operates a plurality of machine learning models such as a large language model and a convolutional neural network. The present system thereby distributes a processing load and dramatically improves a response speed. The present system improves scalability as compared with a conventional monolithic system. The present system is applicable to use cases such as an electronic commerce platform and apparel sales in a virtual reality space. The present system uses a serialized lightweight data format in data communication between the respective modules. The present system thereby minimizes consumption of a network bandwidth. The present system includes an orchestration tool that executes dynamic allocation of hardware resources. The present system automatically scales out or scales in the computing nodes in accordance with an increase or decrease in traffic. The present system thereby brings about a technical effect of enhancing availability and fault tolerance of the system.

First, the user information acquisition unit acquires extremely diverse and detailed information such as body shape data (height, weight, three sizes, shoulder width, waist, hip, thigh, calf, arm length, neck circumference, foot size, a face image, a skin color, a hairstyle, an age, and a gender), a favorite fashion taste (casual, formal, street, natural, mode, elegant, sporty, or the like), a past purchase history (a purchase date, a purchased product, a purchase amount, an evaluation, and a return history), budget information (a budget per time, a monthly budget, and an annual budget), a lifestyle (an occupation, a family structure, a commuting means, a hobby, and how to spend holidays), and a usage scene (work, childcare, travel, a party, sports, a ceremonial occasion, or the like) of a user via a dedicated application or a web interface on the user terminal. For example, when the user takes a whole body photograph or a face photograph with a camera of a smartphone and uploads it to the application, the generative AI automatically extracts body shape parameters, facial features, a skin color, a hairstyle, and the like from the image, and significantly reduces time and effort for input. Furthermore, products purchased by the user in the past, a browsing history, an evaluation/review, a reason for return, and the like are also automatically collected and accumulated, and are integrally managed in a user database on the server side. Specifically, the user information acquisition unit acquires an image tensor having three channels of red, green, and blue from a camera module of the user terminal. The user information acquisition unit executes preprocessing of normalization and resizing on the acquired image tensor. The user information acquisition unit inputs the preprocessed image tensor to a convolutional neural network for posture estimation. The neural network receives, for example, an image tensor having a resolution of 256×256 as an input. The neural network generates a group of heat maps indicating joint positions of a human body and a numerical vector indicating dimensions of each part as an output. For example, the neural network outputs estimated values such as a shoulder width of 42 centimeters and a waist of 70 centimeters as floating-point numbers. The user information acquisition unit stores this output vector in a user profile database. The present system executes subsequent 3D avatar generation processing using these high-dimensional vectors. The present system eliminates an error caused by human manual input, and improves accuracy and speed of data acquisition. The present system is also applicable to a personalized fitness application and a medical body shape management system. The neural network is trained in advance by an error backpropagation method so as to minimize a mean square error function using pair data of millions of human body images and actual measurement values. The present system converts text-input preference and lifestyle information into a 512-dimensional embedding vector using a natural language processing model. The present system uses this embedding vector as a potential preference expression of the user.

The product information management unit is implemented on the server side, and manages extremely diverse information such as 3D model data (for a whole body, for a part, and including wrinkle and drape expressions at the time of wearing), a product image (a front, a back, a side, a wearing example, an enlarged image, and a material up image), a price, an inventory status, a brand, a category (tops, bottoms, outerwear, a dress, shoes, a bag, an accessory, or the like), a size (XS, S, M, L, XL, one-size-fits-all, overseas size notation, or the like), a color, a material (cotton, linen, wool, polyester, silk, leather, or the like), a product description text, a washing instruction, a user review, a sales start date, limited product information, a restock schedule, and discount information regarding a fashion product as a database. For example, even for the same product, a plurality of variations such as different colors, different sizes, a limited collaboration model, and a pre-sale model are centrally managed, and optimal information is provided in response to a user request. Specifically, the product information management unit is configured by combining a distributed relational database and a graph database. The product information management unit stores attribute information of each product in a vector database as a high-dimensional embedding vector. The product information management unit holds the 3D model data as a hierarchical data structure including vertex coordinates, a polygon mesh, and texture mapping information. The product information management unit converts text information such as a category and a material of the product into a 768-dimensional feature vector using a natural language processing model. The present system encodes, for example, a text of a 100% cotton red shirt into a numerical vector. By this vectorization, the present system executes subsequent similarity calculation and search processing at high speed as a cosine similarity operation. The present system overcomes a limitation of a conventional keyword exact match search, and realizes a high-speed and highly accurate information search based on semantic relevance. The present system is applicable to use cases such as a large-scale inventory management system and asset management in a digital twin environment. The present system expresses variation information of the product as nodes and edges of a graph structure, and efficiently manages a complex dependency relationship. The present system applies a feature extraction model to image data, and extracts and stores a visual feature as a 2048-dimensional vector. The present system thereby brings about a technical effect of enabling a multimodal search from both aspects of text and image.

The virtual fitting provision unit synthesizes the body shape data of the user and the 3D model data for each product on the server side, and automatically generates a highly accurate 3D avatar dedicated to the user using the generative AI. For example, when the user takes whole body photographs from a plurality of angles (front, side, and back) and uploads them to the application, the generative AI generates a realistic 3D avatar reflecting a skeleton, a way muscles are attached, subtle unevenness of a body shape, a posture, facial features, a skin color, and even a hairstyle. The 3D model data of the selected product is worn on this avatar, and a silhouette, a sense of size, a texture of a material, wrinkles and drapes according to movement, gloss, a sheer feeling, an appearance at the time of layering, and the like at the time of wearing are reproduced in real time. The generated virtual fitting image or video is transmitted from the server to the user terminal, and can be experienced as an AR display or a VR display on the terminal. For example, when the user stands in front of a mirror at home using the camera of the smartphone, the avatar of the user appears on the screen, and a state of wearing the selected clothes can be superimposed and displayed in a real space. Furthermore, it is also possible to virtually try on a plurality of products simultaneously and display them for comparison. Specifically, the virtual fitting provision unit includes a generative adversarial network and a physics simulation engine. The virtual fitting provision unit inputs a body shape parameter vector and a face image tensor of the user to a generator network. The generator network generates 3D mesh data of the user from the input data. The virtual fitting provision unit superimposes a 3D clothing model of the product on the 3D mesh data. The virtual fitting provision unit executes a cloth simulation based on a finite element method in order to calculate a physical behavior of clothing. The simulation engine receives rigidity, mass, and a friction coefficient as material parameters of the clothing as inputs. The simulation engine calculates deformation of the clothing and generation of wrinkles according to gravity and a motion vector of the user, and outputs a vertex displacement vector. The virtual fitting provision unit performs rendering processing using this output result, and generates a two-dimensional projection image tensor. The present system transmits the generated image tensor to the user terminal, and a graphics processing unit on the terminal side draws it in an augmented reality space. The present system replaces a conventional fitting process depending on human imagination with a combination of advanced physics calculation and machine learning. The present system thereby brings about a technical effect of dramatically improving reality of fitting and reducing a return rate. The present system is applicable to use cases such as online apparel sales and avatar customization in a virtual space. The model determines a difference between a generated image and a real image by a discriminator network, and backpropagates the error, thereby acquiring an extremely photorealistic image generation capability.

The image recognition unit receives a product image uploaded by the user from the terminal on the server side, and performs image analysis using the generative AI. For example, when the user takes a photograph of clothes of interest seen in a magazine or SNS and uploads it, the generative AI extracts feature amounts such as a color, a shape, a design, a material, a pattern, a brand logo, a decoration, a silhouette, and details (a button, a fastener, embroidery, a print, or the like) from the image, collates them with the database of the product information management unit, and searches for and presents a plurality of products with high similarity. For example, when an image of a floral dress is uploaded, products having a similar floral pattern, silhouette, color tone, sense of material, and brand taste are listed. Furthermore, ranking of similar products, filtering according to the preference of the user, and narrowing down by a price range and an inventory status are also automatically performed. Specifically, the image recognition unit includes an image classification model based on a visual transformer architecture. The image recognition unit divides the image data received from the user terminal into patch units, linearly projects each patch, and generates a patch embedding vector. The image recognition unit inputs this patch embedding vector group to a transformer encoder including a self-attention mechanism. The encoder extracts visual features such as a color, a shape, and a texture from the input image, and outputs a 1024-dimensional image feature vector. For example, the encoder expresses a floral pattern or a V-neck shape as coordinates on a specific vector space. The image recognition unit transmits the output image feature vector as a query to a vector database. The vector database calculates a cosine similarity between the query vector and each product vector in the product database using an approximate nearest neighbor search algorithm. The vector database outputs a product identifier list of top N items whose similarity score exceeds a predetermined threshold. The present system passes this output list to a subsequent display processing module. By using a vector operation in a high-dimensional space, the present system realizes an objective and high-speed similar image search that does not depend on human visual intuition. The present system thereby significantly improves search accuracy and processing speed. The present system is applicable to use cases such as an image search function in electronic commerce and an automatic detection system for copyright infringing images. The model is trained in advance to acquire a feature expression from a large amount of image pairs using contrastive learning which is a self-supervised learning method. The present system inputs the extracted feature vector to a clustering algorithm, and also executes automatic category classification processing of products in parallel.

The styling proposal unit generates a plurality of optimal coordination examples using the generative AI based on a body shape, facial features, a preference, a season, a usage scene, and trend information of the user on the server side. For example, when the user specifies a usage scene such as “spring outing”, “for work”, “casual during childcare”, “party”, “travel”, “sports watching”, or “ceremonial occasion”, the generative AI combines tops, bottoms, outerwear, an accessory, shoes, a bag, a hat, a stole, a belt, and the like from the database of the product information management unit, and proposes coordination considering a body shape correction effect (for example, a leg-lengthening effect by a waist mark, body shape cover by an A-line, and a small face effect by a V-neck), a balance of a color and a material, and a trend element (for example, a pastel color, an oversized silhouette, a layered style, and a sustainable material trending this season). Furthermore, for each coordination example, an explanatory text such as “why this combination suits”, “what kind of body shape trouble can be covered”, “which scene is optimal”, “relevance to a trend”, “tips for mixing and matching”, and “recommended use of small items” is also automatically generated by the generative AI and presented to the user. For example, if the user inputs a trouble such as “I am worried about a body shape change after childbirth”, “I want to cover my upper arms”, or “I want to make my complexion look brighter”, coordination and advice on how to wear according to the trouble are also automatically generated. Specifically, the styling proposal unit is configured by combining a graph neural network and a large language model. The styling proposal unit concatenates attribute information, a usage scene, and trend information of the user to generate a context vector. The styling proposal unit inputs this context vector and a graph structure of the product database to the graph neural network. The graph neural network learns a compatibility score between products as an edge weight, and outputs an optimal combination of products for the input context as a probability distribution. For example, the graph neural network outputs a combination probability of tops A and bottoms B as 0.85. The styling proposal unit extracts top coordination candidates based on this probability distribution. The styling proposal unit inputs the extracted coordination information and the trouble information of the user as a prompt text to the large language model. The large language model analyzes a context of the input text, autoregressively generates a token, and outputs text data of an explanatory text. For example, the large language model outputs a character string that this V-neck shirt has an effect of making a neck area look neat. The present system transmits this output text to the user terminal together with a coordination image. The present system converts tacit knowledge of a human stylist into an explicit calculation process by a graph structure and a probability model. The present system thereby makes it possible to execute a personalized proposal in real time and on a large scale. The present system is applicable to use cases such as a personal styling service and an interior coordination proposal system. The model is trained so as to minimize a cross entropy error using past excellent coordination data as teacher data.

The trend analysis unit periodically collects external data such as SNS, fashion magazines, and collections on the server side, and extracts latest fashion trend information using the generative AI. For example, it analyzes hashtags rapidly increasing on SNS, feature articles in fashion magazines, runway images of collections, posts by influencers, street snaps, new product information of overseas brands, search trends of search engines, and the like, and automatically extracts a color, a pattern, a silhouette, a material, a brand tendency, a technique of wearing, a popular item, a notable collaboration, a trend of sustainable fashion, and the like trending this season. The extracted trend information is reflected in the styling proposal unit and a product recommendation function in real time. For example, specific trend keywords and wearing examples such as “green items are trending this season”, “oversized shirts are popular”, “linen dresses are attracting attention”, and “limited collaborations of overseas brands are a hot topic” are customized for each user and presented. Specifically, the trend analysis unit functions as a multimodal analysis engine including a natural language processing model and an image analysis model. The trend analysis unit periodically acquires text data and image data from an external server using a web crawler. The trend analysis unit performs morphological analysis on the acquired text data, and generates an appearance frequency vector of words. The trend analysis unit inputs the acquired image data to a convolutional neural network, identifies an object and a color in the image, and outputs a feature vector. The trend analysis unit integrates these text feature vector and image feature vector, and inputs them to a recurrent neural network as time-series data. The recurrent neural network learns past trend transitions, and outputs a trend probability of a future trend element as a prediction score. For example, the recurrent neural network outputs a trend probability of a pastel color in the next month as 0.92. The trend analysis unit extracts an element whose prediction score exceeds a threshold as a trend keyword. The present system dynamically updates this extracted trend information as an input parameter of the styling proposal unit. The present system eliminates subjective trend prediction by humans, and realizes a statistical and objective prediction operation based on a huge amount of multimodal data. The present system thereby improves freshness and accuracy of a proposal. The present system is applicable to use cases such as a demand prediction system and a marketing analysis tool in the apparel industry. The model is trained so as to minimize a cross entropy error using social media data for the past several years and actual sales performance data as teacher data. The present system also executes processing of mapping the extracted trend keywords on a vector space and clustering similar trend groups.

The interactive assistant unit is realized using the generative AI on the server side, generates an optimal answer or advice in real time in response to a question or request by voice or text from the user terminal while referring to the user information, the product information, the styling information, the trend information, the purchase history, and the like, and returns it to the user terminal. For example, in response to various questions such as “Does this clothes suit me?”, “Are there any other recommendations?”, “How should I return it?”, “What is the trend this season?”, “I want you to propose coordination within the budget”, “How is the sense of size of this brand?”, “What are tips for size selection of overseas brands?”, “What kind of scene is this product suitable for?”, and “What are items that can cover a body shape?”, the generative AI returns a personal answer according to an attribute and a situation of the user. For example, if the user inputs “I want clothes that are easy to move in during childcare”, specific proposals and advice such as a stretch material, an item easy to wash, a color in which dirt is inconspicuous, and a design having good compatibility with a baby carrier are returned. Specifically, the interactive assistant unit includes a large language model based on a transformer architecture. The interactive assistant unit receives a text character string of a natural language or text data of a voice recognition result input from the user terminal. The interactive assistant unit converts this input text into an array of token identifiers using a tokenizer. The interactive assistant unit combines a profile vector of the user, product metadata being browsed, and a past dialogue history vector as a prompt in addition to this token array, and inputs them to the large language model. The large language model has tens of billions of parameters, and calculates a probability distribution of a token appearing next based on the input context. The large language model sequentially selects the most appropriate token from this probability distribution, and generates and outputs a response text. For example, the large language model outputs text data that the product uses a stretch material and does not hinder movement during childcare. The present system outputs this output text to a display unit or a voice synthesis unit of the user terminal. Unlike a rule-based chatbot, the present system realizes dynamic and flexible response generation based on high-dimensional context understanding. The present system thereby brings about a technical effect of accurately understanding an intention of the user and improving customer satisfaction. The present system is applicable to use cases such as online customer support and an automatic inquiry response system. The model is fine-tuned based on human feedback using reinforcement learning, and includes a safety mechanism that suppresses inappropriate remarks. The present system calculates a reliability score of the generated response text, and executes branch processing of escalating processing to a human operator when the score is low.

The purchase support unit collates the budget information of the user with a product price and the inventory status on the server side, and preferentially displays only a product purchasable within a budget. For example, when the user sets a budget to 20,000 yen, only products and coordination that can be purchased within 20,000 yen are presented. In a purchase procedure, input assistance for a delivery destination and a payment method, tracking of a delivery status, automation of a return/exchange procedure, and the like are managed on the server side, and a progress status and a necessary action are notified to the user terminal. For example, every time the delivery status is updated to “shipped”, “delivering”, “delivery completed”, or the like, a push notification is transmitted to the user terminal. Furthermore, when the user inputs a request such as “I want to return” or “I want to exchange a size”, the generative AI guides a reason for return and a procedure method, and automatically generates and provides necessary documents and return destination information. Specifically, the purchase support unit functions as a transaction processing module including a rule engine and a natural language processing model. The purchase support unit performs a comparison operation between numerical data indicating a budget upper limit value of the user and price data of the product database. The purchase support unit filters only a product identifier having a price equal to or less than the budget based on a result of this comparison operation, and generates an output list. The purchase support unit transmits this output list to a rendering engine of the user terminal. When receiving a return request text from the user, the purchase support unit inputs this to the natural language processing model. The natural language processing model classifies a reason for return from the input text, and outputs a corresponding category identifier. For example, the natural language processing model outputs a category identifier indicating a size mismatch from a text that a size did not fit. The purchase support unit calls a predefined workflow based on this category identifier, and automatically generates electronic slip data for return including a return destination address and barcode data. The present system transmits this electronic slip data to the user terminal. The present system completes complex conditional branching and text analysis inside a computer without intervention of a human operator. The present system thereby eliminates a processing delay and dramatically improves a completion speed of a transaction. The present system is applicable to use cases such as a settlement system of electronic commerce and a logistics management system. The present system cooperates with an application programming interface of an external logistics company, asynchronously receives a change event of a delivery status, and updates the database.

The inventory management unit stores the preference and purchase tendency of the user on the server side, automatically detects a product with low inventory, a new product, a limited product, and the like, and notifies the user terminal. For example, when a product browsed many times by the user in the past has only one item left, an alert of “low inventory” is immediately displayed. Furthermore, price negotiation and purchase agency for a limited product can also be executed using the generative AI. For example, when the user requests “I want to buy this product a little cheaper”, the AI can automatically negotiate with a sales side and draw out a discount or a privilege. Lottery sales, advance reservations, restock notifications, and the like of limited products are also automatically managed, and the user is supported so as to be able to obtain a desired product without missing it. Specifically, the inventory management unit includes a time-series prediction model and a reinforcement learning agent. The inventory management unit monitors inventory number data of each product in real time, and generates a trigger signal when an inventory number falls below a predetermined threshold. The inventory management unit transmits a push notification packet to a terminal of a user who has browsed the corresponding product in the past in response to this trigger signal. When receiving a price negotiation request from the user, the inventory management unit activates the reinforcement learning agent. The reinforcement learning agent receives a current inventory number, a sales deadline, and a past purchase performance score of the user as a state vector as an input. The reinforcement learning agent outputs an optimal presented price or discount rate as an action vector based on this state vector. For example, the reinforcement learning agent outputs an action vector of presenting a 5% discount. The inventory management unit hits an interface on a sales system side based on this output, and executes price update processing. The present system realizes an autonomous price optimization operation adapting to a dynamic environmental change, rather than price setting based on a static rule. The present system thereby brings about a technical effect of maximizing an inventory digestion rate and minimizing an opportunity loss. The present system is applicable to use cases such as a dynamic pricing system and an automatic bidding system. The reinforcement learning agent is trained by a Q-learning algorithm using a reward function that maximizes a profit in a simulation environment using past transaction data. The present system uses a cryptographic pseudo-random number generator as a lottery algorithm for a limited product, and executes highly fair and transparent lottery processing.

As described above, in the embodiment of the present invention, for the immediacy and interaction of the user experience, the AR display of the virtual fitting, the notification function, the simple input assistance, and the like are realized on the terminal side, but main processing such as management of the user information and the product information, the image recognition, the 3D avatar generation, the styling proposal, the trend analysis, the interactive assistant, the purchase support, and the inventory management is executed on the server side. The generative AI plays an indispensable role in each part of the system, such as the 3D avatar generation, the feature amount extraction by the image recognition, the similar product search, the automatic coordination generation, the trend information extraction, the interactive response generation, the explanatory text generation, the price negotiation, and the purchase agency, and is utilized one by one to realize a highly personalized experience optimized for each user. Specifically, the present system adopts a hybrid processing architecture in which edge computing and cloud computing are fused. The present system executes augmented reality rendering processing and primary filtering of sensor data, which require low latency, by a processor on the user terminal side. The present system executes the 3D avatar generation and inference processing of a large language model, which require an enormous amount of computational resources, by an image processing device cluster on the server side. The present system transmits and receives only serialized lightweight vector data and metadata between the terminal and the server via a communication protocol. Thereby, the present system maximizes the processing throughput of the entire system while minimizing the consumption of a network bandwidth. The present system constructs pipeline processing for asynchronously and in parallel executing a plurality of neural network models specialized for each functional module. The present system executes integrated analysis of multidimensional data at a speed and accuracy impossible by human manual work. Thereby, the present system brings about a technical effect of dynamically generating an information space completely optimized for each user. The present system is also applicable to use cases such as an education support system and a medical diagnosis support system requiring high personalization. The present system caches an inference result of each model in a shared memory space, and reduces an overhead in data transfer between modules. The present system monitors battery consumption on the terminal side, and executes load distribution control for dynamically increasing a processing ratio on the server side when a remaining amount is low.

For example, when the user thinks “I want to try a new dress of an overseas brand to see if it fits my body shape”, the user takes a whole body photograph of himself/herself with a smartphone and uploads it to the application. On the server side, the generative AI generates a 3D avatar from the body shape data of the user, synthesizes it with the 3D model data of the product information management unit to create a virtual fitting image, and displays it in AR on the terminal. Furthermore, the image recognition AI searches for a similar product close to the preference of the user, the styling proposal AI generates a plurality of coordinations matching the dress, and the trend analysis AI makes a proposal reflecting a trend color and pattern of this season. When the user inputs a question or a request, the interactive AI immediately provides personal advice and purchase support, the inventory management AI notifies low inventory and new product information, and automatically executes price negotiation and purchase agency as necessary. Specifically, the present system adopts an event-driven architecture that sequentially activates a plurality of machine learning models triggered by a series of user actions. Upon receiving an image tensor uploaded from the user terminal, the present system immediately activates a posture estimation model and a 3D reconstruction model to generate mesh data of the 3D avatar. The present system synthesizes the mesh data and the 3D model data of the dress acquired from the product database, and outputs a two-dimensional fitting image tensor using a rendering engine. In parallel with this, the present system extracts a visual feature vector of the dress using an image recognition model, executes an approximate nearest neighbor search on a vector database, and outputs an identifier list of similar products. The present system further activates a styling proposal model, and calculates a combination probability distribution of an optimal coordination using an attribute vector of the user and a feature vector of the product as inputs. The present system keeps an interactive assistant model constantly on standby, immediately executes natural language processing in response to a text input from the user, and outputs a response text. The present system orchestrates these complex arithmetic processings among microservices, and provides a seamless response to the user. By integrally controlling a plurality of artificial intelligence models, the present system realizes complex problem solving, which cannot be realized by a single model, by computer technology. The present system is applicable to use cases such as an integrated virtual store platform and a commercial transaction system in a metaverse space. The present system monitors an execution time of each processing step in milliseconds, and includes a fail-safe mechanism that falls back to an alternative lightweight model when a timeout occurs.

Also, for example, even when the user has extremely diverse worries and requests such as “I want clothes that are easy to move in and easy to wash while raising a child”, “I want to cover my upper arms and stomach area”, “I want to choose a color that makes my complexion look bright”, “I am worried about the sense of size of an overseas brand”, “I do not want to fall behind the trend”, “I want to compare a plurality of coordinations within a budget”, and “I want to surely obtain a limited product”, the generative AI comprehensively analyzes the attribute and situation of the user, the past action history, and the external trend information, and automatically realizes optimal product proposal, coordination, dressing advice, purchase support, inventory notification, price negotiation, and purchase agency for a limited product end-to-end. Specifically, the present system includes a multimodal integrated encoder for integrally processing diverse input data of the user. The present system inputs the text request, the image data, the past action history log of the user, and the external trend data to respective dedicated encoder networks. The present system concatenates feature vectors output from the respective encoders into a single high-dimensional integrated vector in a combining layer. The present system inputs this integrated vector to a transformer-based decision-making network equipped with a self-attention mechanism. The decision-making network analyzes potential needs of the user from the input integrated vector, and outputs a score vector indicating a priority of a task to be executed. For example, the decision-making network outputs a score of a product proposal task as 0.9 and a score of an inventory notification task as 0.8. The present system dynamically calls each functional module based on this score vector, and executes necessary processing in parallel. The present system replaces a conventional process in which a human operator collects and judges information across a plurality of systems with a vector operation in a high-dimensional space by a single neural network. Thereby, the present system eliminates a processing bottleneck, and dramatically improves response accuracy and speed to a complex request of the user. The present system is applicable to use cases such as a personal concierge service and an advanced decision-making support system. The present system feeds back an execution result of each task to the integrated vector again, and forms a continuous learning loop for improving inference accuracy of the next time.

As described above, the embodiment of the present invention realizes a comprehensive and highly personalized system capable of completing online shopping with a sense of satisfaction and a sense of security equal to or greater than those of a real store while the user stays at home, by the cooperation between the server and the terminal, the multilayered utilization of the generative AI, and the linkage of each unit, and fundamentally solves multifaceted and complex problems that could not be solved by conventional online shopping. Specifically, the present system functions as an information processing apparatus in which optimal allocation of hardware resources and sophistication of software algorithms are fused. The present system converts unstructured data acquired from a sensor group of the user terminal into structured data by a machine learning model group on the server side. The present system dynamically generates a virtual product experience transcending constraints of a physical space using this structured data. The present system fundamentally solves physical and cognitive problems such as a size mismatch due to an inability to try on and difficulty in imagining a coordination, which have been held by a conventional electronic commerce system, by integrating computer graphics technology and artificial intelligence technology. The present system includes a mechanism that continuously accumulates intermediate data generated by each module as learning data through a feedback loop, and self-organizingly improves inference accuracy of the entire system. Thereby, the present system brings about a technical effect that the accuracy of personalization improves as an operation period becomes longer. The present system is not merely a tool for business efficiency improvement, but provides a new data-driven commercial transaction architecture. The present system is widely applicable to use cases such as a sales platform for an expensive and complex product, such as a virtual viewing system for real estate and an online customized sales system for automobiles. The present system includes an encryption module that encrypts confidential data such as biometric information and a purchase history of the user, stores the encrypted data in a distributed storage, and ensures privacy protection and security.

### System Configuration

The system according to the present embodiment includes a user information acquisition unit, a product information management unit, a virtual fitting provision unit, an image recognition unit, a styling proposal unit, a trend analysis unit, an interactive assistant unit, a purchase support unit, and an inventory management unit. The user information acquisition unit receives an input from a user terminal, acquires a height, a weight, three sizes, a shoulder width, a waist, a hip, a thigh, a calf, an arm length, a neck circumference, a foot size, a face image, a skin color, a hairstyle, an age, a gender, and the like as body shape data of a user, further presents options such as casual, formal, street, natural, mode, elegant, and sporty as a favorite fashion taste, and records information selected by the user. In addition, the user information acquisition unit automatically collects a purchase date, a purchased product, a purchase amount, an evaluation, and a return history as a past purchase history, causes the user to input a budget per time, a monthly budget, and an annual budget as budget information, and acquires an occupation, a family structure, a commuting method, a hobby, how to spend holidays, work, raising a child, travel, a party, sports, a ceremonial occasion, and the like in detail as a lifestyle and a usage scene. For example, when the user takes a whole body photograph or a face photograph with a camera of a smartphone and uploads it to the application, the generative AI automatically extracts a body shape parameter, facial features, a skin color, a hairstyle, and the like from the image, and reduces time and effort for input. Furthermore, a product purchased by the user in the past, a browsing history, an evaluation/review, a return reason, and the like are also automatically collected and accumulated, and integrally managed in a user database on the server side. Specifically, the user information acquisition unit includes a data preprocessing pipeline for normalizing diverse data formats transmitted from the user terminal. The user information acquisition unit inputs text data input by the user to a natural language processing model, and encodes it as categorical data. The user information acquisition unit inputs an image tensor acquired from the camera of the user terminal to a face recognition model and a body shape estimation model. The body shape estimation model extracts an outline of a human body from the input image, and executes a regression operation for converting the number of pixels of each part into physical dimension data. The body shape estimation model outputs a numerical value such as a height of 160 centimeters or a waist of 65 centimeters as a floating-point number. The user information acquisition unit integrates the output numerical data and text data to generate a profile vector unique to the user. The present system uses this profile vector as a part of an input prompt to a subsequent generative AI model. The present system automatically generates a text string such as a height of 160 cm and a weight of 52 kg by a prompt generator, and inputs it to a large language model. The present system realizes highly accurate parameter extraction by computer image analysis technology while minimizing human manual input. Thereby, the present system brings about a technical effect of eliminating complexity of data input and improving a continuous usage rate of the system. The present system is applicable to use cases such as a health management application and a personal training support system. The present system also executes processing of inputting the extracted profile vector to a principal component analysis algorithm and performing dimensional compression to save a storage capacity.

The product information management unit is implemented on the server side, and manages 3D model data, a product image, a price, an inventory status, a brand, a category, a size, a color, a material, a product description, a washing instruction, a user review, a sales start date, limited product information, a restock schedule, discount information, and the like regarding a fashion product as a database. For example, even for the same product, a plurality of variations such as a different color, a different size, a limited collaboration model, and a pre-sales model are centrally managed, and optimal information is provided in response to a request from the user. Furthermore, as the product image, images from multiple viewpoints such as a front, a back, a side, a wearing example, an enlarged image, and a material up image are held, and as the 3D model data, highly accurate data including wrinkle and drape expressions at the time of wearing is managed. For example, a texture, gloss, transparency, an appearance at the time of layering, and the like for each material, such as a shirt of a cotton material, a dress of a linen material, a bag of leather, and a coat of wool, are recorded in detail. Specifically, the product information management unit includes a distributed object storage system for efficiently storing and searching large-capacity multimedia data. The product information management unit stores the 3D model data of the product in a binary format as a vertex coordinate array, a normal vector array, and a texture coordinate array of a polygon mesh. The product information management unit applies a data compression algorithm to the 3D model data to save a storage capacity and a communication bandwidth. The product information management unit converts text attribute information of the product into a high-dimensional embedding vector using a natural language processing model, and indexes and stores it in an in-memory vector database. The product information management unit holds the image data of the product as a plurality of resolution pyramids, and dynamically distributes an image tensor of an optimal resolution according to a screen size and a network bandwidth of the user terminal. The present system manages a parameter group for physically based rendering indicating light reflectance and transmittance for each material in association with each record in the database. Thereby, the present system enables extremely realistic texture expression in subsequent virtual fitting processing. The present system realizes integrated management of complex 3D data and a high-dimensional vector, which has been difficult with a conventional relational database, by a unique data structure. The present system is applicable to use cases such as a digital archive system and an asset management system of a game engine. The present system includes an integrity verification mechanism that applies a hash function to each record in the database and detects data falsification.

The virtual fitting provision unit synthesizes the body shape data of the user and the 3D model data for each product, and automatically generates a highly accurate 3D avatar dedicated to the user using the generative AI. For example, when the user takes whole body photographs from a plurality of angles and uploads them to the application, the generative AI generates a realistic 3D avatar reflecting a skeleton, a way muscles are attached, subtle unevenness of a body shape, a posture, facial features, a skin color, and a hairstyle. The avatar is caused to wear the 3D model data of the selected product, and a silhouette, a sense of size, a texture of a material, wrinkles and drapes according to movement, gloss, transparency, an appearance at the time of layering, and the like at the time of wearing are reproduced in real time. For example, when the user stands in front of a mirror at home using the camera of the smartphone, the avatar of the user appears on the screen, and a state of wearing the selected clothes can be superimposed and displayed in a real space. Furthermore, it is also possible to virtually try on a plurality of products simultaneously and compare and display them. As a specific example of a prompt text to be read by the generative AI, “Height 160 cm, weight 52 kg, shoulder width 38 cm, waist 65 cm, hip 90 cm, face image attached, hairstyle is short bob, skin color is bright, generate a realistic 3D avatar based on these pieces of information, and generate a virtual fitting image in a state of wearing a dress of product ID 12345” and the like can be cited. Specifically, the virtual fitting provision unit includes an image generation pipeline based on a conditional generative adversarial network. The virtual fitting provision unit inputs a body shape parameter vector of the user, a face image tensor, and the 3D model data of the product to an encoder network to generate a representation vector of a latent space. The virtual fitting provision unit combines this representation vector and a conditioning vector obtained by processing a prompt text automatically generated by the system with a text encoder. The virtual fitting provision unit inputs this combined vector to a decoder network. The decoder network repeatedly executes a deconvolution operation, and generates and outputs a high-resolution two-dimensional image tensor. For example, the decoder network outputs an image tensor with a resolution of 1024×1024. The virtual fitting provision unit applies a super-resolution model to this output image tensor to further emphasize a detailed texture. The present system transmits the generated image tensor to the user terminal, and displays it on a display on the terminal side. The present system does not require a physical fitting room, and instantly generates visual feedback equivalent to the real world by a tensor operation inside a computer. Thereby, the present system brings about a technical effect of strongly supporting purchase decision-making of the user and improving a conversion rate. The present system is applicable to use cases such as a cosmetic surgery simulation and a hairstyle proposal system. This model is trained by adversarial learning using pair data of millions of pairs of person images and clothing images so as to minimize a discrimination error between a generated image and a real image.

The image recognition unit receives a product image uploaded by the user from the terminal on the server side, and performs image analysis using the generative AI. For example, when the user takes a photograph of clothes of interest seen in a magazine or SNS and uploads it, the generative AI extracts feature amounts such as a color, a shape, a design, a material, a pattern, a brand logo, a decoration, a silhouette, and details (a button, a fastener, embroidery, a print, or the like) from the image, collates them with the database of the product information management unit, and searches for and presents a plurality of products with high similarity. For example, when an image of a dress with a floral pattern is uploaded, products having a similar floral pattern, silhouette, color tone, sense of material, and brand taste are listed up. Furthermore, ranking of similar products, filtering according to the preference of the user, and narrowing down by a price range and an inventory status are also automatically performed. As a specific example of a prompt text to be read by the generative AI, “Extract a color, a shape, a design, a material, a pattern, a brand logo, a decoration, a silhouette, and details of clothes in the attached image, and list up 10 products closest to these feature amounts from the database” and the like can be cited. Specifically, the image recognition unit includes a deep convolutional neural network optimized for a multi-label classification task. The image recognition unit executes preprocessing of noise removal and contrast adjustment on the image data received from the user terminal, and generates a standardized image tensor. The image recognition unit supplies this image tensor to an input layer of the neural network. The neural network hierarchically extracts a spatial feature of the image through a plurality of convolutional layers and pooling layers, and generates a sigmoid output vector indicating a probability of belonging to each feature category from a final fully connected layer. For example, the neural network outputs a probability of a floral pattern as 0.95 and a probability of a V-neck as 0.88. The image recognition unit extracts a feature label whose probability exceeds a threshold from this output vector, and constructs a search query vector. The image recognition unit executes similarity scoring based on inner product calculation on the product database using this search query vector, sorts product identifiers in descending order of score, and generates an output list. The present system can also drive an integrated model of vision and language using a prompt text automatically generated by the system, and output a feature extracted from an image as a natural language tag. The present system eliminates subjective tagging work by human visual inspection, and realizes objective and comprehensive feature extraction based on a pixel-level operation. Thereby, the present system dramatically improves comprehensiveness and accuracy of search. The present system is applicable to use cases such as a medical image diagnosis support system and an appearance inspection system for industrial products. This model is optimized by stochastic gradient descent using a cross-entropy loss function so as to minimize an error between a predicted label and a ground truth label.

The styling proposal unit generates a plurality of optimal coordination examples using the generative AI based on a body shape, facial features, a preference, a season, a usage scene, and trend information of the user. For example, when the user designates a usage scene such as “spring outing”, “for work”, “casual for raising a child”, “party”, “travel”, “watching sports”, and “ceremonial occasion”, the generative AI combines tops, bottoms, outerwear, an accessory, shoes, a bag, a hat, a stole, a belt, and the like from the database of the product information management unit, and proposes a coordination considering a body shape correction effect (a leg-lengthening effect by a waist mark, body shape cover by an A-line, and a small face effect by a V-neck), a balance of a color and a material, and a trend element (a pastel color, an oversized silhouette, a layered style, and a sustainable material trending this season). Furthermore, for each coordination example, an explanatory text such as “why this combination suits”, “what kind of body shape worries can be covered”, “which scene is optimal”, “relevance to a trend”, “tips for mixing and matching”, and “recommended use of accessories” is also automatically generated by the generative AI and presented to the user. As a specific example of a prompt text to be read by the generative AI, “Height 160 cm, weight 52 kg, shoulder width 38 cm, waist 65 cm, hip 90 cm, preference is natural, usage scene is spring outing, trend of this season is pastel color and linen material, propose 3 patterns of optimal coordinations under these conditions, and explain a reason for combination, a body shape correction effect, a recommended scene, relevance to a trend, and tips for mixing and matching for each” and the like can be cited. Specifically, the styling proposal unit includes a hybrid inference engine integrating a recommendation algorithm based on reinforcement learning and a large language model. The styling proposal unit inputs a body shape parameter of the user, a preference vector, and a category identifier indicating a usage scene to a reinforcement learning agent as a state vector. The reinforcement learning agent searches a combination of items in the product database as an action space, determines a combination of a coordination that maximizes satisfaction of the user, and outputs a list of item identifiers. The styling proposal unit embeds this item identifier list and attribute information of the user in a template, and automatically generates a prompt text. The styling proposal unit inputs this prompt text to the large language model. The large language model analyzes a context of the input text by a self-attention mechanism, and outputs natural language text data explaining a reason for combination of each item and a body shape correction effect. For example, the large language model outputs a text string that an A-line silhouette covers a waist and a pastel color produces a sense of spring season. The present system synchronizes this output text and a coordination image, and transmits them to the user terminal. The present system realizes a persuasive proposal accompanied by a logical explanation, not a mere enumeration of products, by automatic generation of a computer. Thereby, the present system brings about a technical effect of enhancing a sense of satisfaction of the user and improving a success rate of cross-selling. The present system is applicable to use cases such as a portfolio proposal system for financial products and an automatic generation system for travel plans. When the user rejects a proposal, the present system gives the feedback to a reinforcement learning model as a negative reward, and improves proposal accuracy of the next time.

The trend analysis unit periodically collects external data such as SNS, fashion magazines, and collections, and extracts latest fashion trend information using generative AI. For example, the trend analysis unit analyzes hashtags rapidly increasing on SNS, feature articles in fashion magazines, runway images of collections, posts by influencers, street snaps, new product information of overseas brands, search trends of search engines, and the like, and automatically extracts colors, patterns, silhouettes, materials, brand tendencies, dressing techniques, popular items, notable collaborations, sustainable fashion trends, and the like that are popular this season. For example, specific trend keywords and dressing examples such as “green items are popular this season”, “oversized shirts are popular”, “linen dresses are attracting attention”, and “limited collaborations of overseas brands are a hot topic” are customized for each user and presented. Specific examples of a prompt sentence to be read by the generative AI include “Extract popular colors, popular patterns, popular silhouettes, popular brands, notable dressing techniques, and sustainable fashion trends of this season based on the latest data of SNS, fashion magazines, and collections, and present 10 items in a ranking format”. Specifically, the trend analysis unit includes a distributed stream processing infrastructure for processing large-scale unstructured data. The trend analysis unit continuously acquires thousands of pieces of text data and image data per second through an external application programming interface or a scraping tool. The trend analysis unit inputs the acquired text data into a transformer-based named entity extraction model, extracts entities related to fashion, and counts an appearance frequency. The trend analysis unit inputs the acquired image data into an image classification model, identifies categories of colors and silhouettes included in the image, and generates histogram data. The trend analysis unit integrates the count data and the histogram data as time-series tensor data, and inputs the time-series tensor data into a long short-term memory network. The network predicts an increase or decrease in future trend elements from past time-series patterns, and outputs a trend score of each element. The trend analysis unit generates a ranking list based on the trend score. The trend analysis unit converts the ranking list into a prompt text, inputs the prompt text into a large language model, and causes the large language model to output a summary text explaining a background of the trend and dressing techniques. The system completely automates market research manually performed by human analysts by enormous data processing and a machine learning algorithm. Thereby, the system brings about a technical effect of capturing a change in trend in real time and preventing a delay in product development. The system is applicable to use cases such as a sentiment analysis system of a stock market and an automatic news summarization system. The system also executes a process of converting the extracted trend data into a structured data format for a dashboard and outputting the structured data format as a visual graph to a terminal of an administrator.

The interactive assistant unit generates an optimal answer or advice in real time to a question or request by voice or text from the user terminal using the generative AI while referring to user information, product information, styling information, trend information, a purchase history, and the like, and returns the answer or advice to the user terminal. For example, in response to various questions such as “Does this clothes suit me?”, “Are there any other recommendations?”, “How should I return the product?”, “What is the trend this season?”, “Please propose a coordination within the budget”, “How is the sense of size of this brand?”, “What are the tips for selecting a size of an overseas brand?”, “What kind of scene is this product suitable for?”, and “What are items that can cover a body shape?”, the generative AI returns a personal answer according to an attribute and a situation of the user. Specific examples of a prompt sentence to be read by the generative AI include “User information: height 160 cm, weight 52 kg, shoulder width 38 cm, waist 65 cm, hip 90 cm, preference is natural, past purchase history exists, question: Does this dress suit me? In response to this, generate personal advice considering the body shape, the preference, the past purchase history, and the trend of this season”. Specifically, the interactive assistant unit includes a large language model based on a transformer architecture. The large language model is a neural network having billions of parameters. The interactive assistant unit receives a natural language text input from the user terminal. In the case of voice input, the interactive assistant unit converts an acoustic feature amount into text data using a voice recognition module. The interactive assistant unit divides the input text into a token sequence by a tokenizer. The interactive assistant unit converts the token sequence into a high-dimensional word embedding vector. The interactive assistant unit uses a retrieval-augmented generation technology. The interactive assistant unit acquires an attribute vector indicating the height and preference of the user from a user information database. The interactive assistant unit acquires a product feature vector from a product information database. The interactive assistant unit combines these vectors with the embedding vector of the input text. The interactive assistant unit supplies the combined vector as an input tensor of the large language model. The number of dimensions of the input tensor is, for example, 512 dimensions or 1024 dimensions. Specific examples of the input data include numerical data indicating the height of the user of 160 cm, an array of product IDs indicating the past purchase history, and a token sequence of a text “Does this clothes suit me?”. The large language model calculates a dependency relationship between each token in the input tensor using a self-attention mechanism. The large language model outputs a probability distribution of a word appearing next after understanding a context. The interactive assistant unit autoregressively generates a response text based on the probability distribution. A format of the output data is a text character string of a natural language and structured data of a related product ID. Specific examples of the output data include text data “This V-neck dress suits your straight skeleton body shape very well” and an ID “98765” of a recommended product. The interactive assistant unit transmits the generated response text to a subsequent voice synthesis module or display control module. The display control module renders the response text on a screen of the user terminal. With this configuration, the system generates a dynamic response completely adapted to an individual context of the user, rather than a mere fixed-phrase reply. This process not only substitutes manual customer service by a human operator, but also brings about an improvement peculiar to computer technology of providing a personalized answer with a delay in milliseconds even for simultaneous access of thousands of people. The present technology is applicable to various fields such as automatic customer support in an e-commerce platform and an interactive customer service system through digital signage in a real store.

The purchase support unit collates the budget information of the user with a product price and the inventory status, and preferentially displays only products purchasable within a budget. For example, when the user sets the budget to 20,000 yen, only products and coordinations that can be purchased within 20,000 yen are presented. In a purchase procedure, input assistance for a delivery destination and a payment method, tracking of a delivery status, automation of a return/exchange procedure, and the like are managed on the server side, and a progress status and a necessary action are notified to the user terminal. For example, every time the delivery status is updated to “shipped”, “delivering”, “delivery completed”, or the like, a push notification is transmitted to the user terminal. Furthermore, when the user inputs a request such as “I want to return the product” or “I want to exchange the size”, the generative AI guides a return reason and a procedure method, and automatically generates and provides necessary documents and return destination information. Specific examples of a prompt sentence to be read by the generative AI include “The budget of the user is 20,000 yen, list products purchasable within the budget based on a product list, prices, and inventory statuses, and generate a guidance text of a flow of a purchase procedure, a delivery status, and a return/exchange procedure”. Specifically, the purchase support unit includes a hybrid architecture integrating a rule-based filtering engine and a machine learning-based recommendation model. The purchase support unit acquires numerical data indicating a budget upper limit value set from the user terminal. The purchase support unit acquires numerical data indicating a price of each product and a binary flag indicating an inventory status from the product information database. The purchase support unit executes a filtering process using these data as an input. The purchase support unit extracts only products whose price is equal to or less than the budget upper limit value and whose inventory flag is valid. The purchase support unit inputs a list of the extracted products into the recommendation model. The recommendation model is constructed using a gradient boosting decision tree algorithm. Input data to the recommendation model is a past purchase history vector of the user, a category vector of the product, and numerical data indicating a price range. Specific examples of the input data include an integer value indicating a budget of 20,000 yen, an integer value indicating a price of 15,000 yen of a product ID “11223”, and a Boolean value indicating that there is an inventory. The recommendation model calculates a score indicating a purchase probability of the user for each product. The purchase support unit sorts the product list in descending order based on the calculated score. A format of the output data is an array of sorted product IDs and a purchase probability score of each product. Specific examples of the output data include a pair of a product ID “11223” and a score “0.85”, and a product ID “44556” and a score “0.72”. The purchase support unit transmits the sorted list to a subsequent display control module. The display control module preferentially renders products high in the list on the screen of the user terminal. Furthermore, the purchase support unit manages a progress of the purchase procedure using a state transition machine. The purchase support unit cooperates with an external application programming interface of a logistics system. The purchase support unit asynchronously receives a change event of a delivery status. The purchase support unit activates a push notification generation module at the moment of detecting a status change by an event-driven architecture. The push notification generation module dynamically generates a notification text for the user using a large language model. With this configuration, the system instantaneously extracts an optimal product matching an economic constraint of the user from an enormous product database, and tracks a transaction state from purchase to delivery in real time. This process exhibits a technical effect of significantly reducing a calculation amount of data search and optimizing memory consumption of the server. The present technology is widely applicable to dynamic catalog generation in an online shopping mall, an automatic payment management system in a subscription service, and the like.

The inventory management unit stores the preference and purchase tendency of the user, automatically detects a product with low inventory, a new product, a limited product, and the like, and notifies the user terminal. For example, when a product that the user has browsed many times in the past has only one item left, an alert of “low inventory” is immediately displayed. Furthermore, price negotiation and purchase agency for a limited product can be executed using the generative AI. For example, when the user requests “I want to buy this product a little cheaper”, the AI can automatically negotiate with a seller side to draw out a discount or a privilege. Lottery sales, advance reservations, restock notifications, and the like of limited products are also automatically managed to support the user to obtain a desired product without missing it. Specific examples of a prompt sentence to be read by the generative AI include “Extract a product with low inventory, a new product, and a limited product based on a product list browsed by the user in the past and an inventory status, and generate an alert text and a purchase recommendation text for notifying the user. Also, generate a negotiation text for price negotiation and purchase agency”. Specifically, the inventory management unit includes a time-series data analysis model and a reinforcement learning-based autonomous agent. The inventory management unit acquires time-series array data indicating a browsing history of a product from an action log database of the user. The inventory management unit acquires time-series array data indicating a transition of the number of inventories of each product from the product information database. The inventory management unit inputs these time-series data into a long short-term memory neural network. The long short-term memory neural network learns a correlation between a past browsing frequency and an inventory decrease speed. Specific examples of the input data include an integer array indicating the number of times of browsing a specific product in the past 7 days, and an integer array indicating a decrease amount of the number of inventories in the same period. The long short-term memory neural network outputs a prediction score indicating a probability that a target product will be sold out within the next 24 hours. The inventory management unit generates a low inventory alert flag when the prediction score exceeds a preset threshold value. Specific examples of the output data include a floating-point number indicating a sold-out probability “0.92”, and a truth value indicating alert firing. The inventory management unit transmits the alert flag to a subsequent notification distribution module. The notification distribution module transmits a highly immediate push notification to the user terminal. Furthermore, the inventory management unit implements a reinforcement learning agent for executing price negotiation. The reinforcement learning agent uses a Q-learning algorithm based on a Markov decision process. An input state vector to the reinforcement learning agent includes a current presented price, a desired price of the user, a past discount tolerance of the seller side, and the current number of inventories. The reinforcement learning agent outputs a vector of an optimal negotiation price and a negotiation text to be presented to an automatic response system of the seller side. The reinforcement learning agent continuously updates a weight using a reward function designed to receive a positive reward when a negotiation is established and receive a negative reward when a negotiation breaks down. With this configuration, the system realizes proactive information provision predicting a degree of interest of the user and a dynamic change in a market, rather than a mere threshold determination of the number of inventories. This process automatically executes complex price negotiation in milliseconds without human intervention, and brings about an improvement peculiar to computer technology of dramatically improving a contract rate of a transaction. The present technology is applicable to fields requiring advanced supply and demand prediction, such as an automatic bidding system for a limited product with high scarcity value and an airline ticket reservation system adopting dynamic pricing.

As described above, in the system according to the present embodiment, each unit cooperates to realize a highly personalized experience according to various needs and situations of the user, the generative AI plays an indispensable role in main processing of each unit, and information generation, proposal, support, and management optimized for each user are realized by designing and operating a prompt sentence. Specifically, the system is constructed on a distributed computing environment based on a microservice architecture. The system deploys each functional module such as the user information acquisition unit, the product information management unit, and the virtual fitting provision unit as an independent container. The system constantly monitors a load status of each module using a container orchestration tool. The system dynamically scales the number of replicas of each container according to an increase or decrease in traffic. The system executes communication between each module via an asynchronous messaging queue. The system arranges a generative artificial intelligence model on a parallel computing cluster dedicated to inference. The system aggregates a text vector of a prompt sentence transmitted from each functional module at an application programming interface gateway. The system distributes and allocates the aggregated requests to a plurality of computing nodes in the inference cluster. The system strictly separates a system prompt and a user prompt in designing a prompt sentence. The system describes a role of each module and a constraint of an output format in the system prompt. The system embeds a dynamically acquired user attribute vector and product feature vector in the user prompt. With this configuration, the system eliminates a single point of failure and maximizes availability and fault tolerance of the entire system. This process exhibits a technical effect of preventing competition of computing resources when executing a complex artificial intelligence inference task concurrently in a plurality of modules, and maximizing throughput of the entire system. The present technology is applicable to a base system of a large-scale e-commerce platform, an autonomous business support system in which a plurality of artificial intelligence agents operate in cooperation, and the like.

### Implementation Steps

### Step 1: Acquisition and Registration of User Information

The user inputs or photographs with a camera body shape data such as height, weight, three sizes, shoulder width, waist, hip, thigh, calf, arm length, neck circumference, foot size, a face image, a skin color, a hairstyle, an age, and a gender using an application or a web interface on a terminal, and further registers in detail a favorite fashion taste (casual, formal, street, natural, mode, elegant, sporty, or the like), a past purchase history (a purchase date, a purchased product, a purchase amount, an evaluation, and a return history), budget information (a budget per time, a monthly budget, and an annual budget), a lifestyle (an occupation, a family structure, a commuting means, a hobby, and how to spend holidays), a usage scene (work, childcare, travel, a party, sports, ceremonial occasions, or the like), and the like. These pieces of information are integratedly managed in a user database on the server side. Specifically, the user information acquisition unit includes a multimodal data processing pipeline. The user information acquisition unit receives pixel data of a face image and a whole body image acquired from a camera module of the user terminal as a multidimensional tensor. The user information acquisition unit executes preprocessing such as noise removal and normalization on the image tensor. The user information acquisition unit inputs the preprocessed image tensor into a convolutional neural network. The convolutional neural network extracts visual feature amounts such as a contour of a face, a pigment distribution of skin, and a texture of a hairstyle from the image. The user information acquisition unit converts the extracted feature amounts into a high-dimensional visual feature vector. At the same time, the user information acquisition unit receives numerical data such as height and weight input from an input interface of the user terminal. The user information acquisition unit standardizes these numerical data by a scaling process, and generates a numerical feature vector. The user information acquisition unit inputs natural language data such as a fashion taste and a lifestyle input in a text format into a natural language processing model. The natural language processing model converts the text data into a semantic embedding vector. Specific examples of the input data include an RGB image tensor with a resolution of 1024 by 1024, a floating-point number indicating a height of 160 cm, and a token sequence of a text “I like casual”. The user information acquisition unit combines the visual feature vector, the numerical feature vector, and the embedding vector, and generates a single integrated user profile vector. A format of the output data is, for example, an array of 2048-dimensional floating-point numbers. Specific examples of the output data include a numerical sequence such as “0.15, −0.42, 0.88” in which each dimension indicates an intensity of a specific user attribute. The user information acquisition unit stores the generated integrated user profile vector in a subsequent vector database. The vector database constructs an index structure enabling high-speed similarity search in a high-dimensional space. With this configuration, the system converts various user data having different formats into a unified mathematical expression, and constructs a state in which a subsequent artificial intelligence model can efficiently process the data. This process exhibits a technical effect of preventing data siloing and dramatically improving calculation accuracy and speed of a personalization process. The present technology is applicable to a biometric data integrated management system in a healthcare application, a body shape change tracking system in a fitness service, and the like.

### Step 2: Management and Collection of Product Information

The product information management unit on the server side centrally manages 3D model data, a product image (a front, a back, a side, a wearing example, an enlarged image, and a material up image), a price, an inventory status, a brand, a category, a size, a color, a material, a product description, a washing instruction, a user review, a sales start date, limited product information, a restock schedule, discount information, and the like regarding a fashion product as a database. For example, a plurality of variations such as different colors, different sizes, a limited collaboration model, and an advance sales model are recorded in detail even for the same product. Specifically, the product information management unit includes a large-scale multimedia database and an automatic feature amount extraction engine. The product information management unit receives 3D model data of a product in a format of a polygon mesh from an external system of an apparel manufacturer or a seller. The product information management unit receives 2D image data of a product as a high-resolution pixel array. The product information management unit receives text metadata such as a price and a material of a product. The product information management unit adopts a hybrid configuration of a relational database and a document-oriented database for integratedly managing these heterogeneous data. The product information management unit activates the automatic feature amount extraction engine, and generates a feature vector for search from the received data. The automatic feature amount extraction engine applies an image recognition model having a residual network architecture to image data. The automatic feature amount extraction engine applies a bidirectional encoder representation model to text data. Specific examples of the input data include 3D mesh data including vertex coordinates and a normal vector, a tensor of a product image photographed from the front, and a character string of a product description “100% cotton sheer blouse”. The automatic feature amount extraction engine outputs a multidimensional product feature vector fusing a visual feature and a semantic feature of the product from these input data. A format of the output data is a high-dimensional vector uniquely linked to each product. Specific examples of the output data include a floating-point array such as “0.75, 0.22, 0.91” obtained by digitizing a color component, shape complexity, and a material texture. The product information management unit registers the generated product feature vector in a vector search engine. The vector search engine constructs an index using a hierarchical navigable small world graph algorithm. With this configuration, the system maintains an enormous product group of millions of items in a state capable of being instantaneously searched based on visual and semantic similarity rather than a mere keyword. This process eliminates search omission in a conventional text-based search system, and brings about an improvement peculiar to computer technology of shortening a query response time of a database to milliseconds. The present technology is widely applicable to a digital asset management system, a 3D model search system for parts in a manufacturing industry, and the like.

### Step 3: Similar Product Search by Image Recognition

When the user takes a photograph of clothes of interest seen in a magazine or SNS from the terminal and uploads it to the application, the image recognition unit on the server side extracts feature amounts such as a color, a shape, a design, a material, a pattern, a brand logo, a decoration, a silhouette, and details (a button, a fastener, embroidery, a print, or the like) from the image using the generative AI, collates them with the database of the product information management unit, and searches for and presents a plurality of products with high similarity. Specific examples of a prompt sentence to be read by the generative AI include “Extract a color, a shape, a design, a material, a pattern, a brand logo, a decoration, a silhouette, and details of clothes in an attached image, and list 10 products closest to these feature amounts from a database”. Specifically, the image recognition unit includes a similar image search pipeline using deep metric learning. The image recognition unit receives query image data transmitted from the user terminal as a multidimensional image tensor. The image recognition unit executes preprocessing including resizing, cropping, and color space normalization on the image tensor. The image recognition unit inputs the preprocessed image tensor into a convolutional neural network for feature extraction. The convolutional neural network has a weight parameter pre-trained using a dataset of millions of fashion images. Specific examples of the input data include an RGB image tensor with a resolution of 512 by 512 photographed by the user with a smartphone. The convolutional neural network hierarchically extracts from low-order features such as an edge, a texture, and a spatial arrangement of a pattern to high-order features such as an overall silhouette of clothes and a brand logo from the input image. The convolutional neural network outputs the extracted features as, for example, a 1024-dimensional query feature vector. The image recognition unit transmits the generated query feature vector to the vector database of the product information management unit. The vector database calculates a cosine similarity between the query feature vector and all product feature vectors in the database. The vector database specifies top N products having the highest similarity score. A format of the output data is an array of pairs of a similarity score and a product ID. Specific examples of the output data include a list of a product ID “55667” and a similarity score “0.95”, and a product ID “88990” and a similarity score “0.89”. The image recognition unit transmits the specified product list to a subsequent display control module. The display control module renders a search result in a grid format on the screen of the user terminal. With this configuration, the system converts an ambiguous visual image that the user cannot verbalize into an accurate mathematical vector, and executes a neighborhood search in a high-dimensional space. This process exhibits a technical effect of breaking through a limit of a conventional search method based on tagging, dramatically improving search accuracy, and completely eliminating manual metadata input work. The present technology is applicable to a visual search system for interior furniture, an automatic search system for similar cases in medical images, and the like.

### Step 4: Provision of Virtual Fitting Experience

When the user takes whole body photographs from a plurality of angles and uploads them to the application, the virtual fitting provision unit on the server side generates a realistic 3D avatar reflecting a skeleton, a way muscles are attached, subtle unevenness of a body shape, a posture, facial features, a skin color, and a hairstyle using the generative AI, causes the avatar to wear the 3D model data of the selected product, reproduces a silhouette, a sense of size, a sense of material, wrinkles and drapes according to movement, gloss, a sheer feeling, an appearance at the time of layering, and the like at the time of wearing in real time, and allows the user to experience them as an AR display or a VR display on the terminal. Specific examples of a prompt sentence to be read by the generative AI include “Height 160 cm, weight 52 kg, shoulder width 38 cm, waist 65 cm, hip 90 cm, face image attached, hairstyle is short bob, skin color is bright, generate a realistic 3D avatar based on these pieces of information, and generate a virtual fitting image in a state of wearing a dress of a product ID 12345”. Specifically, the virtual fitting provision unit includes a physics-based rendering engine and a generative adversarial network. The virtual fitting provision unit acquires a numerical vector indicating the body shape data of the user and a tensor of the face image from the user information acquisition unit. The virtual fitting provision unit generates a base mesh of a 3D avatar accurately reflecting the body shape of the user from the input numerical vector using a parametric human body model. The virtual fitting provision unit generates a texture map from the face image tensor, and maps the texture map to a head region of the base mesh. The virtual fitting provision unit acquires a 3D clothes mesh of the selected product and a physical parameter of a material from the product information management unit. The physical parameter includes rigidity, mass, a friction coefficient, and stretchability of cloth. Specific examples of the input data include an array of floating-point numbers indicating the height and three sizes of the user, an array of 3D vertex coordinates of the product, and numerical data indicating bending rigidity of cloth. The virtual fitting provision unit executes a process of covering the 3D avatar mesh with the 3D clothes mesh while performing collision determination using a physical simulation engine. The physical simulation engine calculates deformation of cloth, generation of wrinkles, and formation of drapes according to gravity and a posture change of the user on a vertex basis. Furthermore, the virtual fitting provision unit improves reality of a rendering result using a generative adversarial network. A generator of the generative adversarial network receives an image tensor of a simulation result as an input, and outputs a high-definition image tensor in which reflection of light and a way a shadow falls are corrected. A format of the output data is an RGB alpha image tensor and a depth map of each frame. Specific examples of the output data include full high-definition image data with a resolution of 1920 by 1080, and depth data indicating depth information of each pixel. The virtual fitting provision unit streaming-distributes the generated image tensor to a subsequent augmented reality display module. The augmented reality display module synthesizes the image tensor with a camera video of the user terminal and displays it on the screen. With this configuration, the system executes a strict 3D space calculation based on a physical law, rather than a mere superimposition of images. This process exhibits a technical effect of dramatically reducing a return rate due to size mismatch or image difference in online shopping, and reducing a load of return logistics consuming a network bandwidth. The present technology is applicable to a dynamic costume generation system for a game avatar, a costume simulation for a digital extra in movie production, and the like.
Step 5: Styling Proposal and Coordination Generation When a user inputs a usage scene, a preference, a body shape concern, and the like, a styling proposal unit on a server side combines tops, bottoms, outerwear, an accessory, shoes, a bag, a hat, a stole, a belt, and the like from a database of a product information management unit using generative AI, generates a plurality of coordinations considering a body shape correction effect, a balance of a color and a material, and a trend element, and automatically generates and presents an explanatory text such as “why this combination suits”, “what kind of body shape concern can be covered”, “which scene is optimal”, “relevance to a trend”, “tips for mixing and matching”, and “recommended use of small items” for each coordination example. As a specific example of a prompt sentence to be read by the generative AI, “Height 160 cm, weight 52 kg, shoulder width 38 cm, waist 65 cm, hip 90 cm, preference is natural, usage scene is spring outing, trend of this season is pastel color and linen material, propose 3 patterns of optimal coordination under these conditions, and explain a reason for combination, a body shape correction effect, a recommended scene, relevance to a trend, and tips for mixing and matching for each” and the like are given. Specifically, the styling proposal unit includes a recommendation engine integrating a graph neural network and a large language model. The styling proposal unit acquires an attribute vector and a past purchase history vector of the user from a user information acquisition unit. The styling proposal unit acquires a feature vector group of products belonging to a plurality of categories from the product information management unit. The styling proposal unit expresses these vectors as graph structure data. In the graph structure data, a node represents a user or a product, and an edge represents an interaction between the user and the product or compatibility between products. The styling proposal unit executes message passing between nodes using the graph neural network. The graph neural network learns a high-order connection relationship and predicts an optimal combination of products for a specific user. Specific examples of input data include a feature vector of a user node, a feature vector of a tops product node, and a feature vector of a bottoms product node. The graph neural network outputs a fitness score for a combination of a plurality of product nodes. The styling proposal unit extracts a combination having a high fitness score. The styling proposal unit inputs a product ID list of the extracted combination and the attribute vector of the user to the large language model. The large language model generates a natural language text explaining why the combination is optimal for the user based on the input data. A format of output data is an array of product IDs constituting the coordination, and text data of an explanatory text. Specific examples of the output data include an array of tops ID “111”, bottoms ID “222”, and shoes ID “333”, and a text character string “A V-neck tops makes a neck area look neat, and high-waist bottoms bring a leg-lengthening effect”. The styling proposal unit transmits the generated data to a subsequent display control module. The display control module lays out and displays a coordination image and the explanatory text on a screen of a user terminal. With this configuration, the system mathematically elucidates a complex dependency relationship between a plurality of items, not limited to recommendation of a single product, and automatically generates a harmonized combination as a whole. This processing algorithmizes tacit knowledge of a professional stylist, and brings about an improvement peculiar to computer technology of providing a personalized proposal on a large scale and instantaneously. This technology is applicable to a furniture arrangement proposal system for an interior, an automatic recipe generation system based on a combination of ingredients, and the like.
Step 6: Trend Analysis and Reflection of Latest Information A trend analysis unit on the server side periodically collects external data such as SNS, fashion magazines, and collections, automatically extracts a color, a pattern, a silhouette, a material, a brand tendency, a dressing technique, a popular item, a notable collaboration, a trend of sustainable fashion, and the like that are popular this season using the generative AI, and reflects them in a styling proposal and a product recommendation function in real time. As a specific example of a prompt sentence to be read by the generative AI, “Extract a trend color, a trend pattern, a trend silhouette, a popular brand, a notable dressing technique, and a trend of sustainable fashion of this season based on latest data of SNS, fashion magazines, and collections, and present 10 items in a ranking format” and the like are given. Specifically, the trend analysis unit includes a multimodal data mining pipeline using a natural language processing model and a computer vision model. The trend analysis unit periodically executes a web scraping module. The web scraping module accesses an application programming interface of a designated social networking service or fashion information site. The web scraping module collects a large amount of latest posted text data and image data. The trend analysis unit inputs the collected text data to a transformer-based language model. The language model extracts a frequently appearing keyword, emotional polarity, and a contextual topic from the text. The trend analysis unit inputs the collected image data to an image recognition model. The image recognition model extracts a feature vector of a color, a shape, and a pattern of worn clothes from the image. Specific examples of input data include a character string array of a posted text of an influencer, and a batch of image tensors attached to the post. The trend analysis unit maps the extracted text feature and image feature to the same latent space, and applies a clustering algorithm. The clustering algorithm identifies a set of dense data points as a new trend. The trend analysis unit calculates a growth rate and a diffusion speed of the identified trend using a time series analysis model. A format of output data is structured data including a trend keyword, a representative feature vector, and a trend score. Specific examples of the output data include a data set of a keyword “sheer material”, a color code “hashtag FFB6C1”, and a trend score “0.85”. The trend analysis unit transmits the generated trend data to the product information management unit and the styling proposal unit. The product information management unit dynamically updates a search weight of a product in a database based on the trend data. With this configuration, the system objectively and quantitatively extracts a market trend from a huge amount of unstructured data without depending on human subjectivity. This processing exhibits a technical effect of dramatically improving an adaptation speed of the system to a change in a trend, and realizing a recommendation always reflecting a latest market environment. This technology is widely applicable to a sentiment analysis system in a financial market, a consumer needs prediction system for new product development, and the like.
Step 7: Personal Support by Interactive Assistant When the user inputs a question or request by voice or text from the terminal, an interactive assistant unit on the server side generates an optimal answer or advice in real time using the generative AI while referring to user information, product information, styling information, trend information, a purchase history, and the like, and returns a reply to the user terminal. For example, in response to a question such as “Does this clothes suit me?”, “Are there any other recommendations?”, “How should I return a product?”, “What is the trend this season?”, and “I want you to propose a coordination within a budget”, the generative AI returns a personal answer according to an attribute and a situation of the user. As a specific example of a prompt sentence to be read by the generative AI, “User information: height 160 cm, weight 52 kg, shoulder width 38 cm, waist 65 cm, hip 90 cm, preference is natural, past purchase history exists, question: Does this dress suit me? In response to this, generate personal advice considering a body shape, a preference, a past purchase history, and a trend of this season” and the like are given. Specifically, the interactive assistant unit includes an advanced natural language processing system implementing a retrieval-augmented generation pipeline. The interactive assistant unit receives voice stream data acquired from a microphone of the user terminal, or a text character string input from a keyboard. When receiving the voice data, the interactive assistant unit converts an acoustic feature amount into a text token using a deep learning-based voice recognition engine. The interactive assistant unit inputs the input question text to a query encoder, and generates a high-dimensional query vector. The interactive assistant unit executes a similarity search in parallel on vector indexes of a user information database, a product information database, and a trend information database using this query vector. The interactive assistant unit acquires a related text chunk obtained as a search result. Specific examples of input data include a text character string of a question “Does this dress suit me?”, a numerical vector indicating body shape data of the user, and a feature vector of a target product. The interactive assistant unit combines the acquired related text chunk and the original question text, and constructs a prompt tensor to be input to a context window of the large language model. The large language model weights and evaluates relevance of each piece of information in a prompt using a self-attention mechanism. The large language model autoregressively generates a text serving as a direct answer to the question while satisfying constraints of the body shape and the preference of the user. A format of output data is a generated text character string of a natural language, and metadata including a related product ID and a URL link. Specific examples of the output data include text data “Considering your waist size and favorite taste, this dress suits you very well”, and an ID list of similar products. The interactive assistant unit transmits the generated answer text to a subsequent user interface control module. With this configuration, unlike a static FAQ system, the system dynamically collects and integrates information from a plurality of databases, and generates an answer after going through an inference process. This processing brings about an improvement peculiar to computer technology of improving a resolution rate for a complex inquiry of a user, and significantly reducing a load of support work by a human operator. This technology is applicable to an in-house help desk automation system of a company, an initial medical interview system for a patient in a medical institution, and the like.
Step 8: Purchase Support and Procedure Automation A purchase support unit on the server side collates budget information of the user with a product price and an inventory status, preferentially displays only a product purchasable within a budget, manages input assistance for a delivery destination and a payment method, tracking of a delivery status, automation of a return/exchange procedure, and the like in a purchase procedure, and notifies the user terminal of a progress status and a necessary action. For example, every time the delivery status is updated to “shipped”, “delivering”, “delivery completed”, or the like, a push notification is transmitted to the user terminal. As a specific example of a prompt sentence to be read by the generative AI, “User's budget is 20,000 yen, list up products purchasable within the budget based on a product list, a price, and an inventory status, and generate a guidance text of a flow of a purchase procedure, a delivery status, and a return/exchange procedure” and the like are given. Specifically, the purchase support unit includes a distributed transaction processing engine and a rule-based workflow automation module. The purchase support unit receives a product ID list in a cart and numerical data indicating a budget upper limit value of the user transmitted from the user terminal. The purchase support unit issues a query to the database of the product information management unit, and acquires latest price data and an inventory flag of each product. The purchase support unit calculates a total value of the acquired price data, and executes conditional branch processing of comparing it with the budget upper limit value. When the total value exceeds the budget, the purchase support unit executes an optimization algorithm of excluding a product with a low priority score from the cart. Specific examples of input data include an integer value indicating a budget of 20,000 yen, and numerical data indicating a price of 8,000 yen for a product ID “101” and a price of 15,000 yen for a product ID “102” in the cart. The purchase support unit calculates a combination of products falling within the budget, and outputs it as a purchasable product list. When the user confirms a purchase, the purchase support unit calls an application programming interface of a payment gateway, and executes a secure payment transaction. After completion of the payment, the purchase support unit transmits a request for delivery arrangement to an external interface of a logistics management system. The purchase support unit asynchronously receives an update event of a delivery status periodically transmitted from the logistics system via a message queue. When detecting that the status has been changed, the purchase support unit activates a push notification generation module. A format of output data is JSON data of a notification payload transmitted to the user terminal. Specific examples of the output data include text data including a title “Notice of Shipment Completion”, a body “The ordered product has been shipped”, and a tracking number. When receiving a return request, the purchase support unit analyzes a reason for return using the large language model, and automatically performs return reception processing and generation of label data for return. With this configuration, the system completely automates a series of commercial transaction processes from product selection to payment, delivery tracking, and after-sales support. This processing exhibits a technical effect of reliably performing asynchronous communication with a plurality of external systems, and minimizing a processing delay while guaranteeing data consistency. This technology is applicable to an automatic ordering system in supply chain management, an automatic contract renewal system for a subscription service, and the like.
Step 9: Inventory Management and Limited Product/New Product Notification An inventory management unit on the server side stores a preference and a purchase tendency of the user, automatically detects a product with low inventory, a new product, a limited product, and the like, and notifies the user terminal. For example, when a product that the user has browsed many times in the past has only one item left, an alert of “low inventory” is immediately displayed. Furthermore, price negotiation and purchase agency for a limited product can also be executed using the generative AI, and when the user requests “I want to buy this product a little cheaper”, the AI can automatically negotiate with a seller side and draw out a discount or a privilege. As a specific example of a prompt sentence to be read by the generative AI, “Extract a product with low inventory, a new product, and a limited product based on a product list browsed by the user in the past and an inventory status, and generate an alert text and a purchase recommendation text for notifying the user. Also, generate a negotiation text for price negotiation and purchase agency” and the like are given. Specifically, the inventory management unit includes a predictive analysis model and an autonomous agent architecture. The inventory management unit acquires log data of a past browsing history, a favorite registration history, and a purchase history of the user from a time series database. The inventory management unit acquires data indicating a current inventory number and a scheduled arrival date of each product from the product information management unit. The inventory management unit executes a collaborative filtering algorithm for calculating an interest level score for a product for each user using these data as an input. The inventory management unit fires an event trigger when the interest level score exceeds a certain threshold value and the inventory number of the target product falls below a preset lower limit value. Specific examples of input data include log data indicating that the user has browsed a specific product page 5 times in the past 3 days, and an integer value indicating that the current inventory number of the product is 2. The inventory management unit activates a notification generation module in response to the event trigger, and transmits a low inventory alert to the user terminal. Furthermore, the inventory management unit includes a reinforcement learning-based autonomous agent for executing price negotiation and purchase agency. The autonomous agent receives numerical data of a desired purchase price input from the user. The autonomous agent transmits a negotiation request to an automatic pricing application programming interface on the seller side. The autonomous agent generates a text vector of an optimal presentation price or discount request using a policy network learned from past transaction data. A format of output data is a payload of an API request transmitted to a seller side system, and text data of a negotiation result displayed on the user terminal. Specific examples of the output data include presentation data of a desired price “18,000 yen”, and a notification text “As a result of negotiation, a 10% discount has been applied”. The inventory management unit also executes a script for automatically transmitting a purchase request in accordance with a release time of a limited product. With this configuration, the system executes an active action led by a computer to maximize a purchase opportunity of the user beyond static inventory management. This processing brings about an improvement peculiar to computer technology of reacting in milliseconds to a fluctuation in inventory or a fluctuation in price that cannot be constantly monitored by a human, and preventing an opportunity loss. This technology is widely applicable to an automatic algorithmic trading system for stocks, an automatic bidding agent on an auction site, and the like.

### Specific Use Case

For example, when the user uses the online shopping support system and considers purchasing a new spring dress, the user information acquisition unit acquires detailed information such as height 160 cm, weight 52 kg, shoulder width 38 cm, waist 65 cm, hip 90 cm, a face image, a short bob hairstyle, a light skin color, age 35, preference is natural, usage scene is spring outing, and budget is 20,000 yen from the user terminal, and registers it in a user database on the server side. The product information management unit holds 3D model data, a product image (a front, a side, a back, a wearing example, and a material up image), a price, an inventory status, a brand, a category, a size, a color, a material, a product description, a user review, limited model information, and the like regarding the new spring dress in a database. When the user uploads an image of a floral dress seen on SNS to the application, the image recognition unit extracts a color, a shape, a design, a material, a pattern, a silhouette, and details from the image using the generative AI, searches for a plurality of dresses with high similarity by collating with the database of the product information management unit, and presents them to the user. As a specific example of a generative AI prompt sentence at this time, “Extract a color, a shape, a design, a material, a pattern, a silhouette, and details of a dress in an attached image, and list up 10 products closest to these feature amounts from a database” is given. Specifically, the system executes a multimodal data integration pipeline in an onboarding process and an initial data collection phase of the user. The user information acquisition unit asynchronously collects diverse raw data from a sensor group and an input interface of the user terminal. The user information acquisition unit converts input numerical data such as height and weight into an array of floating-point numbers, and performs normalization processing. The user information acquisition unit expands a face image acquired from a camera on a memory as a multidimensional pixel tensor. The user information acquisition unit inputs the face image tensor to a pre-trained convolutional neural network, and generates a high-dimensional visual feature vector extracting features of a face shape, a skin pigment distribution, and a hairstyle. The user information acquisition unit inputs data of a preference and a usage scene input by text to a natural language processing model, and converts it into a semantic embedding vector. The user information acquisition unit combines these vectors of different modalities, constructs a single integrated user profile vector, and stores it in the database. Subsequently, the product information management unit structures and holds data regarding the new spring dress. The product information management unit manages a vertex coordinate array, a texture map, and a physical material parameter of a 3D model. When the user uploads an image seen on SNS, the image recognition unit is activated. The image recognition unit inputs the uploaded image tensor to a feature extraction network. Specific examples of input data include an RGB image tensor with a resolution of 1024 by 1024. The feature extraction network extracts features of a color distribution, an edge gradient, and a texture pattern from the image, and outputs, for example, a 512-dimensional query feature vector. The image recognition unit executes an approximate nearest neighbor search algorithm on a vector database of the product information management unit using this query feature vector. The image recognition unit calculates a cosine similarity between the query vector and each product vector in the database. A format of output data is an array of product IDs sorted in descending order of a similarity score. Specific examples of the output data include a list of a product ID “99887” and a similarity score “0.92”, and a product ID “66554” and a similarity score “0.88”. The image recognition unit transmits this list to the user terminal, and causes it to be rendered as a search result. With this configuration, the system converts an ambiguous visual memory or intuitive preference of the user into an accurate mathematical expression, and instantaneously extracts target data from a huge database. This processing exhibits a technical effect of realizing intuitive information access impossible with a text search, and dramatically improving calculation efficiency and accuracy of a search. This technology is applicable to a visual search system for real estate properties, an image-based inventory inquiry system for automobile parts, and the like.

When the user selects a dress of interest, the virtual fitting provision unit synthesizes the body shape data of the user and the 3D model data of the selected product, generates a 3D avatar dedicated to the user using the generative AI, reproduces a silhouette, a sense of size, a sense of material, wrinkles and drapes according to movement, gloss, and an appearance at the time of layering at the time of wearing the dress in real time, and makes it possible to experience as an AR display on the terminal. As a specific example of a generative AI prompt sentence, “Height 160 cm, weight 52 kg, shoulder width 38 cm, waist 65 cm, hip 90 cm, face image attached, short bob hairstyle, light skin color, generate a realistic 3D avatar based on these pieces of information, and generate a virtual fitting image in a state of wearing a dress of a product ID 12345” is given. Specifically, the virtual fitting provision unit includes a real-time 3D rendering pipeline and a physics simulation engine. The virtual fitting provision unit acquires an integrated user profile vector from the user information acquisition unit. The virtual fitting provision unit deforms vertex coordinates of a parametric human body model using numerical data such as height, weight, and three sizes included in this vector. The virtual fitting provision unit UV-maps texture data extracted from the face image to a head mesh of the human body model. Thereby, the virtual fitting provision unit generates a 3D avatar mesh dedicated to the user accurately imitating the body shape and facial features of the user. The virtual fitting provision unit acquires a 3D clothes mesh and a physical parameter of the dress from the product information management unit based on the product ID of the dress selected by the user. Specific examples of input data include a vertex coordinate array of the 3D avatar of the user, a vertex coordinate array of the 3D clothes mesh of the dress, and numerical data indicating a mass and a friction coefficient of cloth. The virtual fitting provision unit arranges the 3D clothes mesh with respect to the 3D avatar mesh while performing collision detection using the physics simulation engine. The physics simulation engine calculates deformation of cloth, generation of wrinkles, and formation of drapes for each frame according to a gravity vector and movement of joints of the avatar. The virtual fitting provision unit inputs the calculated mesh data to a physics-based rendering engine. The physics-based rendering engine calculates reflection of environmental light, gloss of cloth, and a sheer feeling, and generates a final 2D image tensor. Furthermore, the virtual fitting provision unit removes an artifact of a rendered image using a generative artificial intelligence model, and improves reality. A format of output data is an RGB image tensor and a depth map of each frame. Specific examples of the output data include full high-definition image data with a resolution of 1920 by 1080. The virtual fitting provision unit streaming-transmits the generated image tensor to an augmented reality display module of the user terminal. With this configuration, the system executes strict 3D space calculation based on physical laws in real time, rather than mere synthesis of 2D images. This processing brings about an improvement peculiar to computer technology of providing a fitting experience extremely close to reality to the user, and dramatically reducing a return rate due to size nonconformity in online shopping. This technology is applicable to a cosmetic surgery simulation system, a furniture arrangement simulation based on ergonomics, and the like.

Furthermore, the styling proposal unit combines a cardigan, shoes, a bag, an accessory, and the like matching the dress using the generative AI based on the body shape, the preference, the usage scene, and the trend information of the user, generates a plurality of coordinations considering a body shape correction effect, a balance of a color and a material, and a trend element, and automatically generates and presents an explanatory text such as “why this combination suits”, “what kind of body shape concern can be covered”, “which scene is optimal”, “relevance to a trend”, “tips for mixing and matching”,
“recommended use of small items” and the like. As a specific example of a generative AI prompt sentence, “Height 160 cm, weight 52 kg, shoulder width 38 cm, waist 65 cm, hip 90 cm, preference is natural, usage scene is spring outing, trend of this season is pastel color and linen material, propose 3 patterns of optimal coordination under these conditions, and explain a reason for combination, a body shape correction effect, a recommended scene, relevance to a trend, and tips for mixing and matching for each” is given. Specifically, the styling proposal unit includes a hybrid inference engine integrating a graph-based recommendation algorithm and a natural language generation model. The styling proposal unit loads an attribute vector of the user, a feature vector of the selected dress, and a trend feature vector acquired from the trend analysis unit onto a memory. The styling proposal unit sets these vectors as input nodes of a graph neural network. The graph neural network calculates a weight of an edge with a node of another item (a cardigan, shoes, a bag, or the like) in a product information database. The graph neural network searches for an optimal combination of items by combining a color harmony algorithm based on a color wheel and a heuristic rule for evaluating a balance of a silhouette. Specific examples of input data include a feature vector of a dress, a numerical vector indicating a body shape of the user, and an embedding vector of a usage scene “spring outing”. The graph neural network calculates a fitness score for a plurality of coordination candidates. The styling proposal unit extracts a coordination candidate having a high score. The styling proposal unit constructs a list of product IDs constituting the extracted coordination, a user attribute, and trend information as a prompt tensor of a large language model. The large language model processes the input tensor with a self-attention mechanism, and generates a text logically explaining why the coordination is suitable for the user. A format of output data is a product ID array for each coordination, and a text character string of an explanatory text. Specific examples of the output data include an array of a cardigan ID “445” and a shoes ID “667”, and text data “A pastel color cardigan produces a spring-like feeling, and a V-neck makes a neck area look neat”. The styling proposal unit transmits the generated data to a display control module of the user terminal. With this configuration, the system mathematically optimizes a complex dependency relationship between a plurality of items, not limited to individual product recommendation, and automatically generates harmonized styling as a whole. This processing exhibits a technical effect of algorithmizing a thinking process of a professional stylist, and providing a personalized advanced proposal on a large scale and instantaneously. This technology is applicable to an automatic travel itinerary creation system, an optimization proposal system for an investment portfolio, and the like.

The trend analysis unit analyzes external data such as SNS, fashion magazines, and collections using the generative AI, extracts a color, a pattern, a silhouette, a material, a brand tendency, a dressing technique, a popular item, a notable collaboration, a trend of sustainable fashion, and the like that are popular this season, and reflects them in a styling proposal and a product recommendation function in real time. As a specific example of a generative AI prompt sentence, “Extract a trend color, a trend pattern, a trend silhouette, a popular brand, a notable dressing technique, and a trend of sustainable fashion of this season based on latest data of SNS, fashion magazines, and collections, and present 10 items in a ranking format” is given. Specifically, the trend analysis unit includes a distributed web crawler and a multimodal deep learning model. The trend analysis unit periodically activates the distributed web crawler, and asynchronously collects latest posted data from application programming interfaces of a plurality of social networking services and fashion media. The trend analysis unit inputs the collected text data to a natural language processing pipeline. The natural language processing pipeline executes morphological analysis, named entity extraction, and sentiment analysis, and extracts a trend keyword and a brand name from the text. The trend analysis unit inputs the collected image data to a convolutional neural network for image recognition. The convolutional neural network extracts a color distribution of clothes, a feature of a silhouette, and a texture of a material from the image. Specific examples of input data include an array of 100,000 text character strings posted within the past 24 hours, and a batch of image tensors attached thereto. The trend analysis unit projects the extracted text feature vector and image feature vector to the same latent space, and specifies a set of data points forming a dense cluster. The trend analysis unit calculates a growth rate of the specified cluster using a time series prediction model, and predicts a future trend. The trend analysis unit summarizes the extracted trend data into a text in a ranking format easy for a human to understand using a large language model. A format of output data is structured JSON data including a trend keyword, a related feature vector, and a summary text. Specific examples of the output data include ranking data of 1st place “pastel color” and 2nd place “linen material”, and a text character string “This season, an environmentally friendly sustainable linen material is attracting attention”. The trend analysis unit reflects the generated trend data in the database of the product information management unit, and dynamically updates a weighting parameter of a search algorithm. With this configuration, the system eliminates manual research work accompanied by human subjectivity and delay, and objectively and in real time extracts a market trend from a huge amount of unstructured data. This processing brings about an improvement peculiar to computer technology of keeping recommendation accuracy of the system always in a latest state, and anticipating and responding to a potential need of the user. This technology is widely applicable to an automatic summarization/classification system for news articles, a flaming detection system on social media, and the like.

When a user inputs a question such as “Does this dress suit me?”, “Are there any other recommendations?”, “How should I return an item?”, “What is the trend this season?”, or “Please propose a coordination within the budget”, the interactive assistant unit refers to user information, product information, styling information, trend information, a purchase history, and the like using generative AI, generates a personal answer or advice in real time, and returns it to the user terminal. A specific example of a generative AI prompt sentence is “User information: height 160 cm, weight 52 kg, shoulder width 38 cm, waist 65 cm, hip 90 cm, preference is natural, past purchase history exists, question: Does this dress suit me? In response to this, generate personal advice considering a body shape, a preference, a past purchase history, and a trend this season.” Specifically, the interactive assistant unit includes a real-time inference pipeline based on a retrieval-augmented generation architecture. The interactive assistant unit receives a text string of the question input from the user terminal. The interactive assistant unit divides the input text into a token sequence by a tokenizer, and converts it into a high-dimensional query vector using a query encoder. The interactive assistant unit executes a vector similarity search on a user information database, a product information database, and a past interaction history database using this query vector. The interactive assistant unit acquires a text chunk of related information obtained as a search result. Specific examples of input data include a text string of the question “Does this dress suit me?”, an attribute vector indicating the height and preference of the user, and a feature vector of a target product. The interactive assistant unit combines the acquired related information and the original question text to construct an input tensor of a large language model. The large language model is a transformer network having billions of parameters, and calculates a contextual dependency between each token in the input tensor using a self-attention mechanism. The large language model autoregressively generates an optimal answer to the question while satisfying constraint conditions such as the body shape and the past purchase history of the user. A format of output data is structured data including a generated natural language text string and a trigger of a related product ID or action button. Specific examples of the output data include text data “This V-neck dress suits your straight skeleton body shape very well. It also goes well with the black cardigan you purchased in the past”, and a product ID of the cardigan. The interactive assistant unit transmits the generated answer data to a display control module of the user terminal, and causes it to be rendered on a chat interface. With this configuration, the system generates a dynamic and logical response deeply understanding an individual context of the user, rather than a fixed phrase reply by simple keyword matching. This processing exhibits a technical effect of substituting manual customer service by a human operator and providing a personalized answer with a delay in milliseconds even for simultaneous access on a scale of thousands of people. This technology is applicable to an automatic financial advisory system in online banking, a technical support bot for software, and the like.

The purchase support unit collates the budget information of the user with a product price and the inventory status, preferentially displays only a product purchasable within a budget, manages input assistance for a delivery destination and a payment method, tracking of a delivery status, automation of a return/exchange procedure, and the like in a purchase procedure, and notifies the user terminal of a progress status and a necessary action. A specific example of a generative AI prompt sentence is “Based on a user budget of 20,000 yen, a product list and prices, and an inventory status, list products purchasable within the budget, and generate a guidance sentence for a flow of a purchase procedure, a delivery status, and a return/exchange procedure.” Specifically, the purchase support unit includes a transaction management engine based on a state machine and a rule-based automation script. The purchase support unit receives an ID list of products desired to be purchased and numerical data indicating a budget upper limit value of the user transmitted from the user terminal. The purchase support unit accesses the database of the product information management unit, and acquires latest price data and an inventory flag of each product. The purchase support unit calculates a total value of the acquired price data, and compares it with the budget upper limit value. The purchase support unit starts a workflow of the purchase procedure when the total value falls within the budget. Specific examples of input data include an integer value indicating a budget of 20,000 yen, numerical data indicating a price of 15,000 yen for a product ID “12345”, and a Boolean value indicating that there is an inventory. The purchase support unit automatically complements a token of a delivery destination address or credit card information from a past input history of the user, and sets it as an initial value of an input form. When the user confirms the purchase, the purchase support unit calls an application programming interface of a payment gateway, and transmits an encrypted payment request. After the payment is completed, the purchase support unit cooperates with an external interface of a logistics management system, and starts tracking of a delivery status. The purchase support unit asynchronously receives a status update event such as “shipped” or “out for delivery” from the logistics system. The purchase support unit activates a push notification generation module every time the event is received. A format of output data is JSON data of a notification payload transmitted to the user terminal. Specific examples of the output data include text data including a title “shipping completed”, a body text “the dress you ordered has been shipped”, and a tracking URL of a delivery company. When receiving a return request, the purchase support unit analyzes a reason for return using the large language model, and automatically generates a text guiding a return address and a necessary procedure. With this configuration, the system completely automates a series of processes from product selection to payment, delivery tracking, and after-sales support, and minimizes an operation burden on the user. This processing brings about an improvement peculiar to computer technology in that asynchronous communication with a plurality of external systems is reliably performed, and a processing delay is minimized while guaranteeing data consistency. This technology is applicable to an automatic reservation/ticketing system for event tickets, an automatic management system for a subscription service, and the like.

The inventory management unit stores the preference and purchase tendency of the user, automatically detects a product with low inventory, a new product, a limited product, and the like, and notifies the user terminal. For example, when a dress that the user has browsed many times in the past has only one item left, an alert of “low inventory” is displayed. Furthermore, price negotiation and purchase agency for a limited product can be executed using the generative AI, and when the user requests “I want to buy this product a little cheaper”, the AI can automatically negotiate with a sales side and draw out a discount or a privilege. A specific example of a generative AI prompt sentence is “Based on a product list browsed by a user in the past and an inventory status, extract a product with low inventory, a new product, and a limited product, and generate an alert sentence or a purchase recommendation sentence for notifying the user. Also, generate a negotiation sentence for price negotiation or purchase agency.” Specifically, the inventory management unit includes a time-series prediction algorithm and a reinforcement learning-based autonomous negotiation agent. The inventory management unit acquires time-series data indicating the number of browses or a cart addition history for a specific product from an action log database of the user. The inventory management unit acquires data indicating a current inventory quantity and a past sales speed of the product from the product information management unit. The inventory management unit inputs these data to a long short-term memory neural network, and calculates a predicted time until a target product is sold out. The inventory management unit fires an event trigger of a low inventory alert when the predicted time falls below a certain threshold value and an interest level score of the user is high. Specific examples of input data include log data indicating that the user has browsed a page of a dress five times in the past week, and an integer value indicating that a current inventory quantity is one. The inventory management unit activates a notification generation module in response to the event trigger, and transmits an alert text to the user terminal. Furthermore, when receiving a request for price negotiation from the user, the inventory management unit activates the autonomous negotiation agent. The autonomous negotiation agent uses a Q-learning algorithm based on a Markov decision process. An input state vector to the autonomous negotiation agent includes a desired price of the user, a cost rate of the product, a current inventory quantity, and a past discount tolerance of the sales side. The autonomous negotiation agent outputs a vector of an optimal negotiation price and a negotiation text to be presented to an automatic response system of the sales side. A format of output data is a payload of an API request transmitted to a sales side system, and text data of a negotiation result displayed on the user terminal. Specific examples of the output data include presentation data of a desired price “18,000 yen”, and a notification text “As a result of negotiation, a 5% discount has been applied”. The inventory management unit also executes a script that automatically transmits a purchase request in accordance with a release time of a limited product. With this configuration, the system goes beyond static inventory management and executes an active action led by a computer to maximize a purchase opportunity of the user. This processing exhibits a technical effect of reacting in milliseconds to a fluctuation in inventory or a fluctuation in price that cannot be constantly monitored by a human, and preventing an opportunity loss. This technology is widely applicable to an automatic price negotiation system for real estate, an automatic bidding agent in a flea market application, and the like.

In this way, it is possible to provide a specific use case that consistently realizes optimal product selection comprehensively considering various conditions such as a body shape, a preference, a usage scene, a trend, a budget, and an inventory status, virtual fitting, a coordination proposal, purchase support, inventory management, and consultation by a personal assistant using generative AI while the user is at home. Specifically, the system integrally controls a plurality of machine learning models operating on a distributed computing environment. The system processes a multidimensional feature amount vector input from the user terminal in real time. The system connects a natural language processing model and an image generation model as a pipeline. The system tokenizes an input text of the user. The system converts the tokenized data into a 512-dimensional embedding vector. The system inputs the embedding vector to a large language model. The large language model analyzes a context using a self-attention mechanism. The large language model outputs a probability distribution score indicating an intention of the user. The system extracts an intention label whose probability distribution score exceeds a predetermined threshold value. The system activates a subsequent image generation module based on the extracted intention label. The image generation module adopts a latent diffusion model. The image generation module receives the intention label and a body shape tensor of the user as conditioning. The image generation module gradually removes noise from a noise space. The image generation module finally outputs an RGB image tensor of 1024 pixels square. The system renders the generated image tensor on a display of the user terminal. The system executes these processes in milliseconds. The system completes a series of processes without intervention of a human operator. The system significantly improves a processing speed compared to a conventional rule-based search system. The system extracts a potential preference of the user with high accuracy by a non-linear operation in a high-dimensional space. The system thereby dramatically improves accuracy of product recommendation. The system is applied to a use case such as an e-commerce platform or apparel sales in a virtual reality space. The system brings about a technical effect of fundamentally improving a purchase experience of the user.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

As an embodiment for carrying out the present invention, a virtual store system includes extremely diverse functional modules such as a user avatar generation unit, a virtual store space generation unit, a product information management unit, a virtual fitting provision unit, an interactive virtual staff unit, a user interaction support unit, a purchase support unit, a trend analysis unit, a coordination proposal unit, an inventory management unit, and a prompt generation unit, and these are realized by cooperation between a server and a user terminal. Specifically, the virtual store system is constructed on a cloud computing environment. The system uses a parallel processing cluster composed of a plurality of computing nodes. The system implements each functional module as a microservice architecture. The system uses an asynchronous messaging queue for communication between the respective modules. The system establishes a secure WebSocket connection for communication between the user terminal and the server. The system receives sensor data and an input text transmitted from the user terminal in real time. The system transfers the received data to a preprocessing module. The preprocessing module executes missing value complementation and normalization of the data. The system distributes the normalized data to each functional module. The system drives a convolutional neural network in the user avatar generation unit. The system executes a generative adversarial network in the virtual store space generation unit. The system uses a transformer-based large language model in the interactive virtual staff unit. The system simultaneously executes these plurality of machine learning models in parallel. The system makes a weight parameter of each model resident on a memory of a graphics processing unit. The system minimizes latency during inference. The system asynchronously writes an output result of each module to an integrated database. The system adopts a distributed in-memory data store as the integrated database. The system improves a data read/write speed. The system significantly improves scalability compared to a conventional monolithic system architecture. The system maintains stable response performance even against a rapid increase in traffic. The system is applied to a use case such as a large-scale metaverse space or an online shopping mall. The system exhibits a technical effect of improving efficiency of complex data processing and improving processing capability of the entire system.

The user avatar generation unit automatically generates a highly accurate 3D avatar individually optimized for each user using generative AI based on information such as body shape data (height, weight, three sizes, shoulder width, waist, hip, thigh, calf, arm length, neck circumference, and foot size), a face image, a skin color, a hairstyle, an age, a gender, a fashion preference (casual, formal, street, natural, mode, elegant, sporty, or the like), a makeup tendency, an accessory preference, a posture, a walking style, and a facial expression pattern acquired from the user terminal. For example, when the user takes whole body photographs and face photographs from a plurality of angles using a camera of a smartphone and uploads them to an application, the generative AI generates a 3D avatar realistically reflecting a skeleton, subtle unevenness of a body shape, a posture, facial features, a skin color, a hairstyle, a facial expression, and even a walking style. Furthermore, a fashion taste, an accessory, and a makeup tendency selected by the user in the past can also be reflected in the avatar, and for example, for a user who usually prefers large earrings or glasses, they can be equipped as standard on the avatar. In addition, a body shape change, a hairstyle change, a makeup change, and the like of the user can be reflected at any time, and for example, a body shape change due to a diet or muscle training, a hair color change, a seasonal makeup change, and the like can be immediately reflected in the avatar. Specifically, the user avatar generation unit estimates a three-dimensional vertex coordinate group from an input two-dimensional image group. The generation unit receives three RGB image tensors as input data. Each image tensor is 3-channel data with a resolution of 1080×1920. The generation unit inputs the image tensor to a convolutional neural network. The neural network extracts a two-dimensional joint keypoint from the image. The generation unit inputs the extracted two-dimensional keypoint to a graph convolutional network. The graph convolutional network infers a three-dimensional skeleton vector from two-dimensional coordinates. The generation unit uses the inferred three-dimensional skeleton vector as an input parameter of a parametric human body model. The generation unit outputs three-dimensional mesh data having 6890 vertices using the parametric human body model. The generation unit executes texture mapping on the output three-dimensional mesh data. The generation unit inputs a feature vector of a skin color or a hairstyle extracted from the face image to a texture generation model. The texture generation model adopts a U-Net architecture. The texture generation model outputs a high-resolution UV map image. The generation unit applies the UV map image to the three-dimensional mesh. The generation unit receives a preference and past history data of the user as a natural language text. The generation unit processes the text data with a language model and generates a 512-dimensional style vector. The generation unit searches for a 3D model of an accessory from a database based on the style vector. The generation unit couples the searched accessory model to a specific vertex coordinate of the avatar. The generation unit constructs a 3D avatar unique to the user by these processes. The generation unit transfers the constructed avatar data to the subsequent virtual fitting provision unit. The generation unit completely eliminates modeling by human manual work. The generation unit shortens a processing time of avatar generation to within a few seconds. The generation unit generates an avatar extremely close to a real user by feature extraction in a high-dimensional space. The generation unit is applied to a use case such as virtual fitting or character creation in an online game. The generation unit brings about a technical effect of improving reproduction accuracy of the avatar and enhancing an immersive feeling of the user.

The virtual store space generation unit constructs a virtual space by personalizing a store layout, an atmosphere, a display, a decoration, lighting, BGM, a sales floor configuration, a pop-up event, a limited corner, zoning for each brand, flow line design, simulation of a congestion status, and the like for each user using generative AI based on a preference, a past purchase tendency, current trend information, a season, a time zone, event information, a psychological state of the user, weather information, and the like. For example, a space based on a wood grain tone or green for a user who likes a natural taste, a monotone or metallic space for a user who likes a mode style, a layout emphasizing bright lighting and a flow line for a sporty-oriented user, and a special corner for cherry blossoms, autumn leaves, Christmas decorations, Valentine's Day, or Halloween during a seasonal event are automatically generated. Furthermore, the entire space is individually optimized, such as arranging a frequently used brand or category near an entrance from a purchase history of the user, and displaying a product that the user is likely to be interested in at a conspicuous place. For example, when the user prefers an outdoor brand, an outdoor corner can be expanded, and a special exhibition of camping equipment or sportswear can be provided. In addition, reflecting the psychological state or weather information of the user, for example, it is also possible to automatically select bright lighting or energetic BGM on a rainy day, or calm lighting or healing music when wanting to relax. Specifically, the virtual store space generation unit receives a plurality of environmental variables as input. The generation unit acquires the purchase history of the user as a time-series item ID array. The generation unit encodes the weather information or the time zone as a numerical vector. The generation unit combines these input data and generates a 1024-dimensional context vector. The generation unit inputs the context vector to a generator of a conditional generative adversarial network. The generator outputs voxel data of a three-dimensional space. The voxel data includes a label indicating a type or a material of an object at each coordinate. The generation unit analyzes the output voxel data and generates a layout map of the store. The generation unit arranges a 3D model of each product in the space based on the layout map. The generation unit optimizes a light source position or a color temperature of lighting using a reinforcement learning agent. The reinforcement learning agent is learned using a stay time of the user as a reward. The generation unit dynamically synthesizes audio waveform data of BGM using an audio generation model. The audio generation model receives the context vector as a condition and outputs a 44.1 kHz stereo audio tensor. The generation unit transmits the generated three-dimensional space data and audio data to a rendering engine. The rendering engine generates an image in real time based on viewpoint information of the user terminal. The generation unit executes dynamic loading of the space in accordance with movement of the user. The generation unit realizes an unconventional information presentation method different from product presentation by a conventional fixed web page. The generation unit constructs a completely different three-dimensional space for each user in real time. The generation unit improves a purchase motivation of the user by the personalized space. The generation unit is applied to a use case such as a virtual store or a digital showroom on a metaverse. The generation unit exhibits a technical effect of improving a user experience while reducing an operation cost by automation of space generation.

The product information management unit centrally manages 3D model data, a product image (a front, a side, a back, a wearing example, and a material up image), a price, an inventory status, a brand, a category, a size, a color, a material, a product description, a user review, limited model information, a restock schedule, discount information, a sales start date, a sales end date, pre-order sales information, sustainable certification information, collaboration information, ranking information, and the like regarding a plurality of products on the server side. For example, a plurality of variations such as a different color, a different size, a limited collaboration model, a pre-sale model, and a pre-order product are recorded in detail even for the same product, and optimal information is immediately provided in response to a user request. The product image also holds a multidimensional viewpoint, a wearing example, an enlarged image for conveying a sense of material, a video, a 360-degree view, a marker image for AR, and the like, and the 3D model data is managed with high accuracy up to reproduction of wrinkles and drapes at the time of wearing, gloss, an appearance at the time of layering, deformation according to movement, reflection and transmission for each material, and friction and expansion/contraction. For example, a feature and a wearing feeling for each material such as a linen dress, a leather bag, a wool coat, water-repellent outerwear, and stretch pants are recorded in detail, and can be immediately presented when the user picks up the product. Specifically, the product information management unit is configured by combining a distributed relational database and a non-relational database. The management unit stores text data and numerical data as structured data. The management unit stores 3D model data and image data in an object storage. The management unit assigns a multidimensional attribute vector to each product data. The management unit extracts a feature word from a product description and a user review using a natural language processing model. The management unit weights the extracted feature word by a TF-IDF algorithm. The management unit converts the weighted feature word into a 256-dimensional text embedding vector. The management unit extracts a 512-dimensional image feature vector from the product image using a convolutional neural network. The management unit combines the text embedding vector and the image feature vector to generate an integrated feature vector. The management unit indexes the integrated feature vector in a vector database. The management unit receives a search query from the user. The management unit similarly vectorizes the search query. The management unit calculates a cosine similarity between the query vector and the integrated feature vector in the database. The management unit outputs a product ID list having a high similarity score. The management unit passes the output product ID list to a subsequent display module. The management unit holds rigidity, mass, and a friction coefficient as a numerical tensor as physical parameters of the 3D model. The management unit provides these physical parameters to a physics calculation engine. The management unit overcomes a limitation of a conventional search method by keyword matching. The management unit enables a semantic search by similarity calculation in a high-dimensional vector space. The management unit is applied to a use case such as a large-scale e-commerce site or an inventory management system. The management unit brings about a technical effect of dramatically improving accuracy and speed of data search.

The virtual fitting provision unit synthesizes the user avatar and the product 3D model data, and generates a virtual fitting image or video in a state in which the avatar wears the product in real time using generative AI. For example, when a dress is selected, a state in which the avatar wears the dress can be confirmed by rotating 360 degrees, and furthermore, a plurality of items (tops, bottoms, outerwear, an accessory, shoes, or the like) can be simultaneously worn, and a balance of the entire coordination, a combination of a color and a material, a body shape correction effect, a trend element, and the like can be compared and displayed in real time. The user can confirm the coordination from multiple angles through operations such as enlargement/reduction, viewpoint change, pose change, walking animation, sitting posture, jump, and rotation. For example, if the user specifies “I want to simultaneously try on a pastel color dress, a cardigan, and white sneakers for a spring outing”, the generative AI causes the avatar to wear them, and presents even a whole body balance and a mixing and matching example. In addition, a detailed dressing arrangement such as “a state in which sleeves of this jacket are rolled up”, “a state in which a belt is added to this dress”, or “a state in which hems of these pants are rolled up” by the user can also be reflected in real time. Furthermore, it is also possible for the user to share his/her own avatar on SNS or with a friend, or save a wearing image for comparative examination. Specifically, the virtual fitting provision unit adopts a hybrid architecture integrating physics-based cloth simulation and neural rendering. The provision unit receives three-dimensional mesh data of the user avatar and three-dimensional clothing mesh data of the product as input. The provision unit acquires skeleton motion data of the avatar as a time-series quaternion array. The provision unit applies a physics calculation based on a mass-spring model to each vertex of the clothing mesh. The provision unit defines parameters of gravity, wind force, and collision determination as a tensor. The provision unit calculates a collision response for preventing penetration between a front surface of the avatar and a back surface of the clothing. The provision unit updates a vertex coordinate of the clothing mesh deformed by the physics calculation. The provision unit inputs the updated mesh data to a neural rendering network. The neural rendering network is composed of a multilayer perceptron. The neural rendering network receives a line-of-sight direction vector and a light source vector as conditions. The neural rendering network outputs an RGB value and an alpha value of each pixel. The provision unit synthesizes the output pixel values and generates a high-resolution two-dimensional image tensor. The provision unit transfers the generated image tensor to a screen buffer of the user terminal. The provision unit receives an instruction for a dressing arrangement from the user as a natural language text. The provision unit analyzes the text and generates a deformation vector for a specific vertex group of the clothing mesh. The provision unit applies the deformation vector as an initial condition of the physics calculation. The provision unit executes these processes at a speed of 60 frames per second. The provision unit guarantees high physical consistency different from conventional simple image synthesis. The provision unit is applied to a use case such as an online apparel shop or a digital fashion show. The provision unit exhibits a technical effect of enhancing reality of fitting to the utmost limit and strongly supporting a purchase decision of the user.

The interactive virtual staff unit returns personal advice, a product proposal, tips for size selection, return/exchange guidance, a coordination example, a reason for combination, a body shape correction effect, relevance to a trend, tips for mixing and matching, a feature for each brand, a handling method of a material, advice on washing and maintenance, a gift proposal, event information, lottery guidance for a limited product, and the like in real time to a question or request by voice or text from the user using generative AI while referring to user information, product information, styling information, trend information, a purchase history, an inventory status, a usage scene, a budget, a return/exchange history, a tendency of size selection, a worry about dressing, a past consultation history, and the like. For example, in response to various questions and requests such as “Does this jacket suit me?”, “Which bag matches this coordination?”, “What is the trend this season?”, “How is the sense of size of this brand?”, “Please tell me recommended products within the budget”, “I want to cover my upper arms”, “I want to choose a color that makes my complexion look bright”, “What are tips for size selection of an overseas brand?”, “What kind of scene is this product suitable for?”, “What is an item that can cover my body shape?”, “I want to return an item”, “I want to exchange a size”, “Is gift wrapping possible?”, and “I want to participate in a lottery for a limited product”, a body shape, a preference, a past purchase history, a current trend, an inventory status, a usage scene, a budget, a return/exchange history, a feature for each brand, and the like are comprehensively analyzed, and a personalized answer up to an optimal product or coordination, a point of dressing, a procedure method for return/exchange, a gift proposal, event information, and lottery guidance for a limited product is immediately generated. For example, if the user inputs a worry such as “I want to cover my upper arms” or “I want to choose a color that makes my complexion look bright”, an item or dressing advice corresponding thereto is returned. Specifically, the interactive virtual staff unit functions as a dialogue system having a large language model as a core. The staff unit converts a voice input from the user into a text string by a voice recognition module. The staff unit converts the text string into an integer token ID array by a tokenizer. The staff unit acquires profile data and a past interaction history of the user in a structured JSON format. The staff unit converts the structured data into a natural language prompt sentence and couples it to the token ID array. The staff unit inputs the coupled token sequence to a transformer-based neural network. The neural network is a pre-trained model having billions of parameters. The neural network calculates a dependency between input tokens using a self-attention mechanism. The neural network outputs a probability distribution of a token appearing next as a vector. The staff unit selects a token having the highest probability from the probability distribution and sequentially generates a response text. The staff unit analyzes whether a specific product ID or action tag is included in the generated response text. The staff unit automatically calls a subsequent system API when detecting the action tag. For example, the staff unit executes an inventory confirmation API or a cart addition API. The staff unit inputs the generated response text to a voice synthesis module and outputs audio waveform data. The staff unit transmits the audio waveform data and the text data to the user terminal. The staff unit completely substitutes customer support by a human operator. The staff unit realizes an advanced dialogue deeply understanding a context by improvement of natural language processing technology. The staff unit is applied to a use case such as online customer service or an automatic help desk. The staff unit brings about a technical effect of dramatically reducing an operation cost while equalizing quality of customer service.

The user interaction support unit provides various interaction functions such as a chat or voice call between user avatars, an exchange of opinions on coordination, a joint shopping experience, SNS linkage, group purchase, browsing of a ranking of popular coordinations, event participation, joint lottery for limited products, friend invitation, real-time voting, a questionnaire, review posting, a coordination contest, and a virtual fashion show. For example, friends enter the same virtual store, select a product together while exchanging opinions by chat or voice call, show coordinations to each other, consult with a staff member among three parties, share dressing with other users by SNS linkage, browse a ranking of popular coordinations, receive a discount by group purchase, participate in a limited event, apply for a coordination contest, participate in a virtual fashion show, and the like, thereby realizing a communication experience close to real shopping. Furthermore, consultations between users such as “What do you think of this coordination?” and “Does this color suit me?”, a discount by group purchase, participation in a limited event, and the like are also possible. Specifically, the user interaction support unit functions as a real-time multiplayer synchronization server. The support unit receives position coordinates and posture quaternion data of an avatar transmitted from each user terminal at a frequency of several tens of times per second. The support unit multicast-distributes the received state data to all other clients participating in the same virtual space session. The support unit transfers voice call data peer-to-peer using a WebRTC protocol. The support unit inputs text chat data between users to a natural language processing model. The support unit calculates an emotion polarity score as a floating-point number from −1.0 to 1.0 from the text data. The support unit dynamically changes a blend shape coefficient of facial expression animation of the avatar based on the emotion polarity score. The support unit registers coordination data shared by the user as a node in a graph database. The support unit records an action of “like” or a comment between users as an edge. The support unit calculates a centrality score between nodes using a graph convolutional network. The support unit extracts a coordination with a high centrality score as a ranking list. The support unit distributes the extracted ranking list as a JSON array to each terminal. The support unit automatically executes condition determination for group purchase using a state transition machine such as a smart contract. The support unit sets a discount application flag to true when the number of participants exceeds a threshold. The support unit evolves conventional unidirectional web browsing into a bidirectional synchronous experience. The support unit is applied to use cases such as social commerce and an online community event. The support unit exhibits a technical effect of activating interaction between users and dramatically increasing engagement of a platform.

The purchase support unit automatically manages a budget, an inventory, delivery destination information, a payment method, a delivery status, a return/exchange history, a restock notification, a lottery application for a limited product, gift wrapping, delivery date and time designation, point usage, coupon application, management of a purchase history, and the like of the user using the generative AI, and seamlessly supports a purchase procedure, tracking of a delivery status, automation of a return/exchange procedure, a restock notification, a lottery application for a limited product, gift wrapping, delivery date and time designation, point usage, coupon application, management of a purchase history, and the like. For example, when the user puts a plurality of products in a cart, the generative AI proposes an optimal combination within a budget, automatically confirms an inventory status, and input assistance for a delivery destination and a payment method, real-time notification of a delivery status, procedure guidance for return and size exchange, a restock notification, a lottery application for a limited product, gift wrapping, delivery date and time designation, point usage, coupon application, management of a purchase history, and the like are also automated. For example, when a request such as “I want to buy this product a little cheaper” is made, the generative AI can automatically negotiate a price with a sales side and draw out a discount or a privilege. Specifically, the purchase support unit includes a payment optimization engine integrating transaction processing and a reinforcement learning agent. The support unit acquires a product list in the cart of the user as an array of item IDs. The support unit receives a budget upper limit value of the user as a scalar value. The support unit extracts a price, a discount rate, and a point return rate of each product as a feature amount vector. The support unit inputs these data to a combinatorial optimization algorithm. The support unit calculates a product subset that maximizes a utility function of the user while satisfying a budget constraint by applying a solution of a knapsack problem. The support unit outputs the calculated product subset as a proposal list. The support unit receives a request for price negotiation as a natural language text. The support unit inputs the text to an intent classification model and determines a hard-line degree of negotiation as a score from 0 to 1. The support unit activates the reinforcement learning agent and calculates a discount rate that maximizes a reward function using a profit margin of the sales side and a purchase probability of the user as parameters. The support unit generates new price data to which the calculated discount rate is applied. The support unit executes encrypted API communication with an external payment gateway in payment processing. The support unit receives tracking data of a delivery status in real time via a webhook of a logistics system. The support unit converts the received status code into a natural language message for the user. The support unit transmits the converted message to the terminal as a push notification. The support unit instantaneously executes complex conditional branching and optimization calculation without human intervention. The support unit is applied to use cases such as dynamic pricing and an automatic payment system. The support unit brings about a technical effect of reducing a cart abandonment rate and maximizing a conversion rate.

The trend analysis unit analyzes diverse external and internal data such as SNS, fashion magazines, collections, street snaps, influencer posts, search trends of search engines, brand official websites, purchase data of users, reviews, questionnaire results, event information, seasonal factors, and regional factors using the generative AI, extracts a color, a pattern, a silhouette, a material, a brand tendency, a dressing technique, a popular item, a notable collaboration, a trend of sustainable fashion, a popularity trend of a limited product, an excitement degree of an event, a fashion trend for each region, a trend by age, a trend by gender, a topic on SNS, and the like that are popular this season, and reflects them in real time in a styling proposal, a product recommendation, store space generation, event planning, a promotion measure, inventory management, a price strategy, and the like. For example, specific trend keywords and dressing examples such as “green items are popular this season”, “oversized shirts are popular”, “linen dresses are attracting attention”, “limited collaborations of overseas brands are a hot topic”, “items made of sustainable materials are attracting attention”, “pastel colors are popular among women in their 20s”, and “sports mix is popular in the Kanto region” are customized and presented for each user. Specifically, the trend analysis unit is a data mining system combining large-scale data scraping and a multimodal learning model. The analysis unit collects millions of pieces of text data and image data every day using an external API or a web crawler. The analysis unit inputs the collected image data to a visual transformer model. The visual transformer model divides the image into patches and extracts features of each patch. The analysis unit calculates a histogram of hue, saturation, and lightness of clothes from the image. The analysis unit extracts an outline of a silhouette from the image by an edge detection algorithm and converts it into a shape vector. The analysis unit inputs the text data to a pre-trained language model and executes named entity extraction. The analysis unit maps extracted entities such as a brand name, a material name, and a style name to a knowledge graph. The analysis unit projects an image feature vector and a text feature vector into the same latent space and calculates a cross-modal similarity. The analysis unit applies a recurrent neural network to time-series data. The analysis unit predicts a future trend score from past data transition. The analysis unit extracts a keyword group whose predicted trend score exceeds a predetermined threshold as a trend tag. The analysis unit links the extracted trend tag to a product database as attribute data. The analysis unit transmits a list of trend tags to a subsequent styling proposal unit or inventory management unit in a JSON format. The analysis unit eliminates subjective analysis by a human analyst and generates a data-driven objective index. The analysis unit extracts a meaningful pattern from a huge amount of unstructured data at high speed. The analysis unit is applied to use cases such as a demand forecasting system and marketing automation. The analysis unit exhibits a technical effect of immediately responding to a market change and contributing to optimization of an inventory and maximization of sales.

The styling proposal unit generates a plurality of optimal coordination examples using the generative AI based on a body shape, facial features, a preference, a season, a usage scene, trend information, a past purchase history, an inventory status, a budget, a dressing worry, a brand characteristic, a material characteristic, event information, limited product information, and the like of the user, and automatically generates and presents an explanatory text such as “reason why this combination suits”, “what kind of body shape worry can be covered”, “which scene is optimal”, “relevance to a trend”, “tips for mixing and matching”, “recommended use of accessories”, “characteristic of each brand”, “handling method of material”, “dressing point at event”, and “utilization method of limited product” for each coordination example. For example, when the user designates a usage scene such as “spring outing”, “for work”, “casual during child-rearing”, “party”, “travel”, “sports watching”, and “ceremonial occasion”, the generative AI combines tops, bottoms, outerwear, an accessory, shoes, a bag, a hat, a stole, a belt, and the like from the database of the product information management unit, and proposes a coordination considering a body shape correction effect, a balance of color and material, a trend element, a brand characteristic, a material characteristic, event information, limited product information, and the like. Specifically, the styling proposal unit functions as a recommendation engine linking a graph neural network and a text generation model. The proposal unit encodes attribute data of the user and the designated usage scene as a condition vector. The proposal unit constructs a huge graph structure having the product database as a node and compatibility between products as an edge on a memory. The proposal unit inputs the condition vector as an initial state of the graph neural network. The graph neural network executes a message passing algorithm and updates an activation score of each node. The proposal unit extracts a node group having a high activation score and generates a coordination set composed of a plurality of items. The proposal unit embeds an item ID group of the generated coordination set into a prompt of a large language model. The proposal unit simultaneously includes the body shape data of the user and the trend tag in the prompt. The large language model analyzes these input conditions and generates an explanatory text of the coordination in a natural language. The large language model outputs a logical basis for body shape cover and a rule of color harmony as a text. The proposal unit combines the generated explanatory text and an image URL of the coordination set to generate structured response data. The proposal unit transmits the response data to the user terminal and causes it to be rendered on a screen. The proposal unit receives feedback from the user as a reward signal and dynamically updates an edge weight of the graph by reinforcement learning. The proposal unit realizes advanced context-dependent recommendation that is impossible with conventional rule-based combination generation. The proposal unit is applied to use cases such as a personal styling service and a recommendation function of apparel e-commerce. The proposal unit brings about a technical effect of uncovering a potential need of the user and significantly improving a probability of cross-selling.

The inventory management unit automatically detects a product with low inventory, a new product, a limited product, a popular product, a restocked product, a discounted product, an event-linked product, a region-limited product, a collaboration product, and the like based on a preference, a purchase tendency, a browsing history, a product in a cart, a wish list, a restock notification setting, a limited product lottery application status, an event participation history, an inventory status for each region, a sales trend, trend information, a price fluctuation, a promotion measure, and the like of the user, and notifies the user terminal. For example, when a product that the user has browsed many times in the past has only one item left, an alert of “low inventory” is immediately displayed. Furthermore, price negotiation and purchase agency for a limited product can also be executed using the generative AI, and when the user requests “I want to buy this product a little cheaper”, the AI can automatically negotiate with the sales side and draw out a discount or a privilege. Lottery sales and advance reservation of a limited product, a restock notification, event-linked sales, region-limited sales, a priority purchase right for a collaboration product, and the like are also automatically managed, and the user is supported so as to obtain a desired product without missing it. Specifically, the inventory management unit is an autonomous system combining a time-series prediction model and an event-driven architecture. The management unit executes a sensor daemon that monitors the inventory quantity of each product in real time. The management unit aggregates a browsing history and a cart addition history of the user by a stream data processing engine. The management unit inputs the aggregated action log and the current inventory quantity to a long short-term memory network. The long short-term memory network predicts a future depletion probability of each product as a floating-point number from a past time-series pattern. The management unit pushes an ID of a target product to an alert queue when the depletion probability exceeds a set threshold. The management unit extracts the product ID from the alert queue and transmits a push notification payload to a terminal of a user who has registered the corresponding product in a wish list. The management unit initializes a multi-agent reinforcement learning environment when receiving a request for price negotiation. The management unit causes an agent on the user side and an agent on the sales side to interact in a virtual space. The management unit calculates a Pareto optimal price point at which utility functions of both agents are balanced. The management unit writes the calculated price in a special price field of the database. The management unit executes logic of lottery sales using a cryptographically secure pseudorandom number generator to ensure fairness. The management unit automatically generates an ID list of winners and hands it over to a subsequent payment module. The management unit completely eliminates manual inventory confirmation and price setting work by a human administrator. The management unit is applied to use cases such as supply chain management and a dynamic pricing system. The management unit exhibits a technical effect of reducing a risk of excess inventory while minimizing opportunity loss.

The prompt generation unit automatically generates a prompt sentence to the generative AI necessary for processing of each unit based on diverse parameters such as user information, product information, trend information, a usage scene, a past history, an inventory status, event information, limited product information, brand information, material information, regional information, weather information, and a psychological state, and realizes optimal information generation, proposal, support, and management. For example, it automatically generates extremely diverse and individualized prompt sentences such as “Height 160 cm, weight 52 kg, shoulder width 38 cm, waist 65 cm, hip 90 cm, face image attached, hairstyle short bob, skin color bright, preference natural, budget 20,000 yen, usage scene spring outing. Propose three optimal dresses under these conditions, and explain each coordination example, reason for combination, body shape correction effect, relevance to a trend, and tips for mixing and matching.” and “Cause an avatar to wear a jacket of an attached image, and generate a virtual fitting image realistically reproducing a silhouette, a sense of size, a sense of material, wrinkles and drapes according to movement, gloss, and an appearance at the time of layering at the time of wearing.” Specifically, the prompt generation unit is a text synthesis module including a template engine and a dynamic variable binding mechanism. The generation unit asynchronously receives state data from each module in the system. The generation unit expands the received state data on a memory as a dictionary object composed of a key-value pair. The generation unit selects an optimal prompt template according to a model specification of a target generative AI from a database. The generation unit maps a value of the dictionary object to a placeholder in the template. The generation unit executes a formatter that converts numerical data or category data into a natural language description. The generation unit converts numerical values of height and weight into a character string, for example, and combines it with a prompt character string. When image data exists, the generation unit Base64-encodes an image and constructs a JSON payload conforming to an input format of a multimodal AI together with a text prompt. The generation unit transmits the constructed payload as an HTTP request to an inference API of the target AI model. The generation unit monitors a response from the AI model, and when an error occurs, executes a fallback process of finely adjusting a parameter of the prompt and retrying. The generation unit completely automates a process of prompt engineering. The generation unit eliminates time and effort and notation fluctuation when a human manually inputs a prompt. The generation unit is applied to use cases such as an autonomous AI agent system and an automatic content generation pipeline. The generation unit brings about a technical effect of maximizing output accuracy of the AI model and improving operation stability of the entire system.

As described above, in the embodiment of the present invention, each unit such as user avatar generation, virtual store space generation, product information management, virtual fitting, interactive virtual staff, user interaction support, purchase support, trend analysis, styling proposal, inventory management, and prompt generation utilizes the generative AI and cooperates to realize an advanced personalized purchase experience optimized for each user. For example, when the user thinks “I want to try whether a new dress of an overseas brand suits my body shape”, the user uploads a whole body photograph, the generative AI generates a 3D avatar from body shape data, synthesizes it with a product 3D model to create a virtual fitting image, and further automatically realizes a styling proposal, trend information, staff consultation, an exchange of opinions with a friend, a purchase procedure, inventory management, and price negotiation seamlessly. For example, even for extremely diverse worries and requests such as “I want clothes that are easy to move in and easy to wash during child-rearing”, “I want to cover my upper arms and stomach area”, “I want to choose a color that makes my complexion look bright”, “I am anxious about a sense of size of an overseas brand”, “I do not want to miss a trend”, “I want to compare a plurality of coordinations within a budget”, and “I want to surely obtain a limited product”, the generative AI complexly analyzes attributes and a situation of the user, a past action history, and external trend information, and automatically realizes optimal product proposal, coordination, dressing advice, purchase support, inventory notification, price negotiation, and purchase agency for a limited product seamlessly. Specifically, the system includes an orchestration layer that integrates these plurality of independent neural network models. The system activates a plurality of back-end processes in parallel in response to a single trigger input from the user terminal. The system simultaneously executes inference of an avatar generation model, a space generation model, and a recommendation model. The system writes an output tensor of each model in a shared memory space. The system supplies data on the shared memory to a subsequent integrated rendering pipeline. The system extracts a specific search query vector from an ambiguous request text of the user using a natural language processing model. The system searches for an optimal product ID group from a vector database in milliseconds using the extracted query vector. The system passes the searched product data to a physical simulation engine and executes a real-time cloth simulation. The system processes these complex calculation processes by a distributed GPU cluster on a cloud. The system returns a processing result to the user terminal as an optimized data stream. The system realizes data-driven seamless cooperation that is impossible with a conventional siloed system. The system provides personalization with accuracy exceeding human cognitive ability by feature amount matching in a high-dimensional space. The system is applied to use cases such as a next-generation e-commerce platform and a virtual reality metaverse space. The system exhibits a technical effect of fundamentally improving quality of a purchase experience while dramatically reducing a cognitive load of the user.

As described above, the embodiment of the present invention realizes a comprehensive and highly personalized system in which the user can complete shopping in a virtual space with a sense of satisfaction and enjoyment greater than those of a real store while staying at home by cooperation between a server and a terminal, multilayered utilization of the generative AI, and cooperation of each unit, and fundamentally solves multifaceted and complex problems that could not be solved by a conventional virtual store or online shopping. Specifically, the system adopts a hybrid processing architecture fusing edge computing and cloud computing. The system executes lightweight data preprocessing and real-time drawing processing using a processor on the user terminal side. The system executes inference of a large language model and complex physical simulation using a high-performance calculation node on a cloud server side. The system applies a compression algorithm of a feature amount vector in order to minimize a data amount transmitted and received between the terminal and the server. The system connects a plurality of machine learning models having different architectures as a pipeline. The system unifies an input/output interface of each model in a standardized tensor format. The system thereby reduces overhead of data transfer between modules. The system continuously collects an action log of the user and dynamically updates a weight parameter of each model using an online learning algorithm. The system autonomously improves recommendation accuracy and naturalness of dialogue over time. The system breaks through a limit of scalability that a conventional static rule-based system had. The system accurately models a complex user need by nonlinear analysis of high-dimensional data. The system is applied to use cases such as a global-scale online retail platform and a digital twin environment. The system brings about a technical effect of dramatically increasing response performance and processing capability of the entire system while optimizing utilization efficiency of calculation resources.

### System Configuration

The system according to the present embodiment includes a user avatar generation unit, a virtual store space generation unit, a product information management unit, a virtual fitting provision unit, an interactive virtual staff unit, a user interaction support unit, a purchase support unit, a trend analysis unit, a styling proposal unit, an inventory management unit, and a prompt generation unit. The user avatar generation unit automatically generates a highly accurate 3D avatar individually optimized for each user using generative AI based on information such as height, weight, three sizes, shoulder width, waist, hip, thigh, calf, arm length, neck circumference, foot size, a face image, a skin color, a hairstyle, an age, a gender, a fashion preference, a makeup tendency, an accessory preference, a posture, a walking way, and a facial expression pattern acquired from the user terminal, and for example, when the user takes whole body photographs and face photographs from a plurality of angles with a camera of a smartphone and uploads them to an application, the generative AI generates a 3D avatar realistically reflecting a skeleton, subtle unevenness of a body shape, a posture, facial features, a skin color, a hairstyle, a facial expression, and a walking way, further reflects a fashion taste, an accessory, and a makeup tendency selected by the user in the past in the avatar, and can also reflect a body shape change, a hairstyle change, a makeup change, and the like at any time. For example, a prompt such as “Height 160 cm, weight 52 kg, shoulder width 38 cm, waist 65 cm, hip 90 cm, face image attached, hairstyle short bob, skin color bright, preference natural, generate a realistic 3D avatar based on these pieces of information” is given to the generative AI. Specifically, the system manages each of these units as an independent container on an orchestration tool. The user avatar generation unit normalizes input numerical data and generates a 128-dimensional body shape feature vector. The generation unit inputs face image data to a convolutional neural network and extracts a 256-dimensional face feature vector. The generation unit combines the body shape feature vector and the face feature vector to construct an integrated feature vector. The generation unit inputs the integrated feature vector to a decoder network. The decoder network is composed of a multilayer perceptron. The decoder network infers a vertex coordinate group in a three-dimensional space from the integrated feature vector. The generation unit maps the inferred vertex coordinate group to a vertex of a standard human body mesh model and deforms the mesh. The generation unit inputs a prompt text to a natural language processing model and generates a text embedding vector. The generation unit drives a texture generation model using the text embedding vector as a condition. The texture generation model adopts a diffusion model and generates a high-resolution texture map from noise. The generation unit applies the generated texture map to the deformed mesh. The generation unit constructs 3D avatar data accurately reflecting a physical characteristic of the user by these processes. The generation unit serializes the constructed avatar data in a binary format and transmits it to a subsequent module. The generation unit eliminates the need for manual parameter adjustment and completely automates an avatar generation process. The generation unit generates an extremely realistic digital clone by feature synthesis in a high-dimensional space. The generation unit is applied to use cases such as avatar-based communication in a virtual space and fitting of digital fashion. The generation unit exhibits a technical effect of achieving both efficiency of data processing and improvement of generation accuracy.

The virtual store space generation unit constructs a virtual space by personalizing a store layout, an atmosphere, a display, a decoration, lighting, BGM, a sales floor configuration, a pop-up event, a limited corner, zoning for each brand, a flow line design, a simulation of a congestion status, and the like for each user using generative AI based on a preference, a past purchase tendency, current trend information, a season, a time zone, event information, a psychological state, weather information, and the like of the user, automatically generates, for example, a space based on a wood grain tone and green for a user who likes a natural taste, a monotone or metallic space for a user who likes a mode style, a layout emphasizing bright lighting and a flow line for a sporty-oriented user, and a special corner for cherry blossoms, autumn leaves, Christmas decorations, Valentine's Day, or Halloween during a seasonal event, arranges a frequently used brand or category near an entrance from a purchase history of the user, displays a product that the user is likely to be interested in at a conspicuous place, expands an outdoor corner and provides a special exhibition of camping equipment and sportswear when the user prefers an outdoor brand, reflects the psychological state and the weather information of the user, and automatically selects bright lighting and energetic BGM on a rainy day, and calm lighting and healing music when the user wants to relax. For example, a prompt such as “Generate a virtual store space based on a wood grain tone and green when the preference of the user is a natural taste” is given to the generative AI. Specifically, the virtual store space generation unit includes a hybrid generation engine combining procedural modeling and machine learning. The generation unit receives profile data and environmental data of the user as an input, and encodes them into a 512-dimensional environmental context vector. The generation unit inputs the environmental context vector to a conditional variational autoencoder. The variational autoencoder performs sampling from a latent space, and outputs a two-dimensional segmentation map indicating a floor plan of the store. The generation unit assigns a category ID of an object to be arranged to each region of the segmentation map. The generation unit searches for and acquires appropriate model data from a 3D asset database based on the category ID. The generation unit arranges the acquired 3D model at designated coordinates on the floor plan to construct a scene graph of a scene. The generation unit executes a neural network that infers a lighting parameter from the environmental context vector. The generation unit applies an inferred position, color temperature, and intensity of a light source to the scene graph. The generation unit inputs prompt text to a large language model, and generates metadata defining a theme and an atmosphere of the space. The generation unit dynamically selects or synthesizes an audio file of the BGM based on the metadata. The generation unit passes the constructed scene graph and audio data to a rendering engine, and executes real-time 3D drawing. The generation unit dynamically reconstructs the space for each user, unlike a conventional fixed 3D space design. The generation unit is applied to use cases such as a metaverse platform and a personalized virtual exhibition. The generation unit brings about a technical effect of maximizing a sense of immersion of the user while reducing a development cost by automating space construction.

The product information management unit centrally manages 3D model data, a product image (a front, a side, a back, a wearing example, and a material up image), a price, an inventory status, a brand, a category, a size, a color, a material, a product description, a user review, limited model information, a restock schedule, discount information, a sales start date, a sales end date, pre-order sales information, sustainable certification information, collaboration information, ranking information, and the like regarding a plurality of products on the server side, records a plurality of variations such as a different color, a different size, a limited collaboration model, a pre-sales model, and a pre-order product in detail even for the same product, immediately provides optimal information in response to a user request, holds an enlarged image, a video, a 360-degree view, a marker image for AR, and the like for conveying a multifaceted viewpoint, a wearing example, and a sense of material for the product image, manages the 3D model data with high accuracy up to reproduction of wrinkles and drapes at the time of wearing, gloss, an appearance at the time of layering, deformation according to movement, reflection and transmission for each material, and friction and expansion/contraction, records characteristics and a wearing feeling for each material in detail, such as a linen dress, a leather bag, a wool coat, water-repellent outerwear, and stretch pants, and can immediately present them when the user picks up the product. Specifically, the product information management unit functions as a data infrastructure integrating a distributed graph database and a vector search engine. The management unit defines each product as a node, and stores a relationship between products as an edge in the graph database. The management unit inputs text attribute data of the product to a natural language processing model, and converts it into a 768-dimensional dense vector. The management unit inputs image data of the product to a residual neural network, and extracts a 1024-dimensional image feature vector. The management unit combines the text vector and the image vector to generate a multimodal feature vector. The management unit indexes the multimodal feature vector in a vector database using an approximate nearest neighbor search algorithm. The management unit assigns a material parameter for physically based rendering as a tensor to the 3D model data. The management unit holds data of albedo, metallic, roughness, and a normal map as the material parameter. The management unit records a stiffness matrix and mass distribution data necessary for a physical simulation of a fabric as a structured array. When receiving a search request from a user terminal, the management unit similarly vectorizes a query, and calculates a cosine similarity in a database space. The management unit extracts data of a product node having the highest similarity, and responds in a JSON format. The management unit overcomes a limitation of an exact match search by a conventional relational database. The management unit realizes a flexible search based on semantic similarity in a high-dimensional space. The management unit is applied to use cases such as an e-commerce site having a large-scale product catalog and a digital asset management system. The management unit exhibits a technical effect of dramatically improving search accuracy while minimizing latency of a data search.

The virtual fitting provision unit synthesizes a user avatar and product 3D model data, generates a virtual fitting image or video in a state in which the avatar wears a product in real time using generative AI, allows a user to confirm a state in which the avatar wears a dress by rotating it 360 degrees when the dress is selected, further causes the avatar to simultaneously wear a plurality of items (tops, bottoms, outerwear, an accessory, shoes, or the like), compares and displays a balance of the entire coordination, a combination of a color and a material, a body shape correction effect, a trend element, and the like in real time, allows the user to confirm the coordination from multiple angles through operations such as enlargement/reduction, a viewpoint change, a pose change, a walking animation, a sitting posture, a jump, and rotation, causes the generative AI to make the avatar wear them and presents even a whole body balance and a mixing and matching example when the user specifies “I want to simultaneously try on a pastel color dress, a cardigan, and white sneakers for going out in spring”, reflects a detailed dressing arrangement such as “a state in which sleeves of this jacket are rolled up”, “a state in which a belt is added to this dress”, and “a state in which hems of these pants are rolled up” in real time, and allows the user to share his/her own avatar to SNS or a friend, or save a wearing image for comparative examination. For example, a prompt such as “Generate a realistic 3D avatar based on information of a height of 160 cm, a weight of 52 kg, a shoulder width of 38 cm, a waist of 65 cm, a hip of 90 cm, a face image attached, a short bob hairstyle, and a light skin color, and generate a virtual fitting image in a state of wearing a dress with a product ID 12345” is given to the generative AI. Specifically, the virtual fitting provision unit executes a pipeline in which a deep learning-based image synthesis model and a 3D physical simulator are linked. The provision unit arranges a 3D mesh of the user avatar and a 3D clothing mesh of the product in the same virtual coordinate space. The provision unit receives skeletal animation data of the avatar as an input, and calculates vertex coordinates in each frame. The provision unit applies a cloth simulation based on a finite element method to the clothing mesh, and calculates deformation of clothing following movement of the avatar. The provision unit renders a 3D scene of a simulation result as a two-dimensional depth map and normal map. The provision unit inputs the depth map, the normal map, and a condition vector generated from prompt text to a generator of a conditional generative adversarial network. The generator has a U-Net structure, and outputs a photorealistic RGB image tensor based on input spatial information. The provision unit applies a super-resolution network to the output image tensor to generate a final image with 4K resolution. The provision unit analyzes an instruction for a dressing arrangement from the user with a natural language processing model, and extracts a deformation parameter for a specific region of the clothing mesh. The provision unit sets the deformation parameter as a boundary condition of the physical simulator, and re-executes the simulation. The provision unit performs distributed processing of these processes by a GPU cluster on a cloud, and performs streaming distribution of a result. The provision unit provides a physically accurate fitting experience different from conventional simple superimposition of 2D images. The provision unit is applied to use cases such as online apparel sales and content generation of a virtual influencer. The provision unit brings about a technical effect of improving reality of fitting and significantly reducing a return rate.

The interactive virtual staff unit returns personal advice, a product proposal, tips for size selection, return/exchange guidance, a coordination example, a reason for combination, a body shape correction effect, relevance to a trend, tips for mixing and matching, characteristics for each brand, a handling method of a material, advice on washing and maintenance, a gift proposal, event information, lottery guidance for a limited product, and the like in real time to a question or request by voice or text from a user using generative AI while referring to user information, product information, styling information, trend information, a purchase history, an inventory status, a usage scene, a budget, a return/exchange history, a tendency of size selection, a worry about dressing, a past consultation history, and the like, comprehensively analyzes a body shape, a preference, a past purchase history, a current trend, an inventory status, a usage scene, a budget, a return/exchange history, characteristics for each brand, and the like in response to various questions and requests such as “Does this jacket suit me?”, “Which bag matches this coordination?”, “What is the trend this season?”, “How is the sense of size of this brand?”, “Please tell me recommended products within the budget”, “I want to cover my upper arms”, “I want to choose a color that makes my complexion look bright”, “What are tips for size selection of an overseas brand?”, “What kind of scene is this product suitable for?”, “What is an item that can cover my body shape?”, “I want to return an item”, “I want to exchange a size”, “Is gift wrapping possible?”, and “I want to participate in a lottery for a limited product”, and immediately generates a personalized answer up to an optimal product, coordination, points of dressing, a procedure method for return/exchange, a gift proposal, event information, and lottery guidance for a limited product. For example, a prompt such as “User information: height 160 cm, weight 52 kg, shoulder width 38 cm, waist 65 cm, hip 90 cm, preference is natural, past purchase history exists, question: Does this dress suit me? In response to this, generate personal advice considering the body shape, the preference, the past purchase history, and the trend of this season” is given to the generative AI. Specifically, the interactive virtual staff unit is an advanced dialogue agent system adopting a retrieval-augmented generation architecture. The staff unit inputs input text from the user to an embedding model, and converts it into a high-dimensional query vector. The staff unit searches for related product information, a past dialogue history, and trend information from a vector database using the query vector. The staff unit extracts the searched information as context text. The staff unit combines profile data of the user, the context text, and the input text to construct an integrated prompt. The staff unit inputs the integrated prompt to a transformer-based large language model. The large language model has dozens of layers of self-attention blocks, and deeply understands a context from an input token sequence. The large language model calculates a probability distribution of a token appearing next, and autoregressively generates response text. The staff unit analyzes whether a function call tag that triggers a specific action is included in the generated response text. When detecting the function call tag, the staff unit automatically executes an external inventory management API or payment API. The staff unit inputs an execution result of the API to the language model again, and generates final response text. The staff unit inputs the response text to a voice synthesis model, and outputs voice waveform data having a natural intonation. The staff unit synchronizes the voice data and the text data, and transmits them to a user terminal. The staff unit exceeds a limit of handling by a human operator, and provides uniform and high-quality support 24 hours a day, 365 days a year. The staff unit is applied to use cases such as automation of customer support and a personal shopping assistant. The staff unit exhibits a technical effect of dramatically reducing an operation cost while improving customer satisfaction.

The user interaction support unit provides various interaction functions such as a chat or voice call between user avatars, an exchange of opinions on coordination, a joint shopping experience, SNS linkage, a group purchase, browsing of a ranking of popular coordination, event participation, a joint lottery for a limited product, friend invitation, real-time voting, a questionnaire, a review post, a coordination contest, and a virtual fashion show, realizes a communication experience close to real shopping, such as friends entering the same virtual store, selecting a product together while exchanging opinions by a chat or a voice call, showing coordination to each other, consulting among three parties including a staff member, sharing dressing with other users by SNS linkage, browsing a ranking of popular coordination, a discount by a group purchase, participation in a limited event, application for a coordination contest, and participation in a virtual fashion show, and enables consultation such as “What do you think of this coordination?” and “Does this color suit me?” between users, a discount by a group purchase, participation in a limited event, and the like. Specifically, the user interaction support unit adopts a distributed real-time communication architecture. The system establishes a peer-to-peer data communication session between respective user terminals. The communication control unit packetizes voice data and motion data of an avatar. The system transmits a packet using a low-latency streaming protocol. The voice processing module executes noise canceling processing on an input voice waveform tensor. The system converts the processed voice data into a feature amount vector. The natural language processing model receives the voice feature amount vector as an input. For example, input data is a 256-dimensional tensor obtained by converting a voice waveform with a sampling rate of 48 kilohertz into a mel-frequency cepstral coefficient. The model analyzes an emotional state of the user from the input tensor. The model generates a probability distribution vector of an emotion score as an output. For example, output data is a continuous value score from 0 to 1 for each emotion category such as joy, surprise, and hesitation. The avatar control unit uses this emotion score as subsequent processing. The control unit dynamically updates a weight of a facial expression blend shape of the avatar based on the emotion score. The system converts an utterance content of the user into a text vector in real time. The translation module converts the text vector into a token sequence of another language using a multilingual large language model. The system displays the translated text in a chat window. The synchronization processing unit synchronizes avatar position coordinates and a posture matrix among a plurality of users. The system smoothes stuttering due to a network delay using a state interpolation algorithm. The system calculates a similarity of interaction between users by a vector operation in a high-dimensional space. The recommendation engine proposes an optimal combination for a group purchase based on a similarity score. The system realizes communication exceeding a physical constraint in a real space by these non-conventional processing methods. The system maintains a drawing frame rate in a multi-user simultaneous participation type virtual space while minimizing consumption of a communication band. The system dramatically improves a sense of immersion of the user by this technical effect. The system is applied to a use case of stably processing simultaneous connections on a scale of thousands of people in a large-scale event such as a virtual fashion show.

The purchase support unit automatically manages a budget, an inventory, delivery destination information, a payment method, a delivery status, a return/exchange history, a restock notification, a lottery application for a limited product, gift wrapping, delivery date and time designation, point usage, coupon application, management of a purchase history, and the like of a user using generative AI, seamlessly supports a purchase procedure, tracking of a delivery status, automation of a return/exchange procedure, a restock notification, a lottery application for a limited product, gift wrapping, delivery date and time designation, point usage, coupon application, management of a purchase history, and the like, causes the generative AI to propose an optimal combination within a budget when the user puts a plurality of products in a cart, automatically confirms an inventory status, and automates input assistance for a delivery destination and a payment method, a real-time notification of a delivery status, procedure guidance for return and size exchange, a restock notification, a lottery application for a limited product, gift wrapping, delivery date and time designation, point usage, coupon application, management of a purchase history, and the like, and gives a prompt such as “The budget of the user is 20,000 yen, list products purchasable within the budget based on a product list, a price, and an inventory status, and generate a guidance text for a flow of a purchase procedure, a delivery status, and a return/exchange procedure” to the generative AI. Specifically, the purchase support unit implements an autonomous artificial intelligence agent that optimizes transaction processing. The system models a purchasing behavior of the user as a multidimensional context vector. The budget management module acquires budget information of the user, a price matrix of products in a cart, and an inventory status flag as input data. The system combines these data to generate a 512-dimensional input tensor. The optimization model adopts a transformer-based neural network architecture. The model analyzes the input tensor by a self-attention mechanism. The model generates a probability distribution vector of an optimal product combination that fits within the budget as an output. For example, output data is a numerical array from 0 to 1 indicating a selection probability of each product. The system extracts a combination of products whose probability exceeds a threshold. The text generation model receives the extracted product list as an input. The model outputs a text token sequence of a guidance text. For example, output data is structured character string data indicating a procedure of a purchase procedure. The payment processing unit uses this output result as subsequent processing. The payment processing unit analyzes the token sequence, and automatically generates a call parameter of an application programming interface for an external payment gateway. The system guarantees data consistency using a distributed transaction management protocol. The system executes a two-phase commit algorithm, and synchronizes decrement processing of an inventory database and a payment completion status. The system acquires tracking data of a delivery status as a time-series array. The prediction model calculates a probability of a delivery delay from the time-series array. When the delay probability is high, the system automatically recalculates an alternative delivery route. The system completely eliminates manual confirmation work by a human operator by these processes. The system shortens latency of payment processing to a millisecond unit by this technical improvement. The system exhibits a technical effect of dramatically reducing a cart abandonment rate. The system enables dynamic scaling of server resources in a high-load use case such as lottery sales of a limited product.

The trend analysis unit analyzes various external and internal data such as SNS, fashion magazines, collections, street snaps, influencer posts, search trends of a search engine, an official brand site, purchase data of a user, a review, a questionnaire result, event information, a seasonal factor, and a regional factor using generative AI, extracts a color, a pattern, a silhouette, a material, a brand tendency, a dressing technique, a popular item, a notable collaboration, a trend of sustainable fashion, a popularity trend of a limited product, a degree of excitement of an event, a trend tendency for each region, a trend by age, a trend by gender, a topic on SNS, and the like that are popular this season, reflects them in real time in a styling proposal, a product recommendation, store space generation, event planning, a promotion measure, inventory management, a price strategy, and the like, and gives a prompt such as “Extract a popular color, a popular pattern, a popular silhouette, a popular brand, a notable dressing technique, and a trend of sustainable fashion of this season based on latest data of SNS, fashion magazines, and collections, and present 10 items in a ranking format” to the generative AI. Specifically, the trend analysis unit includes a deep learning architecture specialized for multimodal data processing. The system continuously crawls unstructured data on the Internet. The data collection unit acquires image data, text data, and time-series search volume data. The preprocessing module converts the image data into a normalized RGB pixel tensor. The module converts the text data into a word embedding vector. The system integrates these heterogeneous data, and maps them to a high-dimensional feature amount space. The analysis model is an ensemble model of a convolutional neural network and a recurrent neural network. The model receives the image tensor and the text vector as an input. For example, input data is a pair of an image tensor of 224 pixels square and a 768-dimensional text embedding vector. The model extracts a latent trend feature from the input data. The model generates a numerical vector of a trend score and barycentric coordinates of a feature amount cluster as an output. For example, output data is a normalized score from 0 to 100 indicating a degree of popularity of a specific color or silhouette. The system uses this trend score as subsequent processing. The recommendation engine dynamically updates a weight parameter of a product recommendation algorithm based on the trend score. The system predicts a trend fluctuation several months ahead using a time-series prediction algorithm. The system applies a prediction result as an optimization parameter of an inventory management database. The system continuously fine-tunes a weight of the analysis model using a backpropagation method. The system uses a linear combination of a mean square error and a cross-entropy error as a loss function. The system quantifies a trend by a purely data-driven high-dimensional space operation, unlike a conventional marketing method depending on human intuition and experience. The system significantly improves accuracy of demand prediction by this technical effect. The system brings about a specific improvement of reduction of excess inventory and minimization of opportunity loss. The system is applied to a use case of automatic drafting of a new product plan and a production plan of an apparel brand.

The coordination proposal unit generates a plurality of optimal coordination examples using generative AI based on a body shape, facial features, a preference, a season, a usage scene, trend information, a past purchase history, an inventory status, a budget, a worry about dressing, characteristics of a brand, characteristics of a material, event information, limited product information, and the like of a user, automatically generates and presents an explanatory text such as “why this combination suits”, “what kind of worry about a body shape can be covered”, “which scene is optimal”, “relevance to a trend”, “tips for mixing and matching”, “recommended use of accessories”, “characteristics for each brand”, “a handling method of a material”, “points of dressing at an event”, and “a utilization method of a limited product” for each coordination example, and gives a prompt such as “Height 160 cm, weight 52 kg, shoulder width 38 cm, waist 65 cm, hip 90 cm, preference is natural, usage scene is going out in spring, trend of this season is a pastel color and a linen material, propose 3 patterns of optimal coordination under these conditions, and explain a reason for combination, a body shape correction effect, a recommended scene, relevance to a trend, and tips for mixing and matching for each” to the generative AI. Specifically, the coordination proposal unit implements a hybrid inference engine integrating a graph neural network and a large language model. The system expresses attribute data of the user and metadata of a product group as a knowledge graph composed of nodes and edges. The feature extraction unit combines body shape dimensions, a past purchase history, and a current trend score of the user to generate a 1024-dimensional user context vector. The system acquires an attribute vector of each item from a product database. The proposal model receives the user context vector and the product attribute vector as an input. For example, input data is an array of floating-point numbers representing a preference of the user, and a one-hot encoding vector of a categorical variable representing a color and a material of a product. The model executes a graph convolution operation, and updates a hidden state between nodes. The model generates a probability distribution of a fitness score of coordination as an output. For example, output data is an index of top 3 patterns from among millions of combinations, and a fitness score of 0.95 or more for each. The system uses this output result as subsequent processing. The explanation generation model receives the index of the selected coordination and the user context vector as an input. The model executes an autoregressive token generation process. The model generates a token sequence of a natural language constituting an explanatory text as an output. For example, output data is text data logically explaining a body shape correction effect and tips for mixing and matching. The system parses the generated text data, and filters an inappropriate expression. The system issues a 3D drawing instruction of the proposed coordination to a rendering engine. The system discovers a novel and appropriate combination that a human cannot think of by learning a non-linear relationship in a latent space, unlike simple rule-based filtering. The system dramatically increases accuracy of personalization by this technical effect. The system reduces a cognitive load required for decision-making of the user, and shortens an information search time. The system is extremely effective in a use case of complete automation of online customer service.

The inventory management unit automatically detects a product with low inventory, a new product, a limited product, a popular product, a restocked product, a discounted product, an event-linked product, a region-limited product, a collaboration product, and the like based on a preference, a purchase tendency, a browsing history, a product in a cart, a wish list, a restock notification setting, an application status for a lottery of a limited product, an event participation history of a user, an inventory status for each region, a sales trend, trend information, a price fluctuation, a promotion measure, and the like, notifies a user terminal, immediately displays an alert of “low inventory” when a product that the user has browsed many times in the past has one item left, can also execute price negotiation and purchase agency for a limited product using generative AI, automatically negotiates with a sales side to draw out a discount or a privilege by the AI when the user requests “I want to buy this product a little cheaper”, automatically manages lottery sales and a pre-order of a limited product, a restock notification, event-linked sales, region-limited sales, a priority purchase right of a collaboration product, and the like, supports the user so as to obtain a desired product without missing it, and gives a prompt such as “Extract a product with low inventory, a new product, and a limited product based on a product list browsed by the user in the past and an inventory status, and generate an alert text and a purchase recommendation text for notifying the user. Also, generate a negotiation text for price negotiation and purchase agency” to the generative AI. Specifically, the inventory management unit is an autonomous control system combining real-time stream data processing and a reinforcement learning algorithm. The system collects an action log and an inventory fluctuation event of all users in a millisecond unit using a distributed message queuing system. The anomaly detection model receives a time-series array of an inventory quantity as an input. The model detects a sign of inventory depletion at an early stage by statistical processing based on a moving average and a standard deviation. When the inventory falls below a threshold, the system extracts an identifier of a target product. The notification control unit calculates a purchase probability score of the user. The system selects a user whose purchase probability score is equal to or greater than a certain value as a target. The price negotiation agent implements a reinforcement learning model based on a Markov decision process. The agent observes a current inventory quantity, a budget vector of the user, and a price fluctuation vector of a market as an input state. For example, input data is an integer value indicating a remaining inventory quantity of 3, numerical data indicating a desired price of the user, and a time-series tensor indicating a price transition of a competitor. The agent calculates an optimal discount rate using a policy gradient method. The agent generates numerical data of the discount rate and a token sequence of negotiation text as an output. For example, output data is a floating-point number indicating a discount of 15 percent, and character string data proposing a special offer. The system uses this output result as subsequent processing. The system executes a smart contract, and records a transaction condition on a blockchain. The system generates payload data of a push notification, and transmits it to a notification service of a mobile operating system. The system autonomously executes dynamic pricing and inventory allocation without intervention of a human administrator. The system maximizes an inventory turnover rate and suppresses occurrence of dead inventory by this technical effect. The system reduces a polling load of a server, and makes calculation resources of the entire system efficient. The system levels a spike in traffic in a use case of sales management of a flash sale or a limited collaboration product.

The prompt generation unit automatically generates a prompt text to generative AI necessary for processing of each unit based on various parameters such as user information, product information, trend information, a usage scene, a past history, an inventory status, event information, limited product information, brand information, material information, regional information, weather information, and a psychological state, and realizes optimal information generation, proposal, support, and management. Specifically, the prompt generation unit is a natural language processing module integrating dynamic template matching and a context embedding algorithm. The system identifies a type of task requested from each functional module. The context collection unit expands various parameters such as the user information, the product information, and the trend information on a memory as dictionary format data of a key-value pair. The system normalizes these parameters, and converts them into a multidimensional context vector. The generation model receives a task identifier and the context vector as an input. For example, input data is an integer ID indicating a coordination proposal task, and a 512-dimensional tensor encoding an attribute and weather information of a user. The model assigns a weight to a parameter most relevant to the task using an attention mechanism. The model generates an optimized prompt character string as an output. For example, output data is structured text defining a specific instruction, a constraint condition, and an output format for generative artificial intelligence. The system uses this output result as subsequent processing. The system transmits the generated prompt character string to an application programming interface of an external or internal large language model. The system monitors a response time from the application programming interface, and regenerates an alternative lightweight prompt at the time of a timeout. The system accumulates a generation history of the prompt and an evaluation score of an inference result in a database. The system periodically executes fine-tuning of the prompt generation model using this accumulated data. The system completely automates manual prompt engineering by a human. The system suppresses variation in inference accuracy of the generative artificial intelligence and guarantees a stable output by this technical effect. The system eliminates a bottleneck in a processing pipeline of the entire system, and improves throughput. The system is applied to a use case of functioning as a foundation of an interactive system that generates an optimal response in real time to various user requests.

As described above, the system according to the present embodiment realizes a comprehensive and highly personalized system in which each unit cooperates by utilizing generative AI to realize a highly personalized purchase experience optimized for each user, and the user can complete shopping in a virtual space with a sense of satisfaction and enjoyment exceeding those of a real store while staying at home. Specifically, the present system is constructed on an advanced distributed computing environment based on a microservice architecture. The present system deploys each functional module as an independent container. The present container orchestration tool dynamically allocates computing resources according to a load status of each module. The present system adopts an asynchronous message queuing protocol for data communication between modules. The present system offloads inference processing of the generative artificial intelligence to a cluster of graphics processing units. The present system executes a hybrid data pipeline combining batch processing and stream processing of input data. The present system caches intermediate data generated by each module in an in-memory database. The present system thereby minimizes latency of data transfer between modules. The present system introduces an edge computing technology that coordinates a lightweight inference model executed on a user terminal side and a large-scale model executed on a server side. The present system locally preprocesses sensor data and image data acquired on the terminal side, and transmits only a feature amount vector to the server. The present system significantly reduces consumption of a network bandwidth by this non-conventional processing method. The present system brings about technical effects of optimization of a data transfer amount and distribution of a server load. The present system realizes performance improvement at an architecture level of the entire computer system, rather than mere automation of business. The present system maintains availability of the entire system by restarting or failing over only a specific module when a failure occurs. The present system enables non-stop service provision by this enhancement of fault tolerance. The present system exhibits extremely high scalability and reliability in a use case of operating a large-scale e-commerce platform on a global scale.

### Implementation Steps

Step 1: User Information Acquisition and Avatar Generation The user inputs or photographs information such as a height, a weight, three sizes, a shoulder width, a waist, a hip, a thigh, a calf, an arm length, a neck circumference, a foot size, a face image, a skin color, a hairstyle, an age, a gender, a fashion preference, a makeup tendency, an accessory preference, a posture, a walking style, and a facial expression pattern from a terminal, and transmits the information to the system. A user avatar generation unit on the server side automatically generates a highly accurate 3D avatar individually optimized for each user using generative AI based on these pieces of information. As a specific example of a prompt sentence to be read by the generative AI, “Generate a realistic 3D avatar based on these pieces of information: height 160 cm, weight 52 kg, shoulder width 38 cm, waist 65 cm, hip 90 cm, face image attached, hairstyle short bob, skin color bright, preference natural” is cited. Specifically, the present user information acquisition unit acquires raw data from a camera module and various sensors of the terminal. The present system normalizes the acquired face image and converts it into a 256-pixel square RGB tensor. The present system converts the input body dimension data into a numerical vector of floating-point numbers. The present avatar generation model adopts an architecture of a generative adversarial network. A generator of the present model receives the RGB tensor and the numerical vector as inputs. For example, the input data is a pixel array of a face and a 10-dimensional vector indicating a height and three sizes. The present model extracts a feature representation of a latent space through a convolutional layer and a fully connected layer. The present model generates a vertex coordinate array of a 3D mesh and a texture map as outputs. For example, the output data is mesh data composed of tens of thousands of polygons and a high-resolution image file expressing a skin texture. The present system uses this output result as subsequent processing. The present rigging module automatically assigns a bone structure to the generated mesh data. The present system calculates a movable range of a joint of the avatar using an inverse kinematics algorithm. The present system applies motion capture data to the avatar based on parameters of the posture and walking style of the user. The present system executes these processes in parallel on a graphics processing unit. The present system completely eliminates conventional manual 3D modeling work, and dynamically generates an avatar by tensor calculation in a high-dimensional space. The present system reduces a calculation time required for avatar generation to a unit of several seconds by this technical effect. The present system optimizes a file size of the generated avatar data, and reduces a transfer load to a client terminal. The present system dramatically improves efficiency of a user onboarding process in a use case of fitting in a virtual space or automatic generation of an in-game character.
Step 2: Individual Generation of Virtual Store Space A virtual store space generation unit constructs a virtual space by personalizing a store layout, an atmosphere, a display, a decoration, lighting, BGM, a sales floor configuration, a pop-up event, a limited corner, zoning for each brand, a flow line design, and the like for each user using generative AI based on a preference, a past purchase tendency, current trend information, a season, a time zone, event information, a psychological state, weather information, and the like of the user. As a specific example of a prompt sentence to be read by the generative AI, “If the user's preference is a natural taste, generate a virtual store space based on a wood grain tone and green” is cited. Specifically, the present virtual store space generation unit implements a spatial rendering engine combining a procedural modeling technology and deep learning. The present system collects preference data, a past purchase history, and environmental variables of the user. The present system combines these data to construct a context vector for spatial generation. The present spatial generation model adopts an architecture of a variational autoencoder. The present model receives the context vector as an input. For example, the input data is a 64-dimensional tensor including a flag preferring a natural taste, a categorical variable indicating spring, and an environmental parameter indicating sunny. The present model samples features of a spatial layout from a latent space. The present model generates bounding box coordinates of a 3D space, an arrangement matrix of objects, and a light source parameter matrix as outputs. For example, the output data is polygon coordinates of a wall and a floor, a three-dimensional position vector of a display shelf, and numerical data indicating a color temperature and intensity of environmental light. The present system uses this output result as subsequent processing. The present ray tracing engine calculates reflection and refraction of light in real time based on the arrangement matrix and the light source parameters. The present system applies an occlusion culling algorithm, and skips drawing processing of an object outside a field of view of a camera. The present system performs mipmapping of a texture, and applies an image with an optimal resolution according to a camera distance. The present system minimizes consumption of a graphics memory of a client terminal by these non-conventional processing methods. The present system stabilizes a drawing frame rate of a high-definition virtual space to 60 frames per second or more by this technical effect. The present system prevents 3D sickness of the user due to a drawing delay. The present system realizes efficient allocation of computing resources in a use case of dynamic construction of a personalized virtual store in a metaverse space.
Step 3: Integrated Management and Presentation of Product Information A product information management unit centrally manages 3D model data, a product image (a front, a side, a back, a wearing example, and a material up image), a price, an inventory status, a brand, a category, a size, a color, a material, a product description, a user review, limited model information, a restock schedule, discount information, a sales start date, a sales end date, pre-order sales information, sustainable certification information, collaboration information, ranking information, and the like regarding a plurality of products on the server side, and immediately presents optimal information when the user picks up or searches for a product. Specifically, the present product information management unit adopts a hybrid storage architecture combining a distributed NoSQL database and an in-memory cache cluster. The present system stores diverse product attribute data in the database as a document in a JSON format. The present system stores large-capacity binary data such as 3D model data and a high-resolution image in an object storage, and manages a reference uniform resource locator thereof in the database. The present search engine converts a search request from the user into a vector representation. The present system analyzes an intention of a search query using a natural language processing model. The present system vectorizes each document in a product database in advance, and constructs a high-dimensional index. The present similarity calculation module receives a search query vector and a product vector as inputs. For example, the input data is a 512-dimensional vector encoding a search phrase of the user and a group of millions of product feature amount vectors. The present module executes cosine similarity calculation in parallel. The present module generates a list of product identifiers sorted in order of a relevance score as an output. For example, the output data is array data including top 50 product IDs and respective similarity scores. The present system uses this output result as subsequent processing. The present system acquires detailed data from the in-memory cache at high speed based on the product ID. The present system transmits the acquired data to a client terminal as a JSON response. The present system implements optimistic concurrency control for avoiding lock contention of the database. The present system reduces a response time of a complex search query for millions of records to a unit of several milliseconds by this technical effect. The present system reduces an input/output waiting time of the server, and maximizes throughput. The present system exhibits extremely high performance in a use case of real-time product search and filtering in a large-scale e-commerce site.
Step 4: Virtual Fitting and Coordination Comparison A virtual fitting provision unit synthesizes a user avatar and product 3D model data, and generates a virtual fitting image or video in a state in which the avatar wears a product in real time using generative AI. The user can simultaneously wear a plurality of items such as a dress, outerwear, and an accessory, and compare and display a whole body balance of coordination, a combination of a color and a material, a body shape correction effect, a trend element, and the like in real time. As a specific example of a prompt sentence to be read by the generative AI, “Generate a realistic 3D avatar based on these pieces of information: height 160 cm, weight 52 kg, shoulder width 38 cm, waist 65 cm, hip 90 cm, face image attached, hairstyle short bob, skin color bright, and generate a virtual fitting image in a state in which a dress of product ID 12345 and a cardigan of product ID 67890 are simultaneously worn” is cited. Specifically, the present virtual fitting provision unit implements an advanced physical simulation engine and a cloth simulation algorithm. The present system loads 3D mesh data of the avatar and a physical parameter matrix of the selected product onto a memory. The present physical parameter matrix includes data of a mass, rigidity, a friction coefficient, and stretchability of cloth. The present simulation model receives vertex coordinates of the avatar and initial arrangement coordinates of clothes as inputs. For example, the input data is a bone transformation matrix indicating a posture of the avatar and tens of thousands of vertex vectors constituting a polygon mesh of the clothes. The present model calculates deformation of the cloth using a finite element method. The present model generates a vertex coordinate array and a normal vector of a clothes mesh after deformation as outputs. For example, the output data is a new three-dimensional coordinate group reflecting wrinkles and drapes generated according to gravity and movement of the avatar. The present system uses this output result as subsequent processing. The present collision determination module detects an intersection of a body mesh of the avatar and the clothes mesh, and executes clipping prevention processing. The present system performs an iterative calculation for resolving interference between layers at the time of layering a plurality of items. The present rendering pipeline applies a texture and a material shader to the calculated mesh data, and calculates a final pixel color. The present system processes these complex physical calculations in parallel using a compute shader of a graphics processing unit. The present system reproduces a realistic wearing state by dynamic vertex calculation based on physical laws, unlike conventional static image synthesis. The present system realizes real-time processing of physical calculation and completely eliminates visual discomfort by this technical effect. The present system minimizes a drawing delay when the user rotates or moves the avatar. The present system contributes to a use case of dramatically reducing a return rate due to a size mismatch or an image difference in online apparel sales.
Step 5: Personal Support by Interactive Virtual Staff An interactive virtual staff unit returns personal advice, a product proposal, tips for size selection, return/exchange guidance, a coordination example, a reason for combination, a body shape correction effect, relevance to a trend, tips for mixing and matching, characteristics of each brand, a handling method of a material, advice on washing and maintenance, a gift proposal, event information, lottery guidance for a limited product, and the like in real time to a question or request by voice or text from the user using generative AI while referring to user information, product information, styling information, trend information, a purchase history, an inventory status, a usage scene, a budget, a return/exchange history, a tendency of size selection, a worry about dressing, a past consultation history, and the like. As a specific example of a prompt sentence to be read by the generative AI, “User information: height 160 cm, weight 52 kg, shoulder width 38 cm, waist 65 cm, hip 90 cm, preference natural, past purchase history present, question: Does this dress suit me? In response to this, generate personal advice considering a body shape, a preference, a past purchase history, and a trend of this season” is cited. Specifically, the present interactive virtual staff unit implements an advanced natural language processing pipeline based on a retrieval-augmented generation architecture. The present system converts a voice input from the user into text in real time. The present context integration unit combines the converted text, a profile vector of the user, a past purchase history matrix, and a current session state. The present system executes a similarity search on a vector database, and extracts related product information and a knowledge base document of styling. The present dialogue generation model is a transformer-based large language model. The present model receives the input text of the user and the extracted context document as inputs. For example, the input data is a text sequence of thousands of tokens including a question sentence of the user and specification data and an inventory status acquired from a product database. The present model analyzes a context using a self-attention mechanism. The present model generates a token sequence of a response text and an acoustic feature amount for voice synthesis as outputs. For example, the output data is a character string of a natural language including personalized advice and a mel-spectrogram tensor controlling a pitch and intonation. The present system uses this output result as subsequent processing. The present voice synthesis module generates a voice waveform from the acoustic feature amount. The present lip-sync control unit analyzes an amplitude and a frequency component of the voice waveform, and dynamically generates a mouth movement of an avatar of a virtual staff. The present system synchronizes the generated voice and animation, and streams them to a client terminal. The present system executes non-linear inference considering a dynamically changing context, unlike a rule-based chatbot. The present system minimizes a response delay and realizes a natural dialogue comparable to a human by this technical effect. The present system significantly reduces an operation cost in a use case of complete automation of customer support and provision of a personalized customer service experience.
Step 6: User Interaction and Joint Shopping Experience A user interaction support unit provides diverse interaction functions such as a chat or voice call between user avatars, an exchange of opinions on coordination, a joint shopping experience, SNS linkage, group purchase, browsing of a ranking of popular coordination, event participation, a joint lottery for a limited product, friend invitation, real-time voting, a questionnaire, review posting, a coordination contest, and a virtual fashion show, and realizes a communication experience close to real shopping. Specifically, the present user interaction support unit constructs a peer-to-peer full mesh network topology based on a web real-time communication protocol. The present system exchanges a session description protocol between respective client terminals via a signaling server. The present state synchronization module samples position coordinates, a rotation quaternion, and an animation state of an avatar of each user in units of milliseconds. The present system encodes these state data as a difference vector. The present synchronization algorithm receives input event data from each terminal. For example, the input data is a two-dimensional vector of a joystick indicating a movement operation of the user or an array of Boolean values indicating a button press. The present system interpolates a packet loss due to a network delay using a dead reckoning algorithm. The present system generates a future predicted coordinate vector of each avatar as an output. For example, the output data is an array of floating-point numbers indicating a three-dimensional position of the avatar in a next rendering frame. The present system uses this output result as subsequent processing. The present rendering engine smoothly moves the avatar based on the predicted coordinates. The present voice mixing module processes voice streams of a plurality of users as spatial audio. The present system dynamically calculates attenuation and panning of voice based on a relative distance and direction between avatars. The present system dramatically reduces bandwidth consumption of a central server by these non-conventional processing methods. The present system suppresses a communication delay in a virtual space in which a large number of people simultaneously participate to below a human perception limit by this technical effect. The present system improves fault tolerance against network jitter and packet loss. The present system provides a seamless synchronization experience in a use case of a virtual shopping tour between friends or a large-scale online fashion event.
Step 7: Purchase Support and Procedure Automation A purchase support unit automatically manages a budget, an inventory, delivery destination information, a payment method, a delivery status, a return/exchange history, a restock notification, a lottery application for a limited product, gift wrapping, delivery date and time designation, point usage, coupon application, management of a purchase history, and the like of the user using generative AI, and seamlessly supports a purchase procedure, tracking of a delivery status, automation of a return/exchange procedure, a restock notification, a lottery application for a limited product, gift wrapping, delivery date and time designation, point usage, coupon application, management of a purchase history, and the like. As a specific example of a prompt sentence to be read by the generative AI, “The user's budget is 20,000 yen. Based on a product list, a price, and an inventory status, list products purchasable within the budget, and generate a guidance sentence for a flow of a purchase procedure, a delivery status, and a return/exchange procedure” is cited. Specifically, the present purchase support unit implements a state machine that guarantees atomicity, consistency, isolation, and durability of a transaction in a distributed system. The present system activates an asynchronous event-driven architecture triggered by a cart addition operation of the user. The present budget evaluation module receives a budget vector of the user and a price matrix of products in a cart as inputs. The present system solves a utility maximization problem under a budget constraint using a linear programming algorithm. The present system generates payload data of a payment request. The present encryption module encrypts the payload data by a public key cryptosystem. The present payment processing model receives the encrypted payload as an input. For example, the input data is a secure hash character string including credit card information and a delivery destination address. The present system communicates with an external payment gateway, and executes authorization. The present system generates a status code of transaction completion and receipt data with an electronic signature as outputs. For example, the output data is a JSON object including an HTTP status 200 indicating processing success and a unique transaction ID. The present system uses this output result as subsequent processing. The present inventory synchronization module exclusively locks a record of an inventory database using the transaction ID as a key, and executes decrement processing. The present system prevents data inconsistency between a payment database and the inventory database using a two-phase commit protocol. The present system calls a delivery management application programming interface, and automatically acquires a tracking number. The present system autonomously executes these processes without human intervention. The present system improves throughput of payment processing and ensures responsiveness of the system to simultaneous and multiple purchase requests by this technical effect. The present system completely prevents overselling of an inventory due to data contention. The present system is applied to a use case of secure payment processing under a high traffic environment such as a flash sale.
Step 8: Trend Analysis and Reflection in Store and Proposal A trend analysis unit analyzes diverse external and internal data such as SNS, fashion magazines, collections, street snaps, influencer posts, search trends of a search engine, a brand official website, purchase data of a user, a review, a questionnaire result, event information, a seasonal factor, and a regional factor using generative AI, extracts a color, a pattern, a silhouette, a material, a brand tendency, a dressing technique, a popular item, a notable collaboration, a trend of sustainable fashion, a popularity trend of a limited product, a degree of excitement of an event, a trend tendency for each region, a trend by age, a trend by gender, a topic on SNS, and the like that are popular this season, and reflects them in a styling proposal, a product recommendation, store space generation, event planning, a promotion measure, inventory management, a price strategy, and the like in real time. As a specific example of a prompt sentence to be read by the generative AI, “Extract a popular color, a popular pattern, a popular silhouette, a popular brand, a notable dressing technique, and a trend of sustainable fashion of this season based on latest data of SNS, fashion magazines, and collections, and present 10 items in a ranking format” is cited. Specifically, the present trend analysis unit constructs a large-scale data processing pipeline based on a lambda architecture. The present system operates a batch processing layer and a speed processing layer in parallel. The present data ingest module acquires real-time stream data from an application programming interface of social media. The present system performs morphological analysis on the acquired text data, and generates an appearance frequency vector of a word. The present image analysis model extracts a feature amount map from a street snap image using a convolutional neural network. The present trend prediction model receives a time-series appearance frequency vector and an image feature amount map as inputs. For example, the input data is a one-dimensional array indicating a search volume of a specific keyword in the past 30 days and a 512-dimensional style feature vector extracted from an image. The present model learns a time-series dependency relationship using a long short-term memory network. The present model generates a score matrix indicating a future growth probability of each trend element as an output. For example, the output data is a prediction score from 0 to 1 for each category such as a pastel color or an oversized silhouette. The present system uses this output result as subsequent processing. The present system dynamically updates a weight parameter of a collaborative filtering algorithm of a product recommendation engine based on the score matrix. The present system transmits an element having a high trend score as an environmental variable to a spatial generation module of a virtual store. The present system executes invalidation of a cache server, and immediately reflects latest trend data on a front end. The present system captures a minute change in a trend by continuous tensor calculation in a high-dimensional space, unlike static rule-based analysis. The present system achieves both securing of real-time property and efficiency improvement of large-scale data processing by this technical effect. The present system dramatically improves an adaptation capability of the system to a market change. The present system technically supports business decision-making in a use case of data-driven dynamic pricing or inventory optimization.
Step 9: Coordination Proposal and Explanation Generation The styling proposal unit generates a plurality of optimal coordination examples using the generative AI based on the body shape, the facial features, the preference, the season, the usage scene, the trend information, the past purchase history, the inventory status, the budget, a worry about dressing, a characteristic of a brand, a characteristic of a material, event information, limited product information, and the like of the user, and automatically generates and presents an explanatory text such as “why this combination suits”, “what kind of body shape worry can be covered”, “which scene is optimal”, “relevance to a trend”, “tips for mixing and matching”, “recommended use of accessories”, “characteristic for each brand”, “handling method of material”, “dressing point at event”, and “utilization method of limited product” for each coordination example. As a specific example of a prompt sentence to be read by the generative AI, “Height 160 cm, weight 52 kg, shoulder width 38 cm, waist 65 cm, hip 90 cm, preference is natural, usage scene is spring outing, trend of this season is pastel color and linen material, propose 3 patterns of optimal coordination under these conditions, and explain a reason for combination, a body shape correction effect, a recommended scene, relevance to a trend, and tips for mixing and matching for each” is given. Specifically, the styling proposal unit implements an ensemble recommendation algorithm integrating collaborative filtering and content-based filtering. The system expands a past interaction history of the user as a sparse matrix on a memory. The system compresses the sparse matrix into a low-dimensional latent feature space using singular value decomposition. The feature extraction unit combines a body shape parameter, a season flag, and a categorical variable of the usage scene of the user to generate a context vector. The recommendation model receives a latent feature vector and the context vector as an input. For example, input data is a 64-dimensional vector representing the preference of the user and a one-hot encoding array indicating a spring outing. The model calculates an intersection of non-linear features using a multilayer perceptron. The model generates a distribution vector of recommendation probabilities for all products as an output. For example, output data is a score array from 0 to 1 for a product group of tens of thousands of items, and is an index group indicating a combination of the top three items. The system uses this output result as a subsequent process. The explanation generation module embeds metadata of the selected item and the body shape parameter of the user into a prompt template. The natural language generation model receives this prompt as an input, and autoregressively generates a token. The model generates text data of the explanatory text as an output. For example, the output data is a structured character string including a basis for body shape correction. The system synchronizes the generated text and a rendering instruction of a 3D model, and transmits them to a client terminal. The system mitigates a cold start problem and enables highly accurate recommendation even for a new user by this non-conventional processing method. The system logically presents validity of the recommendation and improves a purchase motivation of the user by this technical effect. The system realizes both calculation efficiency and accuracy in a use case of reproducing an inference process of a personal stylist on a computer.
Step 10: Inventory Management and Limited Product/New Product Notification The inventory management unit automatically detects a product with low inventory, a new product, a limited product, a popular product, a restocked product, a discounted product, an event-linked product, a regionally limited product, a collaboration product, and the like based on the preference, the purchase tendency, a browsing history, a product in a cart, a wish list, a restock notification setting, a limited product lottery application status, an event participation history, an inventory status for each region, a sales trend, the trend information, a price fluctuation, a promotion measure, and the like of the user, notifies the user terminal, immediately displays an alert of “low inventory” when a product browsed many times by the user in the past becomes one remaining item, can also execute price negotiation and purchase agency for the limited product using the generative AI, automatically negotiates with a sales side to draw out a discount or a privilege when the user requests “I want to buy this product a little cheaper”, automatically manages lottery sales and advance reservation of the limited product, a restock notification, event-linked sales, regionally limited sales, a priority purchase right of the collaboration product, and the like, and supports the user so as to obtain a desired product without missing it. As a specific example of a prompt sentence to be read by the generative AI, “Extract a product with low inventory, a new product, and a limited product based on a product list browsed by the user in the past and an inventory status, and generate an alert sentence or a purchase recommendation sentence for notifying the user. Also, generate a negotiation sentence for price negotiation or purchase agency” is given. Specifically, the inventory management unit adopts an asynchronous messaging architecture based on a publish-subscribe model. The system executes a change data capture process for continuously monitoring an update log of an inventory database in a background. The event router fires a low inventory event when an inventory quantity falls below a preset threshold. The matching engine receives a target product ID of the low inventory event and a browsing history vector of the user as an input. For example, input data is a specific product ID and an identifier list of users who have browsed the same product a plurality of times in the past. The engine executes a high-speed set operation using a bitmap index. The engine generates a list of users to be notified and payload data of a personalized message as an output. For example, output data is an array of device tokens and a JSON object including an alert sentence. The system uses this output result as a subsequent process. The push notification service asynchronously transmits the payload data to a notification gateway of a mobile operating system. The price negotiation module receives a discount request from the user as a natural language text. The reinforcement learning model calculates an optimal discount price with constraint conditions of a current inventory turnover rate and a profit margin as an input. The model generates numerical data of an approved discount price and a text token of a successful negotiation as an output. The system calls a smart contract and automatically issues a temporary discount coupon code. The system dramatically reduces a server load due to polling to the database by these processes. The system realizes real-time event-driven processing and suppresses a response delay of the system to a millisecond unit by this technical effect. The system technically establishes an autonomous sales promotion activity in a use case of preventing an opportunity loss and maximizing an inventory digestion rate.

### Specific Use Case

For example, when the user considers a new spring dress in a virtual store, the user avatar generation unit automatically generates a realistic 3D avatar using the generative AI based on detailed information acquired from the user terminal, such as height 160 cm, weight 52 kg, shoulder width 38 cm, waist 65 cm, hip 90 cm, a face image, a short bob hairstyle, a light skin color, age 35, a natural preference, natural makeup, a preference for small earrings as an accessory, a slightly forward-leaning posture, a slightly pigeon-toed walking style, and a smiling expression. As a specific example of a prompt sentence to be read by the generative AI, “Height 160 cm, weight 52 kg, shoulder width 38 cm, waist 65 cm, hip 90 cm, face image attached, short bob hairstyle, light skin color, natural preference, natural makeup, small earrings as an accessory, slightly forward-leaning posture, slightly pigeon-toed walking style, smiling expression, generate a realistic 3D avatar based on these pieces of information” is given. Specifically, the user avatar generation unit executes a data preprocessing pipeline that normalizes an input multidimensional parameter group and converts it into a tensor format processable by a machine learning model. The system scales continuous value data such as height, weight, and three sizes so as to follow a standard normal distribution with a mean of 0 and a variance of 1. The system converts categorical data such as a hairstyle and a preference into a one-hot encoding vector. The system applies a facial organ detection algorithm to the face image, and extracts feature point coordinates of eyes, a nose, and a mouth. The avatar generation model receives these preprocessed data groups as an input. For example, input data is a composite tensor in which a matrix including 68 facial feature point coordinates, a 15-dimensional numerical vector indicating body dimensions, and a 20-dimensional categorical vector representing a preference are combined. The model calculates a feature representation of the avatar in a latent space using an encoder-decoder architecture of a deep neural network. The model generates a vertex coordinate array of a 3D mesh, a normal vector, and UV mapping data as an output. For example, output data is mesh data of tens of thousands of polygons accurately reflecting the body shape of the user, and a texture image reflecting a skin color and makeup. The system uses this output result as a subsequent process. The system compresses the generated 3D data into a binary format and stores it in a cloud storage. The system caches the data in an edge server of a content delivery network. The system delivers the data from an optimal edge server in response to a request from a client terminal. The system completely automates a complex 3D modeling process by this non-conventional processing method. The system optimizes a data transfer amount and significantly shortens an initial load time of the avatar by this technical effect. The system is extremely effective in a use case of improving an onboarding experience of the user and reducing a drop-off rate.

The virtual store space generation unit automatically generates a bright virtual store space based on a wood grain tone and green using the generative AI based on the preference and past purchase tendency of the user, current trend information, a season being spring, a time zone being morning, a psychological state being relaxation-oriented, and weather being sunny, provides a new dress corner of a natural brand near an entrance, arranges a pop-up display for a limited spring event in a center, and plays a light song of an acoustic guitar as BGM. As a specific example of a prompt sentence to be read by the generative AI, “User's preference is natural taste, season is spring, time zone is morning, psychological state is relaxed, weather is sunny, generate a bright virtual store space based on a wood grain tone and green under these conditions, and set a new dress corner of a natural brand near an entrance, a pop-up display for a limited spring event in a center, and a light song of an acoustic guitar as BGM” is given. Specifically, the virtual store space generation unit is a system integrating a dynamic scene graph construction algorithm and a real-time rendering engine. The system collects context information and an environmental variable of the user, and constructs a parameter vector for space generation. The system converts data of a season and a time zone into a normalized floating-point number. The space generation model is a procedural modeling network based on generative artificial intelligence. The model receives the parameter vector as an input. For example, input data is a multidimensional tensor including a season flag indicating spring, a time zone index indicating morning, and an emotion score indicating relaxation-oriented. The model infers an optimal configuration from a learned space layout pattern. The model generates hierarchical scene graph data describing a scene configuration as an output. For example, output data is a JSON structure including a texture ID of a wood grain tone, a 3D model ID of a green plant, three-dimensional coordinates of a pop-up display, and a reference path of a BGM file of an acoustic guitar. The system uses this output result as a subsequent process. The rendering engine analyzes the scene graph data and loads an asset into a memory of a graphics processing unit. The system dynamically calculates an angle and a color temperature of a directional light for simulating morning sunlight. The system calculates mutual reflection of light in real time using a global illumination algorithm. The system executes these processes on a parallel computing cluster. The system dynamically synthesizes a completely personalized space for each user, unlike reading of a static 3D space. The system prevents a drawing delay and stabilizes a frame rate by this technical effect. The system optimizes a memory usage amount and overcomes a hardware constraint of a client terminal. The system realizes efficient use of computing resources in a use case of providing an immersive virtual store experience in a metaverse environment.

The product information management unit centrally manages 3D model data, a product image (a front, a side, a back, a wearing example, and a material up image), a price, an inventory status, a brand, a category, a size, a color, a material, a product description, a user review, limited model information, a restock schedule, discount information, a sales start date, advance reservation sales information, sustainable certification information, collaboration information, ranking information, and the like regarding the new spring dress, and immediately presents optimal information when the user picks up the product. Specifically, the product information management unit implements an architecture combining a high-availability data store using a distributed hash table and an in-memory search engine. The system distributively arranges metadata of the product, vertex data of the 3D model, and a high-resolution texture image in different storage hierarchies, respectively. The system generates a unique hash key for each data element, and constructs a reference relationship by a pointer. The search query processing unit receives a proximity event when the avatar of the user approaches a specific product area in a virtual space as a trigger. The system converts this event into a search condition vector. The search engine receives the search condition vector as an input. For example, input data is a vector including a category ID of the new spring dress, size information of the user, and three-dimensional coordinates of a current position. The engine executes a high-speed filtering process using an inverted index on an in-memory database. The engine generates a JSON array including metadata of a product matching a condition and a reference path of a 3D asset as an output. For example, output data is structured data including a product name, a price, an inventory quantity, and a download URL of the 3D model. The system uses this output result as a subsequent process. The system issues an asynchronous data fetch request to a front-end rendering engine. The system applies a level-of-detail control algorithm, and dynamically adjusts the number of polygons of the 3D model according to a distance from a camera. The system eliminates an input/output bottleneck of a database by these non-conventional data management methods. The system dramatically reduces a rendering load on a client side and improves a user experience by this technical effect. The system technically realizes a use case of presenting product information without delay in response to a line-of-sight movement or a movement operation of the user in a large-scale virtual store in which tens of thousands of product items are displayed.

The virtual fitting provision unit synthesizes the user avatar and the 3D model data of the dress, generates a virtual fitting image or video in a state in which the avatar wears the dress in real time using the generative AI, and allows the user to simultaneously wear the dress, a cardigan, and white sneakers, and compare and display a balance of the entire coordination, a combination of a color and a material, a body shape correction effect, a trend element, and the like in real time. As a specific example of a prompt sentence to be read by the generative AI, “Height 160 cm, weight 52 kg, shoulder width 38 cm, waist 65 cm, hip 90 cm, face image attached, short bob hairstyle, light skin color, generate a realistic 3D avatar based on these pieces of information, and generate a virtual fitting image in a state in which a dress of product ID 12345, a cardigan of product ID 67890, and white sneakers of product ID 24680 are simultaneously worn” is given. Specifically, the virtual fitting provision unit includes a hybrid architecture integrating a physics-based rendering engine and an image generation neural network based on a diffusion model. The virtual fitting provision unit receives input data from the user terminal. The input data includes a multidimensional numerical vector indicating a body shape parameter of the user. The numerical vector is composed of normalized floating-point numbers such as height, weight, and shoulder width, for example. The input data further includes a high-dimensional image tensor indicating a face image of the user. The image tensor is, for example, RGB data of 256 pixels vertically, 256 pixels horizontally, and 3 channels. The input data further includes 3D mesh data and a texture map of the product acquired from the product information management unit. The virtual fitting provision unit passes these pieces of input data to a preprocessing module. The preprocessing module scales a standard humanoid bone based on the body shape parameter. The preprocessing module fits the 3D mesh data of the product to the scaled bone. The virtual fitting provision unit renders the fitted 3D model as a two-dimensional depth map and segmentation map. The virtual fitting provision unit combines the rendered various maps and the face image tensor of the user. The virtual fitting provision unit inputs the combined tensor to the image generation neural network. The image generation neural network has a U-Net structure. The image generation neural network extracts a feature map from the input tensor. The image generation neural network outputs a realistic two-dimensional image tensor in a wearing state based on the extracted feature map. The output data is, for example, an RGB image tensor of 1024 pixels vertically, 1024 pixels horizontally, and 3 channels. Each pixel value of the output data represents a color intensity indicating reflection of light or a shadow of a wrinkle of clothes. The virtual fitting provision unit transmits the output image tensor to a display control module as a subsequent process. The display control module draws the received image tensor on a display of the user terminal. The image generation neural network is learned in advance using a large amount of pair data. The pair data is a combination of an avatar image before wearing and an actual wearing photograph. The learning process updates a weight parameter so as to minimize a pixel-by-pixel error and a perceptual error between a generated image and a correct image. With this configuration, the system significantly reduces a calculation load as compared with a conventional method depending only on a complex physical simulation. The system realizes generation of a highly accurate virtual fitting image in real time by reducing the calculation load. The present technology brings about a technical effect of reducing a return rate in a specific use case of improving a fitting experience in online apparel sales.

The interactive virtual staff unit receives a question or request from the user such as “Does this dress suit me?”, “Which bag matches this coordination?”, “What is the trend this season?”, “How is the sense of size of this brand?”, “Please tell me recommended products within the budget”, “I want to cover my upper arms”, and “I want to choose a color that makes my complexion look bright”, and returns personal advice, a product proposal, tips for size selection, return/exchange guidance, a coordination example, a reason for combination, a body shape correction effect, relevance to a trend, tips for mixing and matching, a characteristic for each brand, a handling method of material, advice on washing and maintenance, a gift proposal, event information, lottery guidance for a limited product, and the like in real time using the generative AI while referring to user information, product information, styling information, trend information, a purchase history, an inventory status, a usage scene, a budget, a return/exchange history, a tendency of size selection, a worry about dressing, a past consultation history, and the like. As a specific example of a prompt sentence to be read by the generative AI, “User information: height 160 cm, weight 52 kg, shoulder width 38 cm, waist 65 cm, hip 90 cm, preference is natural, past purchase history exists, question: Does this dress suit me? In response to this, generate personal advice considering a body shape, a preference, a past purchase history, and a trend of this season” is given. Specifically, the interactive virtual staff unit is configured with a large language model including a self-attention mechanism as a core. The interactive virtual staff unit receives a natural language inquiry from the user terminal. The interactive virtual staff unit converts the received text into an integer token array using a tokenizer. The input data is, for example, a one-dimensional array consisting of several tens of tokens obtained by converting a character string “Does this dress suit me?”. The interactive virtual staff unit further acquires a user profile from a user information database. The user profile is a high-dimensional embedding vector encoding a past purchase history and body shape data. The interactive virtual staff unit combines the token array and the embedding vector, and inputs them to the large language model. The large language model analyzes a context of the input sequence. The large language model calculates a dependency relationship between words in a transformer block of each layer. The large language model outputs a probability distribution of a response text based on an analysis result. The output data is an array of softmax scores for each word in a vocabulary. The output data is, for example, a continuation of high probability values for generating a text “It is optimal for your straight skeleton”. The large language model simultaneously outputs a score for an identifier of a product to be recommended. The output data is, for example, a high recommendation score of 0.95 for a specific product identifier. The interactive virtual staff unit sequentially samples a token with the highest score from the probability distribution as a subsequent process. The interactive virtual staff unit decodes the sampled token into a natural language text. The interactive virtual staff unit outputs the generated text to a user interface. The interactive virtual staff unit further searches a product database using a product identifier whose recommendation score exceeds a threshold. The interactive virtual staff unit acquires image data of the searched product, and displays it in synchronization with the response text. The large language model is optimized by reinforcement learning using human feedback in addition to autoregressive language modeling. With this configuration, the system executes deep context understanding in a high-dimensional vector space, unlike a conventional chatbot based on simple keyword matching. The system accurately grasps a potential need of the user, and dynamically generates a personalized response. The present technology exhibits a technical effect of improving response accuracy and reducing a work load of an operator in a use case of automation of customer support.

The user interaction support unit provides various interaction functions such as a chat or voice call between user avatars, an exchange of opinions on coordination, a joint shopping experience, SNS linkage, group purchase, browsing of a ranking of popular coordination, event participation, joint lottery of a limited product, friend invitation, real-time voting, a questionnaire, review posting, a coordination contest, and a virtual fashion show, and realizes a communication experience close to real shopping, for example, friends enter the same virtual store, select a product together while exchanging opinions by chat or voice call, show coordination to each other, consult with three parties including a staff member, share dressing with other users by SNS linkage, browse a ranking of popular coordination, and perform a discount by group purchase, participation in a limited event, application for a coordination contest, participation in a virtual fashion show, and the like. Specifically, the user interaction support unit constructs a virtual space using a distributed state synchronization server and a real-time communication protocol. The user interaction support unit simultaneously arranges a plurality of user avatars in the virtual space. The user interaction support unit periodically receives input data from each user terminal. The input data includes a three-dimensional coordinate vector indicating a position of the avatar in the space. The input data is, for example, a vector consisting of floating-point numbers of an X-axis, a Y-axis, and a Z-axis. The input data further includes a quaternion array indicating a rotation state of a joint of the avatar. The input data further includes voice stream data of the user. The user interaction support unit inputs the received input data to a state integration module. The state integration module integrates latest states of avatars of all users, and generates a global state vector. The state integration module simultaneously applies a distance attenuation process to the voice stream data. The state integration module generates mixing data of spatial audio based on a relative distance in the virtual space. The user interaction support unit transmits the updated global state vector and mixing data to each user terminal as output data. The output data is, for example, an array of relative position coordinates of an avatar of another user and voice waveform data whose volume is adjusted. The user interaction support unit instructs a graphics processing unit of each user terminal to perform local rendering as a subsequent process. Each user terminal draws the avatar of another user on a screen based on the received global state vector. The user interaction support unit adopts a delta compression algorithm that transmits only difference data from a previous state in order to optimize a communication band. With this configuration, the system minimizes a communication delay even in an environment where a large number of users connect simultaneously. The system enables a real-time joint shopping experience beyond a physical distance. The present technology brings about a technical effect of smoothing interaction between users and dramatically reducing a communication load of the system in a use case of a virtual event or group purchase in a metaverse space.

The purchase support unit automatically manages a budget of the user, an inventory, delivery destination information, a payment method, a delivery status, a return/exchange history, a restock notification, a lottery application for a limited product, gift wrapping, delivery date and time designation, point use, coupon application, management of a purchase history, and the like using the generative AI, and seamlessly supports a purchase procedure, tracking of a delivery status, automation of a return/exchange procedure, a restock notification, a lottery application for a limited product, gift wrapping, delivery date and time designation, point use, coupon application, management of a purchase history, and the like. As a specific example of a prompt sentence to be read by the generative AI, “User's budget is 20,000 yen, list products purchasable within the budget based on a product list, a price, and an inventory status, and generate a guidance sentence for a flow of a purchase procedure, a delivery status, and a return/exchange procedure” is given. Specifically, the purchase support unit includes a dynamic workflow generation mechanism combining a transaction processing engine and a sequence conversion neural network. The purchase support unit receives a purchase request from the user terminal. The purchase support unit acquires a scalar value indicating a budget constraint of the user as input data. The input data is, for example, numerical data of 20,000 yen. The purchase support unit further acquires an array of identifiers of products in a cart as input data. The purchase support unit further acquires a status flag of each product from an inventory database. The purchase support unit inputs these pieces of input data to the sequence conversion neural network. The sequence conversion neural network has a structure of an encoder and a decoder. The sequence conversion neural network encodes an input condition into a multidimensional context vector. The sequence conversion neural network decodes the context vector, and outputs graph structure data of an optimized purchase route. The output data is a node list indicating a calling order of a payment application programming interface. The sequence conversion neural network simultaneously outputs a token array of a text constituting a guidance sentence to the user. The output data is, for example, natural language text data explaining a flow of a purchase procedure. The purchase support unit automatically calls a payment gateway according to the generated graph structure data as a subsequent process. The purchase support unit updates a state of a transaction every time processing of each node is completed. The purchase support unit confirms the transaction when all processes are normally completed. The sequence conversion neural network is optimized by supervised learning using a past normal transaction log and error log. With this configuration, the system dynamically solves a complex conditional branch for each user by artificial intelligence, unlike a static rule-based payment flow. The system autonomously handles an exception process such as out of stock or budget excess. The present technology exhibits a technical effect of reducing an occurrence rate of a payment error and shortening a processing step in a use case of automation of a payment process in electronic commerce.

The trend analysis unit analyzes various external and internal data such as SNS, fashion magazines, collections, street snaps, influencer posts, search trends of search engines, brand official websites, user purchase data, reviews, questionnaire results, event information, seasonal factors, and regional factors using generative AI, extracts colors, patterns, silhouettes, materials, brand tendencies, dressing techniques, popular items, notable collaborations, trends in sustainable fashion, popularity trends of limited products, event excitement levels, regional trend tendencies, trends by age, trends by gender, and topicality on SNS that are popular this season, and reflects them in real time in styling proposals, product recommendations, store space generation, event planning, promotional measures, inventory management, price strategies, and the like. A specific example of a prompt sentence to be read by the generative AI is “Extract popular colors, popular patterns, popular silhouettes, popular brands, notable dressing techniques, and trends in sustainable fashion of this season based on the latest data of SNS, fashion magazines, and collections, and present 10 items in a ranking format”. Specifically, the trend analysis unit includes a multimodal learning architecture in which a natural language processing model and an image recognition model are integrated. The trend analysis unit periodically collects input data from an external data source. The input data includes text data extracted from a social networking service. The text data is, for example, a set of character strings including a specific hashtag. The input data further includes a high-dimensional image tensor indicating a fashion image. The image tensor is, for example, RGB data of 224 pixels vertically, 224 pixels horizontally, and 3 channels. The input data further includes time-series data of a timestamp assigned to each data. The trend analysis unit inputs the text data to the natural language processing model, and extracts a text feature vector. The trend analysis unit inputs the image tensor to a convolutional neural network, and extracts an image feature vector. The trend analysis unit maps the text feature vector and the image feature vector to a common multidimensional feature space using a contrastive learning algorithm. The trend analysis unit executes a clustering process on the common feature space. The trend analysis unit outputs a clustering result of trend elements as output data. The output data is a barycentric coordinate vector of each cluster on the multidimensional feature space. The trend analysis unit further calculates a time-series growth rate of each cluster, and outputs a rapid rise score. The output data is, for example, a floating-point number in a range of 0.0 to 1.0. The output data is, for example, a score of 0.88 of a cluster indicating a pastel color, or a score of 0.92 of a cluster indicating an oversize. The trend analysis unit extracts a trend element whose rapid rise score exceeds a predetermined threshold as a subsequent process. The trend analysis unit automatically feeds back the extracted trend element to a tagging system of the product information management unit. With this configuration, the system fuses and analyzes a correlation between text and an image in a high-dimensional space. The system eliminates qualitative trend analysis by human visual inspection, and realizes data-driven quantitative trend prediction. This technology brings about technical effects of early discovery of a trend and improvement in accuracy of marketing measures in use cases of planning of apparel products and inventory optimization.

The coordination proposal unit generates a plurality of optimal coordination examples using the generative AI based on a body shape, facial features, a preference, a season, a usage scene, trend information, a past purchase history, an inventory status, a budget, a dressing worry, a brand characteristic, a material characteristic, event information, limited product information, and the like of the user, and automatically generates and presents an explanatory text such as “why this combination suits”,
“what kind of body shape worry can be covered”, “which scene is optimal”, “relevance to a trend”, “tips for mixing and matching”, “recommended use of accessories”, “characteristics of each brand”, “handling method of a material”, “dressing points at an event”, and “utilization method of a limited product” for each coordination example. A specific example of a prompt sentence to be read by the generative AI is “Propose 3 patterns of optimal coordination under these conditions: height 160 cm, weight 52 kg, shoulder width 38 cm, waist 65 cm, hip 90 cm, preference is natural, usage scene is spring outing, and trend of this season is pastel colors and linen materials, and explain a reason for combination, a body shape correction effect, a recommended scene, relevance to a trend, and tips for mixing and matching for each”. Specifically, the coordination proposal unit includes an advanced recommendation system architecture based on a graph neural network. The coordination proposal unit acquires input data from the user information database and the product information management unit. The input data includes a user feature vector in which a past purchase history and a preference of the user are aggregated. The user feature vector is, for example, an array of 256-dimensional floating-point numbers. The input data further includes a product node vector indicating an attribute of each product. The product node vector is, for example, a one-hot encoded vector indicating a category or a color. The input data further includes a trend context vector acquired from the trend analysis unit. The coordination proposal unit inputs these input data to the graph neural network. The graph neural network constructs a huge graph structure with users and products as nodes and interactions as edges. The graph neural network propagates feature information between adjacent nodes using a message passing algorithm. The graph neural network outputs a link prediction score between unpurchased product nodes as output data. The output data is a probability value in a range of 0.0 to 1.0. The output data is, for example, a fitness score of 0.95 for a combination of specific tops and bottoms. The coordination proposal unit simultaneously outputs text data of the explanatory text using a language generation model. The output data is a token array explaining why the combination is optimal. The coordination proposal unit extracts a combination having a high fitness score as a subsequent process. The coordination proposal unit transmits the extracted coordination information and explanatory text to a display control module of a user interface. The graph neural network is trained to minimize a binary cross-entropy error with an actual purchase history as a positive example and a random combination as a negative example. With this configuration, the system models a complex non-linear relationship between products that cannot be discovered by simple rule-based filtering. The system proposes non-trivial coordination that matches a potential preference of the user by utilizing feature representation in a high-dimensional space. This technology exhibits technical effects of promotion of cross-selling and improvement in customer satisfaction in a use case of automation of personal styling.

The inventory management unit automatically detects a product with low inventory, a new product, a limited product, a popular product, a restocked product, a discounted product, an event-linked product, a regionally limited product, a collaboration product, and the like based on a preference, a purchase tendency, a browsing history, a product in a cart, a wish list, a restock notification setting, a limited product lottery application status, an event participation history, an inventory status by region, a sales trend, trend information, a price fluctuation, a promotional measure, and the like of the user, notifies the user terminal, immediately displays an alert of “low inventory” when a product browsed many times by the user in the past has only one item left, can also execute price negotiation and purchase agency for a limited product using the generative AI, automatically negotiates with a seller side to draw out a discount or a privilege when the user requests “I want to buy this product a little cheaper”, automatically manages lottery sales, advance reservations, restock notifications, event-linked sales, regionally limited sales, priority purchase rights for collaboration products, and the like of limited products, and supports the user so as not to miss a desired product.

A specific example of a prompt sentence to be read by the generative AI is “Extract a product with low inventory, a new product, and a limited product based on a product list browsed by the user in the past and an inventory status, and generate an alert sentence and a purchase recommendation sentence for notifying the user. Also, generate a negotiation sentence for price negotiation and purchase agency”. Specifically, the inventory management unit includes an autonomous control architecture in which a time-series prediction neural network and a reinforcement learning agent are integrated. The inventory management unit continuously acquires input data from various databases in the system. The input data includes a time-series array indicating a past sales record. The time-series array is, for example, a one-dimensional vector having the number of daily sales for the past 30 days as an element. The input data further includes a scalar value indicating a browsing frequency of the user. The input data further includes an integer value indicating the current number of inventories. The inventory management unit inputs these input data to the time-series prediction neural network. The time-series prediction neural network includes a long short-term memory unit or a self-attention mechanism. The time-series prediction neural network analyzes a dependency relationship of the input time-series pattern. The time-series prediction neural network outputs a probability distribution of a future demand prediction value as output data. The output data is, for example, a numerical value of 0.85 indicating a probability that the inventory will be depleted within 7 days. The inventory management unit further inputs the demand prediction value to the reinforcement learning agent. The reinforcement learning agent outputs an optimal action value for price negotiation or ordering as output data. The output data is, for example, a Q value of 0.75 for an action presenting a discount rate of 5 percent. The inventory management unit activates an alert generation module when the depletion probability exceeds a predetermined threshold as a subsequent process. The alert generation module transmits a notification to the user terminal. The inventory management unit further selects an action having the maximum Q value, and automatically transmits a negotiation request to a seller-side system via an application programming interface. The reinforcement learning agent is optimized through a learning process with profit maximization in a simulation environment as a reward. With this configuration, the system eliminates conventional inventory management relying on human intuition, and autonomously executes dynamic pricing and inventory replenishment based on data. The system dramatically improves a response speed to demand fluctuation. This technology brings about technical effects of minimization of inventory retention and complete prevention of opportunity loss in a use case of optimization of a supply chain.

In this way, the user can realize optimal product selection comprehensively considering various conditions such as a body shape, a preference, a usage scene, a trend, a budget, and an inventory status, virtual fitting, a coordination proposal, purchase support, inventory management, consultation by a personal assistant, and user interaction consistently using the generative AI while staying at home. Specifically, the entire system adopts a microservice architecture that asynchronously links a plurality of functional modules. The system receives various request data from the user terminal as input data. The input data is encapsulated as a payload in a JSON format. The input data includes, for example, a session identifier, an operation log vector of the user, and various sensor data. The system routes the received input data to an appropriate functional module via an API gateway. As described above, each functional module processes data in parallel using a dedicated neural network or processing algorithm. The system inputs a processing result from each module to an integration module. The integration module generates a rendering instruction group of a user interface as output data. The output data is, for example, an array of an update command of a document object model or a drawing command of a 3D object using WebGL. The output data includes, for example, a flag that triggers a screen transition or coordinate data that updates a posture of an avatar. The system transmits the generated instruction group to the user terminal as a subsequent process. A dedicated application or a browser on the user terminal interprets the received instruction group, and asynchronously updates a screen display. The system utilizes a message queuing system for communication between the modules to prevent data loss. With this configuration, the system eliminates a single point of failure, and dramatically improves scalability and fault tolerance of the entire system. The system efficiently performs distributed processing of artificial intelligence processing requiring enormous calculation resources on a server side, and minimizes a load on the user terminal. This technology reliably brings about technical effects of provision of a seamless user experience without delay and reduction in system operation cost in a use case of construction of a next-generation virtual reality shopping mall or an integrated electronic commerce platform.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

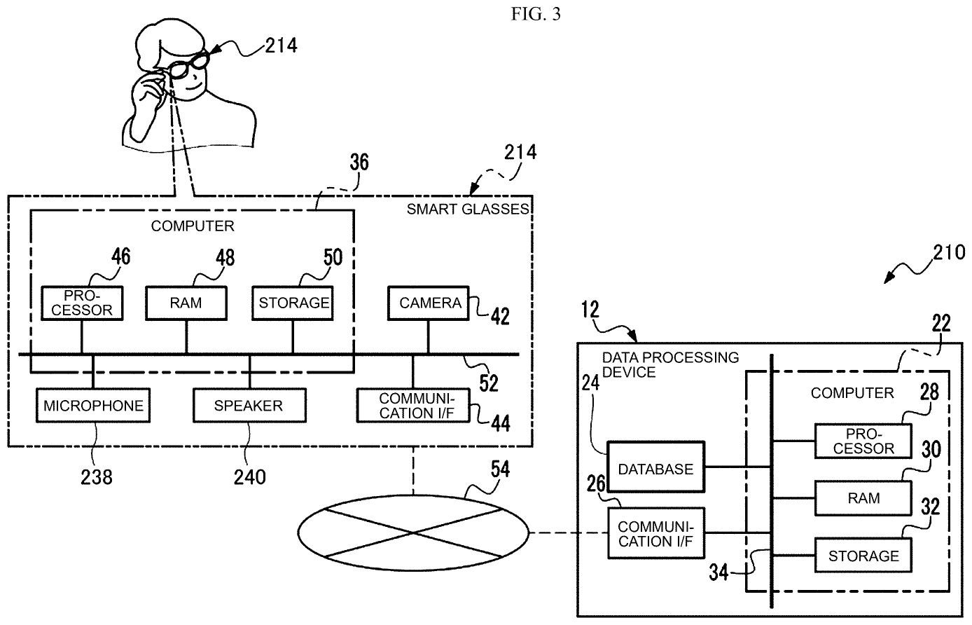

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

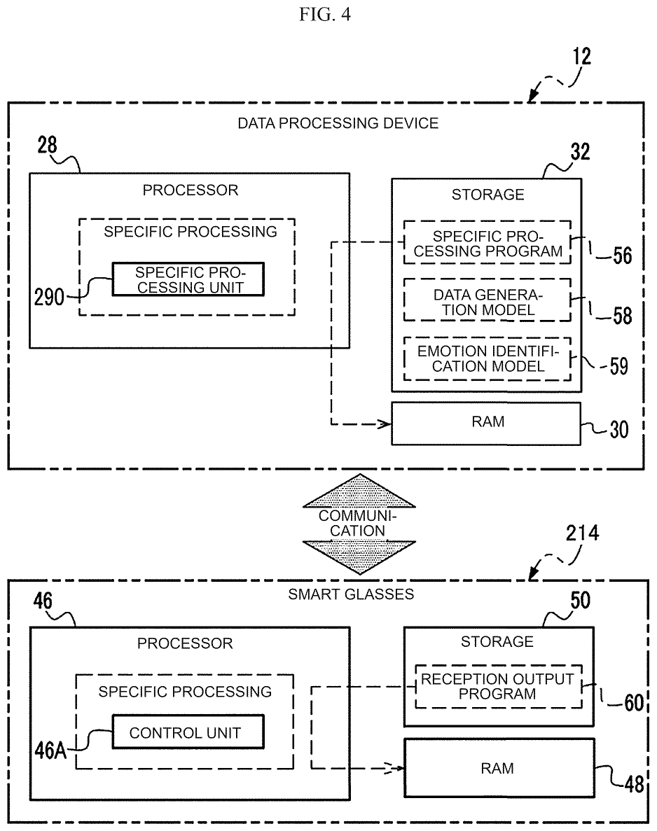

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

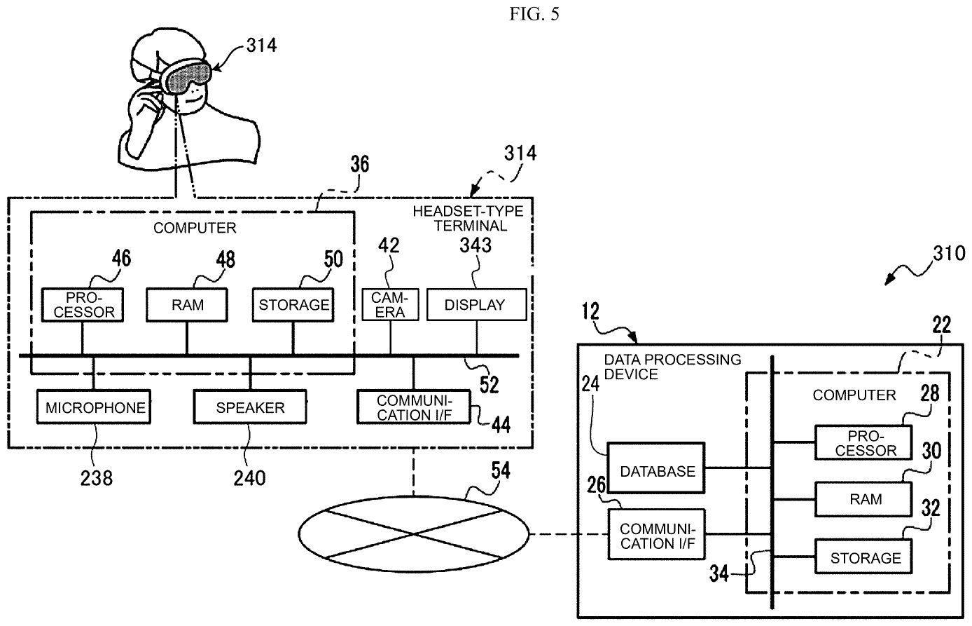

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

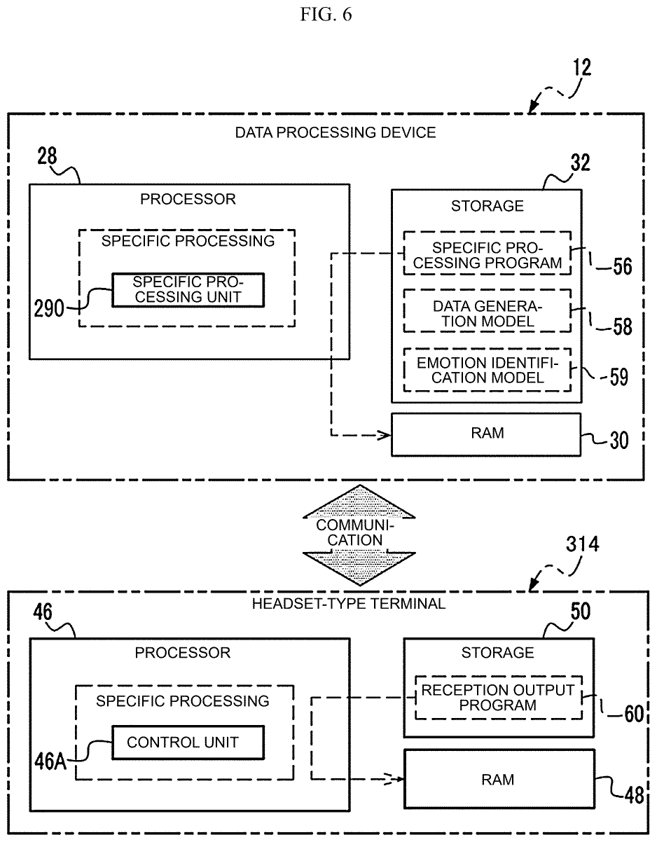

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

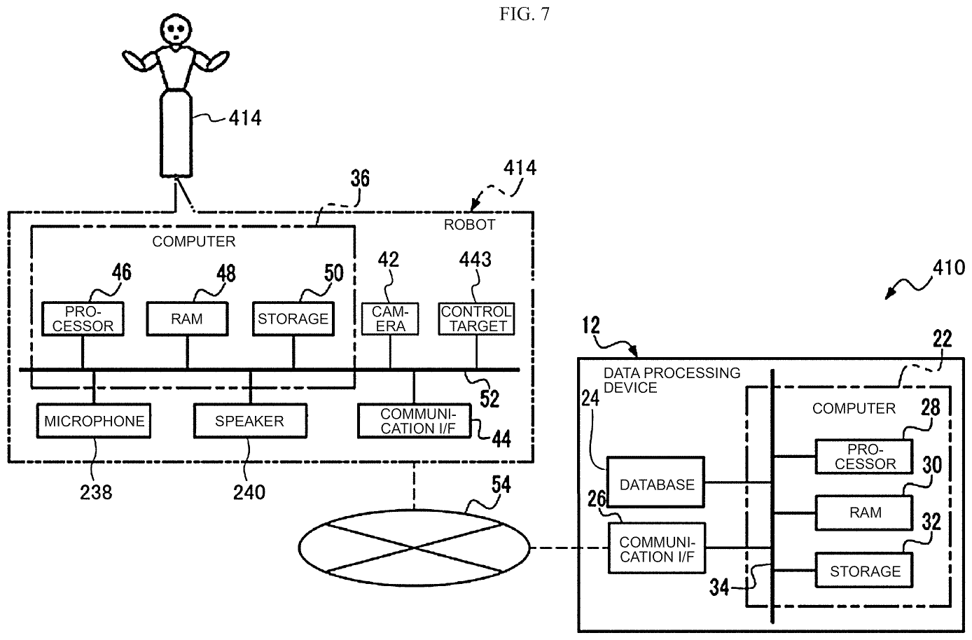

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

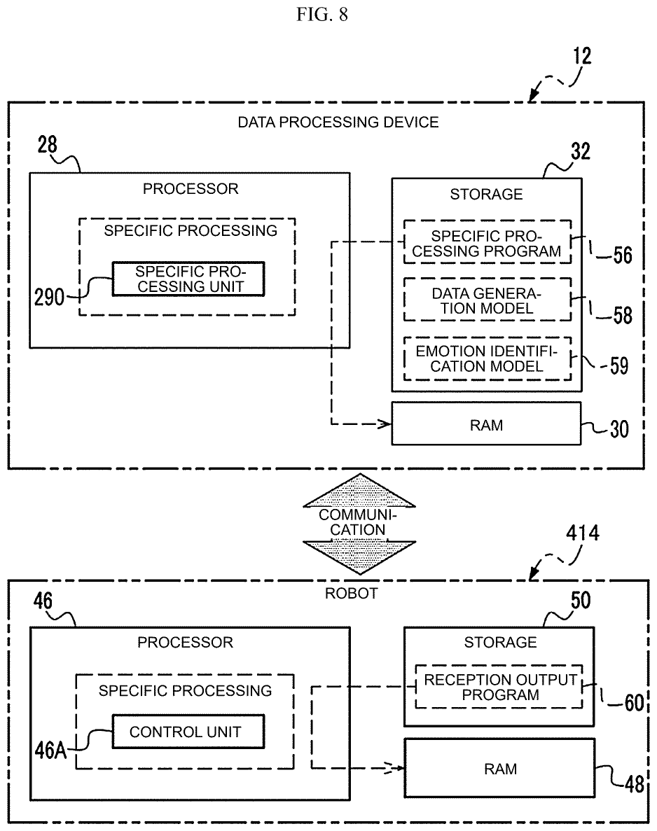

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

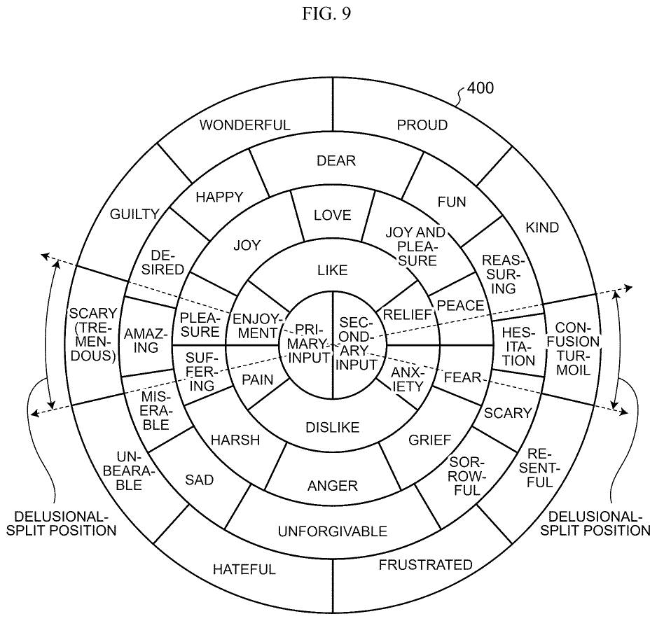

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

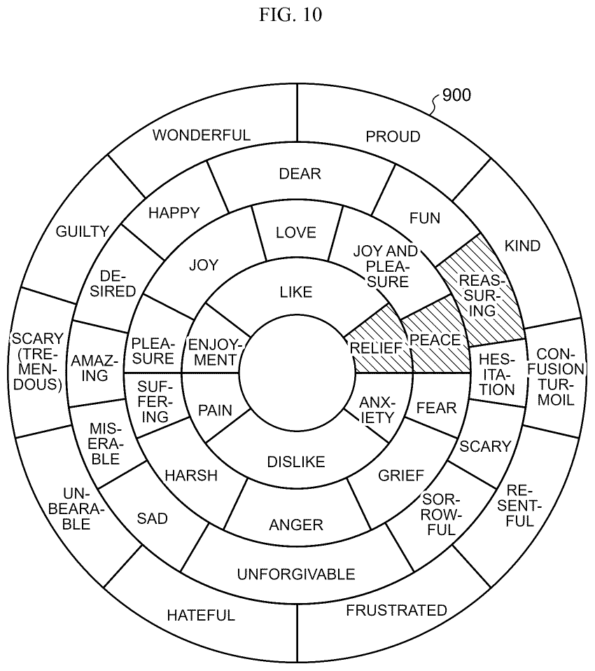

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

(Supplementary Note 1)[0210]A virtual store system comprising: a user avatar generation unit; a virtual store space generation unit; a product information management unit; a virtual fitting provision unit; an interactive virtual staff unit; a user interaction support unit; and a purchase support unit, wherein the user avatar generation unit is configured to acquire information such as a body shape, facial features, a hairstyle, a skin color, a fashion preference, an age, and a gender of a user, and automatically generate a highly accurate 3D avatar individually optimized for each user using generative AI; the virtual store space generation unit is configured to construct a virtual space by personalizing a store layout, an atmosphere, a display, a decoration, lighting, BGM, a sales floor configuration, and the like for each user using the generative AI based on a preference, a past purchase tendency, current trend information, and the like of the user; the product information management unit is configured to centrally manage 3D model data, a product image, a price, an inventory status, a brand, a category, a size, a color, a material, a product description, a user review, limited model information, and the like regarding a plurality of products; the virtual fitting provision unit is configured to synthesize the user avatar and the product 3D model data, generate a virtual fitting image or video in a state in which the avatar wears the product in real time using the generative AI, and reproduce a silhouette, a sense of size, a sense of material, wrinkles and drapes according to movement, gloss, an appearance at the time of layering, and the like at the time of wearing with high accuracy; the interactive virtual staff unit is configured to return personal advice, a product proposal, tips for size selection, return/exchange guidance, and the like in real time to a question or request by voice or text from the user using the generative AI while referring to user information, product information, styling information, trend information, a purchase history, and the like; the user interaction support unit is configured to enable a chat or voice call between user avatars, an exchange of opinions on coordination, and a joint shopping experience; and the purchase support unit is configured to automatically manage a budget, an inventory, and delivery destination information of the user using the generative AI, and seamlessly support up to a purchase procedure, tracking of a delivery status, and automation of a return/exchange procedure.

(Supplementary Note 2)[0211]The virtual store system according to Supplementary Note 1, wherein the virtual fitting provision unit is configured to, when the user selects a plurality of products simultaneously, cause the user avatar to simultaneously wear each product using the generative AI, and compare and display a balance of the entire coordination, a combination of a color and a material, a body shape correction effect, a trend element, and the like in real time, so that the user can confirm the coordination from multiple angles through operations such as 360-degree rotation and enlargement/reduction.

(Supplementary Note 3)[0212]The virtual store system according to Supplementary Note 1, wherein the interactive virtual staff unit is configured to comprehensively analyze the body shape, the facial features, the preference, the past purchase history, the current trend information, the inventory status, a usage scene, the budget, and the like of the user using the generative AI, and, in response to various questions and requests from the user such as “Does this product suit me?”, “Which item matches this coordination?”, “What is the trend this season?”, “How is the sense of size of this brand?”, and “Please tell me recommended products within the budget”, generate personal advice, a product proposal, a coordination example, a reason for combination, a body shape correction effect, relevance to a trend, tips for mixing and matching, points for size selection, return/exchange guidance, and the like in real time, and present them to the user.

What is claimed is:

1. A system comprising:
circuitry configured to:
receive, via a communication interface coupled to a packet-switched network, image data from a terminal device, and store the image data in a storage device;
apply a convolutional neural network to the image data to extract feature vectors comprising color histogram data, shape descriptor data, material texture features, and design pattern features, and generate an image embedding vector from the extracted feature vectors;
compute cosine similarity scores between the image embedding vector and stored item record embedding vectors in a vector database, retrieve candidate item records having similarity scores exceeding a similarity threshold, and rank the retrieved candidate item records in descending order of similarity score;
apply a generative adversarial network to body shape parameter data and three-dimensional model data associated with a selected item record to synthesize a composite image representing the body shape parameter data wearing the selected item, and generate virtual try-on output data from the synthesized composite image; and
transmit the ranked candidate item records and the virtual try-on output data to the terminal device via the communication interface.

2. The system according to claim 1, wherein the circuitry is configured to receive body shape parameter data from the terminal device via the communication interface comprising height, weight, and body dimension measurements, normalize the received body shape parameter data to a standardized body shape representation, and generate a body shape embedding vector from the normalized body shape parameter data using a body shape encoder model.

3. The system according to claim 2, wherein the circuitry is configured to apply the generative adversarial network by encoding the body shape embedding vector and the three-dimensional model data of the selected item as a combined input tensor, generating a synthesized composite image through a generator network conditioned on the combined input tensor, and applying a discriminator network to compute a realism score for the synthesized composite image.

4. The system according to claim 3, wherein the circuitry is configured to generate augmented reality overlay data by projecting the synthesized composite image onto a real-time camera image stream received from the terminal device, and transmit the augmented reality overlay data to the terminal device via the communication interface for display on the terminal device screen.

5. The system according to claim 1, wherein the circuitry is configured to apply a natural language processing model to preference text data received from the terminal device via the communication interface to extract attribute preference parameters comprising color preference identifiers, style category identifiers, and occasion type identifiers, and incorporate the extracted attribute preference parameters as weighting factors applied to cosine similarity scores during candidate item record ranking.

6. The system according to claim 5, wherein the circuitry is configured to retrieve a user preference profile record associated with a user identifier from the storage device, compute a preference alignment score between each retrieved candidate item record and the user preference profile record, and adjust the ranking of candidate item records by combining the cosine similarity score with the preference alignment score.

7. The system according to claim 1, wherein the circuitry is configured to apply a trend analysis model to item record attribute data and time-series popularity metric data stored in the storage device to compute a trend score for each candidate item record, and incorporate the trend score as an additional ranking factor in the candidate item record ranking.

8. The system according to claim 1, wherein the circuitry is configured to generate a coordinate set recommendation by applying the generative neural network model to the selected item record embedding vector, retrieving complementary item records from the vector database by cosine similarity search using the selected item record embedding vector as a query, and ranking the retrieved complementary item records by a coordinate compatibility score.

9. The system according to claim 8, wherein the circuitry is configured to apply the generative adversarial network to synthesize a coordinate set composite image representing the body shape parameter data wearing the selected item together with a selected complementary item, and transmit the coordinate set composite image to the terminal device via the communication interface.

10. The system according to claim 1, wherein the circuitry is configured to receive feedback data from the terminal device via the communication interface comprising rating values and preference update parameters for displayed item records, update the user preference profile record based on the feedback data, and update the preference alignment score computation model using the feedback data as additional training examples.

11. The system according to claim 1, wherein the circuitry is configured to apply a multimodal encoder to fuse the image embedding vector with textual attribute data extracted from the item record by a natural language processing model, generating a multimodal item record embedding vector for indexing in the vector database.

12. The system according to claim 1, wherein the circuitry is configured to receive an availability status update from an inventory management data service via the communication interface, update the availability status field of the corresponding item records in the vector database, and exclude item records having availability status values below an availability threshold from candidate item record retrieval results.

13. The system according to claim 1, wherein the circuitry is configured to apply an interactive dialogue model to natural language queries received from the terminal device about specific item records, retrieve relevant item attribute data and user preference data from the storage device, and generate natural language responses by the generative neural network model conditioned on the retrieved data.

14. The system according to claim 1, wherein the circuitry is configured to establish a secure WebSocket connection with the terminal device for real-time bidirectional communication, receive sensor data and input text from the terminal device in real time over the WebSocket connection, and apply preprocessing comprising missing value imputation and normalization to the received sensor data.

15. The system according to claim 1, wherein the circuitry is configured to update the convolutional neural network by generating training pairs from historical image data records and corresponding validated item category labels, and fine-tune the convolutional neural network to improve feature extraction accuracy for specific item attribute patterns.

16. The system according to claim 1, wherein the circuitry is configured to generate a size recommendation by applying a size prediction model to the body shape parameter data and size specification data extracted from the selected item record, and transmit a size recommendation data record comprising a recommended size identifier and a fit probability score to the terminal device.

17. The system according to claim 1, wherein the image data comprises photographs of items or reference item images uploaded by a user, the three-dimensional model data represents geometric surface data for items in the vector database, and the virtual try-on output data comprises a synthesized composite image generated by the generative adversarial network.

18. A system comprising:
circuitry configured to:
receive, via a communication interface coupled to a packet-switched network, image data from a terminal device, apply a convolutional neural network to extract feature vectors and generate an image embedding vector, and retrieve candidate item records by cosine similarity scoring from a vector database;
apply preference text data processing using a natural language processing model to extract attribute preference parameters and adjust candidate item record ranking;
apply a generative adversarial network to body shape parameter data and three-dimensional model data of a selected item to synthesize a composite image, and generate augmented reality overlay data by projecting the composite image onto a real-time camera image stream; and
transmit ranked candidate item records, virtual try-on output data, and coordinate set recommendations to the terminal device via the communication interface.

19. The system according to claim 18, wherein the circuitry is configured to apply a multimodal encoder to fuse image embedding vectors with textual attribute data to generate multimodal item record embedding vectors, apply a trend analysis model to compute trend scores as additional ranking factors, and generate size recommendations by applying a size prediction model to body shape parameter data and item size specification data.

20. A method comprising:
receiving, via a communication interface coupled to a packet-switched network, image data from a terminal device, and storing the image data in a storage device;
applying a convolutional neural network to extract feature vectors comprising color histogram data, shape descriptor data, material texture features, and design pattern features, and generating an image embedding vector;
computing cosine similarity scores between the image embedding vector and stored item record embedding vectors in a vector database, and ranking retrieved candidate item records by similarity score;
applying a generative adversarial network to body shape parameter data and three-dimensional model data to synthesize a composite image and generate virtual try-on output data; and
transmitting the ranked candidate item records and the virtual try-on output data to the terminal device via the communication interface.
